(19) United States
(12) Patent Application Publication
(10) Pub. No.: US 2025/0306560 A1
(43) Pub. Date: Oct. 2, 2025

(54) PANELIZED ARTIFICIAL INTELLIGENCE (AI) WALLS, FURNITURE, AND STRUCTURES

(71) Applicant: Edlen Habitat & Technologies, Seattle, WA (US)

(72) Inventors: Richard Chia Tsing Tong, Seattle, WA (US); Matthew Edlen, Portland, OR (US); David Chen, Portland, OR (US); Trang Thuy Le, Seattle, WA (US)

(73) Assignee: Edlen Habitat & Technologies, Seattle, WA (US)

(21) Appl. No.: 19/094,718

(22) Filed: Mar. 28, 2025

Related U.S. Application Data
(60) Provisional application No. 63/571,727, filed on Mar. 29, 2024.

(51) Int. Cl. G05B 19/048; G05B 19/05

(52) U.S. Cl. CPC G05B 19/048; G05B 19/052; G05B 2219/2642

(57) ABSTRACT

A smart panel system comprises a network of interconnected smart panels, each including subpanels and micropanels. Each micropanel includes layers, such as a processing layer, communications layer, and module controller. The module controller uses an Artificial Intelligence Operating System (AIOS) to control and monitor the subpanels and micropanels. The AIOS includes software Artificial Intelligence (AI) agents dedicated to specific tasks, such as analyzing data, generating prompts, and applying AI outputs to the smart panels. The system can be monitored and controlled remotely using identification data, state data, and operating data transmitted by the smart panels.

### CROSS-REFERENCE TO RELATED APPLICATIONS

This application claims the benefit of U.S. provisional patent application Ser. No. 63/571,727, filed on Mar. 29, 2024, the contents of which are incorporated herein by reference in their entirety.

### BACKGROUND

In the last 50 years, the median home price has gone from 80% of all Americans being able to afford to buy a home to less than 15%. Since the mid-1980's, the total cost of construction has increased 222%. Forecasting growth based upon year-over-year trends from 2000-2024, it is estimated that by 2044 the cost of construction may have doubled.

These challenges may continue to grow, and traditional development models fail to result in long-term solutions because housing costs are outstripping incomes as construction costs are tied to rising labor costs (unlike other industries like manufacturing) and economies of scale are low. In addition, separation of incentives between builders and long-term owners. Construction projects are often funded with “value-add” equity investors whose investment focus is on short-term (3-5 year periods) that generate the highest possible rate of return. These investments incentivize developers to minimize the cost of housing production while maximizing revenues to generate high yields. These short-term investment outlooks do not require that developers view those impacts 10 or even 50 years down the line. It is someone else's problem. As a result, long-term operating costs of multi-tenant units are rising as they are fundamentally driven by higher labor costs. Climate change may increase insurance, heating, ventilation, and air conditioning (HVAC), and general repair costs for units that are not climate-resistant.

### The Insight: Longer-Term Holders⇒Better Buildings⇒Lower Cost

One solution to all this is the investment risk and its corresponding impact on capital cost. The measure of risk is based on a variety of factors ranging from perception of market stability to construction cost volatility, to operating costs, etc. The industry breaks down that risk into three primary categories:
Core Assets (Low Risk)—These assets are located in areas with a strong track record of minimal volatility within the asset class. Therefore, investors risk perception of these assets is generally lower and therefore demand low net returns.
Core (+) Plus (Medium Risk)—Oftentimes Core+ assets are relatively stable cash flowing assets that may need some capital investment or repositioning in the marketplace to generate higher profits. As cash flowing assets, these properties have a history and track record of operating success.
Value-Add (High Risk)—Value-Add investment comprises both new construction as well as acquisition of existing assets. These are classified as higher-risk investments as the path to achieving stated economic goals may rely on a significant number of variables coming together. For example, these investments may be made in emerging markets where developers forecast significant growth or the ability to generate market demand or depressed assets that may achieve market success through deep capital investment or repositioning. The innumerable risks associated with constructing new real estate—despite the quality of the asset—may lead many new assets to be built through value-add investment targets. To offset that risk, investors look for significantly higher returns (13-20+% internal rate of return). Meeting these returns generally leads developers to maximize profit by a.) minimizing the cost of production and maximizing revenues and/or b.) timing market transactions (typically within a 1-3 year window) to achieve the highest possible return.

To develop housing for “middle-income” earners may necessitate a dramatic shift in housing investment. The population that constitutes those earning “middle-income” wages reflects the largest subset of the United States population. Middle-income wages are relatively stable and have historically reflected long-term, consistent tenancy. With diminishing housing supply and little ability to construct new middle-income housing under the current construction techniques, the supply and demand imbalance makes middle-income investment an extraordinarily risk-averse investment. By reducing risk perception and lowering the cost of capital, a more resilient product may be produced that does not rely on harvesting every dollar to meet increased return expectations.

One solution is to provide a “new product” for the longest-term holders. If a low-cost, high-operating-return product is created, interest rates may come down because the risk is lower. This provides a model for housing that is cheaper to build, cheaper to operate, and higher quality.

One of the primary drivers of costs is a.) time based or step-by-step construction and b.) specialized labor. Time-based or step-by-step construction refers to the process of traditional construction models, such as Framing→Utility Rough In→MEP/I installation→Insulation→Drywall→Finish Surface→Paint. This process relies upon multiple trades and time for materials to cure before the next step may take place. This process may be impacted by a.) trade availability, b.) human error, and c.) conditions (i.e., weather, etc.). Furthermore, usage of corrosive or vulnerable materials such as paint, glue, wood, drywall, etc. have a high likelihood of impacts such as water, fire, etc. increasing the chance of loss which further relies upon multiple trades for remediation and is a key driver to future insurability.

There is therefore a need for a holistic look at housing investment across the entire 100-year lifecycle of a typical multi-tenant building. Having significantly less investment risk may open up a much larger capital base for housing development. This may rely on a lifecycle view across the entire lifecycle of the “built” infrastructure. To facilitate this, there is a need for built infrastructure designed with a focus on efficiency and cost-effectiveness across the 100-year lifecycle, including planning, construction, operation, and maintenance.

### BRIEF SUMMARY

A smart panel system includes a number of smart panels, each including subpanels that contain micropanels. Each micropanel has various components, including nodes, internal lines, internal connectors, and a unique identifier. The micropanels are composed of layers, which include a processing layer, a communications layer, and a module controller. The module controller features an Artificial Intelligence Operating System (AIOS) with multiple software Artificial Intelligence (AI) agents, each designed to handle specific tasks. The AIOS also includes logic to control and monitor the subpanels and micropanels.

A method of monitoring and controlling a smart panel system involves receiving identification data, state data, and operating data from smart panels. Each smart panel comprises a subpanel with a node, internal line, internal connector, and unique ID. Micropanels within subpanels have layers, including processing, communications, and other layers.

A module controller receives this data and features an Artificial Intelligence Operating System (AIOS) with multiple software Artificial Intelligence (AI) agents, each dedicated to specific tasks. The AIOS has logic to control and monitor subpanels and micropanels.

The AIOS analyzes the received data, generates input tokens, and creates prompts based on these tokens. It then generates AI outputs related to these prompts and applies these outputs to the smart panels through the AI agents. This approach enables the module controller to monitor and control the smart panel system, potentially allowing for more efficient and intelligent management of the system.

In various embodiments, a method of creating a smart panel system involves providing multiple smart panels, each comprising subpanels and micropanels. Each subpanel includes nodes, internal lines, internal connectors, and a unique ID. Micropanels contain layers, such as processing, communications, or module controllers, which include an Artificial Intelligence Operating System (AIOS) with multiple software Artificial Intelligence (AI) agents. Each smart panel is physically connected to another smart panel.

The AIOS controls subpanels and micropanels, monitors their states, and receives identification, state, and operating data from the smart panel structures. The AIOS analyzes this data to generate input tokens, creates prompts from these tokens, and produces AI outputs related to the prompts. Finally, the AI agents apply these outputs to the smart panels.

The smart panels are connected using physical connections, forming structures. The AIOS uses this data to optimize the performance and operation of the smart panel system.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a micropanel 100 in accordance with one embodiment.

FIG. 2 illustrates a micropanel computing, power, and sensing layers 200 in accordance with one embodiment.

FIG. 3 illustrates a micropanel wall installation 300 in accordance with one embodiment.

FIG. 4 illustrates a subpanel 400 in accordance with one embodiment.

FIG. 5 illustrates a subpanel and wall rear attachment layers 500 in accordance with one embodiment.

FIG. 6 illustrates a subpanel with a door penetration 600 in accordance with one embodiment.

FIG. 7 illustrates a subpanel with a window penetration 700 in accordance with one embodiment.

FIG. 8 illustrates a subpanel surface points and external attachments 800 in accordance with one embodiment.

FIG. 9 illustrates an interior mounting 900 in accordance with one embodiment.

FIG. 10 illustrates a kitchen cabinet mounting layer 1000 in accordance with one embodiment.

FIG. 11 illustrates an exterior mounting layer 1100 in accordance with one embodiment.

FIG. 12 illustrates a smartdesk with wireless charging 1200 in accordance with one embodiment.

FIG. 13 illustrates a whole room panel components 1300 in accordance with one embodiment.

FIG. 14 illustrates a floor panel 1400 in accordance with one embodiment.

FIG. 15 illustrates a ceiling panel 1500 in accordance with one embodiment.

FIG. 16A illustrates a utility system layer 1600 in accordance with one embodiment.

FIG. 16B illustrates a utility system layer 1600 in accordance with one embodiment.

FIG. 17 illustrates a high-pressure water, HVAC, energy storage, and AC electrical distribution layers 1700 in accordance with one embodiment.

FIG. 18 illustrates a mechanical ducting and liquid HVAC layers 1800 in accordance with one embodiment.

FIG. 19 illustrates a utility hub and utility wall connection layer 1900 in accordance with one embodiment.

FIG. 20 illustrates a low pressure system and high voltage distribution layers 2000 in accordance with one embodiment.

FIG. 21 illustrates a high pressure plumbing layer connection 2100 in accordance with one embodiment.

FIG. 22 illustrates a rainwater, gray water, and black water layers 2200 in accordance with one embodiment.

FIG. 23A illustrates a low voltage DC electrical layer 2300 in accordance with one embodiment.

FIG. 23B illustrates a low voltage DC electrical layer 2300 in accordance with one embodiment.

FIG. 24 illustrates an exemplary physical component integration with major systems elements 2400 in accordance with one embodiment.

FIG. 25 illustrates a system controller 2500 in accordance with one embodiment.

FIG. 26 illustrates a method 2600 in accordance with one embodiment.

FIG. 27 illustrates a method 2700 in accordance with one embodiment.

FIG. 28 illustrates an AI system 2800 in accordance with one embodiment.

FIG. 29 illustrates a cloud computing node 2900 in accordance with one embodiment.

FIG. 30 illustrates a cloud computing environment 3000 in accordance with one embodiment.

FIG. 31 illustrates an item 3100 in accordance with one embodiment.

FIG. 32 illustrates an exemplary tokenizer 3200 in accordance with one embodiment.

FIG. 33 illustrates a deep neural network 3300 in accordance with one embodiment.

FIG. 34A illustrates inference and/or training logic 3400a in accordance with one embodiment.

FIG. 34B illustrates inference and/or training logic 3400b in accordance with one embodiment.

FIG. 35 illustrates a basic deep neural network 3500 in accordance with one embodiment.

FIG. 36 illustrates an artificial neuron 3600 in accordance with one embodiment.

### DETAILED DESCRIPTION

### Foundational Technologies

The basic technologies for which knowledge is needed to understand this disclosure are:
1. Construction techniques including modularization, panels, fixed structure, familiarity with building codes, and standard construction techniques for structure, foundation, enclosure, and roofing
2. Core building subsystems including mechanical, electrical, plumbing, and information technology (MEP/I) infrastructure, with understanding of the tradeoffs between high- and low-voltage electrical systems and high- and low-pressure water systems
3. Greenhouse and other large enclosure structure technologies such as self-standing roof systems
4. Advanced energy, water, and communications technologies including solar roofing, battery and water power storage, water supply and reclamation, decentralized systems for energy production, and satellite, broadband wireless, and other high bandwidth remote site communication technologies
5. Real estate development, operations, and financing, including site survey, financing, tenant management, repair and refurbishment techniques
6. General contractor and specialty contractor software and technologies and workflows for structural, external envelope, roofing, etc.
7. Manufacturing for building and information technology including pre-fabrication, robotics automation and assembly, and just-in-time manufacturing and logistics optimization.
8. Computer hardware and software including embedded designs, microkernel, self-boot, Android, Linux, and other embedded systems, self-diagnosis, and reliability techniques. Micropower and micro communications technologies such as wireless charging, long range (LoRa) Qi and other wireless charging standards
9. Sensor technology including micro-electro-mechanical systems (MEMS), ultrawideband, accelerometers, strain gauges, humidity, temperature, millimeter wave radar, proximity, light detection and ranging (LIDAR), infrared (IR), and imaging
10. Computer networking, both wired and wireless including power over Ethernet (POE), WiFi 7, Bluetooth, domain name system (DNS), mesh networks, multi-master, and network switching
11. Reliability engineering, including fault tolerance, mean-time to failure, and other failure concepts, fault-tolerant systems design and evaluation, and operation and maintenance such as predictive replacement, break-fix reduction, and multi-failure analysis
12. Artificial intelligence (AI) and machine learning (ML) techniques including small model performance tuning, and fine parameter tuning, model optimization, dataset management, aggregation, automated code generation, machine learning operations, and data management.
13. Computer operations technologies including remote boot, integrated self-test, recovery strategies, and continuous integration/continuous development (CI/CD)
14. User interface techniques such as automatic notification, mobile user interfaces, and web interfaces
15. Security and privacy technologies including zero-knowledge storage, removal of personally identifiable information (PII), security policies such as encryption, signing, and sealing, and quantum-resistant keys and other future proofing techniques

### Technical Benefit or Technical Effect

### Core Innovations

The major new ideas in this disclosure are based on three core innovations:
1. Manufacturing, construction and repair are one system. Instead of each having their own workflow and architecture, all things that are physical may be managed through their entire 100-year lifespan.
2. The city is the computer. Every component in the structure and all things inside the building may be managed as one integrated whole with microprocessors in each important physical system.
3. A single learning private-and-secure AI. Every system is designed to learn preferences of the residents while minimizing cost and with zero-knowledge as the foundation of a highly private and secure system.

### Technical Benefit and Effect

These three core innovations have major technology benefits including:
1. Custom with economies of scale design. A predefined “palette” of design options may be delivered at extremely low cost. This may give structures made with this system up to 99% of the creativity of a full custom design with custom parts and on-site fabrication. Moreover, instead of expensive remodels, the system may allow “in one day” complete makeovers of existing structures and units.
2. Advanced materials and technologies. By using the most advanced materials and allowing a smooth upgrade path to new materials, the system may provide a growth path for the future. As new physical and electronic technologies and standards are introduced, the panelized system may allow full and partial upgrades easily.
3. Easy reengineering and simplification. The system is designed for a 100-year life, so may include new provisions for reengineering components. Overall, the system may reduce the total parts count of a typical structure from 10,000 custom parts to fewer than 10 physical panels that are replicated. In addition, components such as furniture, floor lighting, televisions, computers may be seamlessly integrated into the modular structure and managed with the same physical infrastructure. The use of these modular techniques may support automated permitting and expedited compliance with regulatory needs.
4. High productivity, automation and assembly. The system is designed from the start with a high level of automation and management. The system may thus allow on-site structure creation to minimize logistics costs and may feature full autonomous assembly of components, as well as placement with robotic systems of those components into built structures. The system may use a complete monitoring approach where every component from the factory floor through its 100-year life may generate a complete history of its location, performance, and other key parameters.
5. Long-term maintenance and operations. The system is designed to have a scalable level of redundancy and proactive maintenance. The structure owner may dynamically tune their desired reliability based on factors such as labor costs and downtime of facilities from typical repair intervals of 5 years up to completely preventative maintenance. Building residents may thus expect the highest grade maintenance level to not expect an emergency repair in 100 years. The in-panel intelligence system may be designed to be both fault tolerant and to provide AI models with complete data on all parameters in the building to optimize comfort, energy efficiency, and operational effectiveness.
6. Total communications and interconnect. The system is designed from the ground up to be completely interconnected and manage privacy and security as a seamless whole. Each system may have multiple interconnections for redundancy, and all have a single communications hierarchy.

### One Solution: Lowest Total Cost of Ownership (TCO) Through 100-Year MTBF in Buildings at Half the Price

Approaching the solution through the eye of the investor, housing production, particularly for middle-income earners, may be increased by reducing and eliminating risk through a total cost of ownership (TCO) model. In addition to driving down the cost of production, methods of production may be streamlined to reduce inefficiencies and lower overall construction costs, drive efficient building operations through both design and technological advancement to lower the cost of ownership, and deliver assets with 100-year-plus life cycles.

The disclosed system may automatically scale the redundancy and reliability systems needed to meet a desired target for mean-time-between-failures (MTBF), defined as the number of times a resident or structure user needs to move out, has a power failure, or other high inconvenience event. This may be accomplished within cost curves that do not scale to labor costs to achieve a cost reduction (e.g., 50%) compared with conventional techniques (which may grow over time as labor costs continue to skyrocket). This may be accomplished by focusing on:
1. Product. Broad economies of scale and smart manufacturing from the consumer electronics and automotive industries. These industries have 100× and 10× higher volumes than construction, so those technologies may be adapted in a unique way for construction.
2. Location. Peri-urban land with jobs and urban quality of life. Thanks to the pandemic, the work-from-home trend is here to stay, so specific novel technologies for building large-scale developments that are thought of as entire “districts” or “cities” may be areas of focus. Low land costs and the ability to build large neighborhoods and eventually whole towns and cities may be key.
3. Operations. Focus on lower costs with a high quality of life. Instead of buildings that are designed for a quick flip, for a nominal extra cost in building, systems may be designed that do not have single points of failure necessitating expensive, high-labor fixes.

### Description of the Disclosed Solution

To mitigate the drawbacks of conventional construction techniques and management, the disclosed system approaches exterior and interior walls by mitigating corrosive material, simplifying construction for manufactured production, and building fully integrated systems within the wall panel. These may serve as the primary vertical walls, both exterior and interior. They may also be fully integrated with MEP/I systems that connect vertically and horizontally for simplified production.
1. Production of “micropanels,” “subpanels,” and “panels” as new gridded, redundant, smart add-on to existing structures. At the base, small smart systems in the form of micropanels may provide smart services and monitoring. Next, subpanels (which may be thought of as optimized collections of micropanels put together) may be used to convert furniture and physical objects like wall hangings, bookshelves, and tables. Finally, a collection of subpanels may be assembled into panels. These may be used for whole-room remodeling and as the basis for building completely new structures.
2. Creating complete, self-standing structures scaling into entire cities. These systems incorporate key features that may support unprecedented low-cost functionality by integrating microprocessors into the smallest units, having a “gridded” redundant approach to all system components such as structural and MEP/I technologies. They may eliminate single points of failure, allow switching off of system elements to prevent catastrophic failure, and allow seamless “replace while maintaining operation” versus the typical “break-fix” where users are inconvenienced at a minimum and in danger in the worst case. They may be intelligent with a built-in processing system that may sense, serve, and store key ambient data about the environment and which may allow easy, modular replacement anticipating a 100-year-plus product life.
3. Assembly facility to scale the system components from a single room to an entire city. At their core, construction costs may be driven by manufacturing as much as possible in a factory, pre-designing components to fit together, and minimizing what is done “on-site.” The entire assembly facility may be placed on a “green field” site to minimize transportation costs and allow fully robotic materials handling and longer-term use of the same facility for repair and refurbishment.
4. Drive on-site construction to be up to 99% component self-assembly. Most of the previous work in cost savings has focused on the construction phase and assembling the physical components, i.e., the assembling of raw materials and products onto a job site. Most of this has much of the value added happening on itself. Wood may be taken in to produce a house. While modular construction has made some inroads in building components ahead of time, the industry fundamentally depends on labor. The disclosed solution may eliminate nearly all of the “custom work” that occurs on-site. Instead, components may be moved to the site and then may “self-assemble.” Each system component may have a unique identification tag in it which may determine its relative location and movement history. At assembly time, the tag may transmit to humans or robotic systems its intended use and direct its assembly through electronic components or removable display devices.
5. Predictive operations and on-site preventative maintenance. While production costs may be key, longer-term production is a small percentage of the 100-year operating cost of a building. For too long, the economics between developers in charge of the building and someone who is going to own the building for the long term has meant cost-cutting in production leads to high operation costs. The disclosed system's approach may be different from the start.
6. Refurbishment and updates for 100+ years. This is not normally contemplated when doing initial construction. The entire point of the hierarchy from subpanel to panel to modules and eventually to cities may be to allow easy upgrades to the facilities without performing a major “rip and replace.” A city built with the disclosed system may be as new in 2124 as it was in 2024 without needing to undergo multi-year reconstruction projects.

### Architecture

The overall architecture may be built modularly with modular components that may be assembled into more complex structures or used separately. The disclosed system may comprise a hierarchy of building blocks.

### Overall Architecture: Components, Systems and Software

There are three different parts to the architecture:
1. Physical components. These are the components that make up the buildings and provide the support and structure, such as the framing of the building, the foundation, the transportation system between buildings, etc.
2. Structural/MEP/I elements. These may be built into the physical components and may provide facilities for users and equipment, such as mechanical systems for HVAC, electrical systems for high voltage and main power (typically 120-240V alternating current (AC)), and plumbing that includes high-pressure water, low-pressure water, and sewage. These may further include information technology (IT) hardware such as network communications, low voltage POE, and computer elements such as servers and data storage.
3. City AI Operating System (AIOS). An AIOS may oversee the physical components and structural/MEP/I elements, and may work with human operators to design, build, operate, refurbish, and repair the overall architecture.

### Physical Components

The physical components of the disclosed system are modular, starting with a subpanel and each level building on the previous bio to city scale projects.

### Physical Component Design Principles

The novel guiding principles here are the opposite of the typical custom design with thousands of specific parts limited to the construction of a single or limited number of structures. Instead, the aim of the disclosed solution may be to limit variability in production while creating maximum modularity which may be combined to support a broad variety of uses:
1. Maximum modularity. Each level may the smallest number of unique stock keeping units (SKUs), which may increase scale and allow easy repair.
2. Complexity by repetition and hierarchy. Each level may build rigidly on the last. So a panel may be made of subpanels, etc.
3. Design variety by composition. This may provide a huge variety of design possibilities through various combinations of modules.
4. Swap-and-repair (not break-and-fix) and robotic assist first (not glue and hide). The disclosed systems may have the redundancy to allow swap-and-repair instead of catastrophic breakage that needs a human to come to fix it. All systems may be designed for ease of robotic assistance from automated materials handling to quick insertion and removal (instead of glue and hide).

### Physical Hierarchy: Base Components

The applications referenced herein reflect a hierarchy of applications. Ranging in order of scale, these applications include the basic components which may be used as add-ons, furniture or upgrades to existing structures:
Micropanel. A micropanel is a minimum “sub-subpanel” that incorporates sensing, processing, and other technologies for an existing room. These may be designed to fit seamlessly on walls, tables, and other locations to bring the first benefits of these systems to rooms. They may be portable and easily moved and installed.
Subpanel. A subpanel is a single modular smart section that may be used as a standalone to enhance existing rooms with lower cost operation and monitoring. It may have all the functionality and may be the base unit for mounting, sensing, and computation in the system. It may incorporate an upgradeable and redundant system for adding sensors, computers, networking, and power. The subpanel may be the smallest component having all of the AI compute capabilities. It may also use magnetic or other non-intrusive attachments to support mounting of photos, pictures, tablets, phones and even monitors upon its surface. It may be used for the interior or exterior of a structure.
Panel (wall, ceiling, floor and specialty). A panel is a composition of subpanels. Panels may be designed to be of standard width such as 10′×10′. Panels may have variants appropriate for walls, floors, and ceilings. There may also be specialty panels to meet specific needs such as providing high voltage (120-240 AC electrical) or plumbing. Panels may use a grid system for interior surfaces and mounting. No “nailing” or other intrusions may be needed. Panels may use a novel grid system of permanent magnets with Qi-2 or other wireless charging mechanisms with an integrated POE jack. Panels formed together may have the ability to form a multitude of spaces or rooms across all product types, from private offices to living rooms to kitchens and baths, etc.

### Physical Hierarchy: Large Components

“New build” systems may build on these basic components and may be used for major renovations or new construction:
Module (residence, office, medical room, warehouse bay, etc.). Panels interconnected into fully formed spaces or rooms may be used to form individual modules. Singular modules as well as combined modules may form the basis of a space or room. Integration of two or more base modules may provide the basis for a variety of uses including residential units, offices, medical treatment facilities, warehouses, storage, retail, hospitality, and other enclosed spaces within various real estate uses.
Structure (low-rise, high-rise, multitenant, commercial, industrial, etc.). A structure is a collection of modules with the addition of an exterior load-bearing frame, exterior enclosure, roofing, and foundation. Structures may vary by height with designs for: “garden-style”/low rise buildings with a maximum height of 35′, low- to mid-rise structures of Type V/Type II/Type III with heights of 45′ to 85′, and Type I high-rise structures for buildings over 85′ in height. Structures may also vary by their use and may use specialized modules for governmental, hospitality, residential, commercial office, retail, industrial, biomedical, infrastructure, and other designs. Structures may also be mixed use and may integrate retail, residential, hotel, and office modules.
Development (multiple structures connected to site infrastructure). A development may take a group of related buildings and may integrate green space and infrastructure such as utilities (power, water, sewage, internet) and transportation (roads, buses, rail, trolleys, etc.). At this scale, certain resources may be centralized. For instance, a development may have a single integrated weather-proof “canopy” system over all of its buildings to reduce the need for exterior enclosure and provide shade and inclement weather protection for parks and other green spaces. Typically, these may be mixed-use and multi-structured developments with governmental, hospitality, residential, commercial office, retail, industrial, and infrastructure structures.
Neighborhoods or districts (multiple developments in a coherent whole). Multiple developments and sets of structures may be integrated to form neighborhoods or districts on a mixed-use neighborhood or district scale. A typical neighborhood may include residences, offices, health clinics, educational centers, public safety buildings, and infrastructure scaled to handle all of them. These may all be managed as a single system using the disclosed solution.
Towns, cities and municipalities (multiple districts). An integrated system of multiple districts may form a town, city, or municipality. These may include specialized districts such as mixed-use developments, major shopping centers, government and judicial buildings, manufacturing, logistics, higher education, and hospitals. They may also use centralized infrastructure such as water, power, and sewage. They may be managed as a single system through implementing the disclosed solution.

### Physical Hierarchy: Support Components

In addition to building blocks described above, the disclosed solution may include supporting systems that handle each phase of building a city from design to build to operation to refurbishment:
Modular factory, repair, and refurbishment components. The same modular approach may be used for the production of the disclosed components. The design may integrate “on-site manufacturing” directly into developments to convert much on-site custom construction into an automated, inspectable, and quality controlled “factory system.” After initial construction is complete, the system may convert the fabrication facility into a repair and refurbishment facility that may allow for automated repair of all components, from micropanels to subpanels to panels to modules and whole structures, using the same fixtures and tools (such as painting).
Modular transportation, materials handling, intra-structure and external road systems. Instead of using traditional “dumb” roads, the disclosed system may integrate automated assistance into the roadway that may allows robotic vehicles to move modules and other components from the modular factory to structures. The monitoring and path system may facilitate the construction of robotic systems that may move materials during construction in a slow and safe manner. These may integrate with exterior lift systems and interior elevator systems to move components to the outside and inside of a destination building. After initial construction is complete, these systems may be used to automatically provide daily services such as mail, package, and meal delivery, as well as more major services such as move in/move out, removal of failing large scale components, and transport to the repair and refurbishment centers.

### System Layers

The major subsystems in a building make the empty shell livable. They provide the water, power, light, and plumbing that are essential to forming a habitable dwelling. In this disclosure, they may be implemented using a modular “pick and choose” design that may fit in at any level of the physical component hierarchy. This may allow many degrees of freedom in choosing between short term construction cost and long term livability and operating cost. The major systems may be arranged in layers in each of the physical components. This may allow easy sharing, simplified production, and easier maintenance to have a regular grid for all system layers.

### System Layer Design Principles: Fault Tolerance is Key

These degrees of freedom are achieved by following three design principles that allow the composability of any system element into any physical component.
1. Sensed, Switched and Stored Data. Unlike conventional construction, each major component has a sensor, and all major system elements may be isolated remotely.
2. Scalable Redundancy. But by default, all system elements are 2-way redundant. If say a plumbing joint fails, there is another fully redundant and separated plumbing line that may take over. Each system is physically routed by an optimization AI to minimize crossovers and single points of failure. The system allows no redundancy for cost reasons, 50% failover (that is in a 2 way system if a system goes down the other may supply ½ the needs, so it is down but not out). And may scale from 2-way to 4-way or higher if the system is highly vulnerable. The advantages of this approach are complete design flexibility and low operating cost. Theoretically, a 2-way system may have 4× fewer failures (so an MTBF of 5 years goes to 20). But since a fully redundant two way system allows preventative repair and full replacement, true MTBF is essentially infinite. If a component has a failure rate of every 5 years (assuming a week to repair), then a simultaneous failure may occur every 187,200 years. This illustrates the benefit of a full 2 way redundancy. The system may scale based on timing the residency at each level of the physical component hierarchy.
3. Lowest Possible Low Power and Pressure. The final core principle is that a high power system may be avoided where a low power or low pressure system is sufficient. High pressure and voltage systems may fail catastrophically, with significant personal and property damage. Instead, low power may be utilized as much as possible, and reservoir systems may be used to store reserves for anticipated peaks.
4. Building blocks into any physical component. A single system element may not be moved to any location in the physical component hierarchy. So for instance a water reservoir may be inserted any way. They work like building blocks.

### System Layer Descriptions

The major systems in a building are Structural, Mechanical, Electrical, Plumbing and IT (S/MEP/I):
1. Structural including Foundations, Enclosure, Transportation. These elements ensure the physical safety and stability of the construction. The core components of the structural system are sensing units which determine the sag, movement and strain on the physical components. A framing system that provides the internal stability for each building. The enclosure, including the roofing, provides weather protection for the building. Finally, for developments it includes the roadway, parking, pedestrian, logistics and material handling. And it deals with the connection to the outside world. At each level there may be vehicle parking and material warehousing and storage.
2. Mechanical: Ventilation, Heating and Cooling. These systems support HVAC and are typically divided into three components. Ventilation to assure airflow through the structures to maximize air quality. And then the heating and cooling. Both passive systems such as automated shades, electro optical glass, etc., and management software platform, may be used for predictive analysis to prime the system with adequate thermal reservoirs.
3. Electrical: High Voltage, Mains Power, AC. This system supplies the main power and also allows storage and micro-generation and step-up or step-down across the entire high power system.
4. Plumbing: High Pressure, Heated, Low Pressure Water, Runoff and Sewage. This supplies water into the building that may be at typical high pressure (over 40 psi and typically high volume through ¾″ and larger lines delivering 20+ gallons per minute), heated water and low pressure water (typically delivering 0.2 gpm). In addition, these systems handle both black water sewage and gray water runoff. As well as Life Safety systems (sprinklers).
5. Information Technology: Networking, Low Voltage Power, Computers and Data Storage. These systems process the sensor data that comes from the physical components and actuate the various gates, valves and switches in the MEP systems. It provides stable, reliable wireless and wired networking, caching and reliable wide-area networking (WAN) to the outside world. It also provides low voltage (5-20V) and low power (2-240 W) for low-demand devices such as light emitting diode (LED) lighting, computers, phones and televisions. In addition, it provides a computational fabric to run the AIOS across the entire system with controllers, full computers, servers and varying data storage in the system.

### AI Asset Management System and Design (AMD)

The overall physical components with their embedded system layers are designed and managed by a comprehensive distributed AI infrastructure including:
AI Asset Management (AM) System. At its core, the AI integration is both a tool for systems operations as well as an asset management and reporting tool. The AI AM system provides a real time look at each level of the architectural hierarchy with a unique interface and set of controls for each user type. Those user types include Owner/Investors, Facilities Managers/Property Managers, and Resident/Users.
Operations Management Distributed S/MEP/I Systems. Each of the major subsystems has a management control plane that may securely and privately operate the system. The system uses AI prediction techniques based on external weather, internal traffic patterns and other parameters to stage power, water and other resources to meet peak demand while storing during off-peak across the entire physical component hierarchy.
Owner/Investor Platform. The Owner/Investor Platform is a cloud-based portal that allows Owners/Investors real time access to information gathered by subpanel layers to provide a.) current asset conditions, b.) predictive analysis on capital expenditures, upgrades, and enhancements, c.) aggregated data for customizable reporting including benchmarking, property performance, sustainability reporting, etc.
Facilities Management Platform. Facilities managers, property managers, and other similar personnel associated with the care, maintenance, upkeep, and oversight of the asset are given access to a Facilities Management Platform which provides predictive oversight to all asset facilities to optimize building management. For example, if the overhead lighting in Unit A were coming to the end of its useful life, management may be notified prior and may change the light for a new one. The Facilities Management Platform heavily relies on both the subpanel sensing layers and AI management tool to negate the “break-fix” operating model move towards predictive asset management.
Resident/User Interface. In addition to the owner management systems, end-user control systems may be provided for lighting, power, music, entertainment, and security systems. Those controls may be unlimited or restricted depending on the condition (i.e., employees of an office user may have access to certain controls, however, are limited by facilities management who have “master control”). In addition to controls, residents and users have access to reportable data including individual and asset level performance such as energy usage, water usage, etc. with visualization metrics to highlight individual resident impacts.
Actuarial and Risk System: Dynamic Rental Pricing, Development Association and Other Fees Management and Good Resident Scoring. Because the system has much greater understanding of the facilities and their actual usage. For instance, the sensor system may sense vibrations, damage to panels, smoke damage and other potentially prohibited activities, the system allows owners to assess appropriate fees and provide appropriate discounts for “good residents”. As an example, if a resident has used the system “gently” with no wall penetrations, minimal cabinetry impacts, the system may dynamically assess this and provide a discount. Similarly, for excessive wear and tear, there may be both an immediate intervention (such as an email or message notification) indicating that such violations are occurring and automated billing. The system may maintain a “good resident” score that analyze the initial risks that a tenant is taking and project based on past data what the actuarial risk of a particular resident. This might result in change to insurance surcharge and discounts for instance or to core Development association fees.
Personally Identifiable Information, General Data Privacy Regulations and Zero-Knowledge Data System. Because this data may be confidential, the system uses a zero knowledge system which anonymized the identification of individual residents and structures unless the appropriate keys are provided. For data that is legally owned by residents, the system may use a “double encryption” with revocation. That is the data is encrypted by both the structure owners' keys and the legal owner of the data. If a resident chooses to, they may invalidate the temporary key and make it impossible for others to see the data.
Generative AI Design System: Layout, Aesthetics and Reliability Components. Given a set of parameters such as the number of residents, unit type, rent levels, operating cost, public safety, regulations, zoning, amenities as well as time to travel and to food, work and desired lifestyle, the AI expert may automatically generate a series of site layouts, unit mix, and other variable conditions that meet these constraints. Furthermore, with access to real-time costing data, these models may supply up to the minute construction budgets, construction schedules, and underwriting proforma to developers, owners, and investors. It may produce three-dimensional (3D) models and virtual reality (VR) walkthroughs for further design work and for investors and tenants. The system may also meet the MTBF needs and perform simulations given varying conditions and climate change assumptions for the next 100+ years to determine redundancy needed, etc.
Generative AI for Design: Construction Drawings/As Builts. With uniform panelization, once a desired project has been approved for production, pre-construction drawings and other architectural/engineering sets may be easily reproduced for owners, operators, and investors. Furthermore, upon completion, subpanel sensors and AI assistance may quickly reproduce “as-built” drawings that reflect the actual field execution of the project. These “as-built” drawings provide a detailed plan set for the project at time of completion and as the project evolves over time (e.g., additions, upgrades, etc.) those plans may be reproduced to reflect real-time changes to design.
Zoning & Approvals AI System. In cities, municipalities, and other conditions where zoning either is a.) not established b.) needs to be changed or c.) utilizes a “spot zoning” or approvals based zoning code to conform to the greatest possible use such as a Planned Development (“PD”, “PUD”), a multi-use permit (MUP), etc. predictive AI tracks data and trends to showcase highest and best use based of similar conditions, recent approvals, etc. as well as provide supportive data to support the proposed including demographic trends, economic impact studies, parking studies, etc.

### Wide Applications: Fixed, Mobile, Non-Civilian Applications

The physical components listed may be used in fixed structures such as homes, offices and retail establishments, but the form factor may also be used in a variety of mobile applications.

For instance, a subpanel (or micropanel) may be used in a mobile home, car, trailer, floating docks, oil rigs, aircraft, watercraft or spacecraft. This allows mobile and other transportation systems to be integrated into the AIOS and allows predictive and preventative maintenance for mobile applications as well. It may also have applications in any environment such as a large container ship or space station or non-Earth base to allow full control and high reliability in these environments.

The technology may be used in industrial applications such as paint rooms, welding areas or others that need proactive maintenance and also high observability of the surroundings. The “Factory Component” described later makes heavy use of this to build a Panelized Factory with all these benefits.

The technology also has broad applicability in non-civil applications. As an example using a Lexan Substrate, a subpanel may operate as a sensor platform, active defense base and passive defense system for military and law enforcement vehicles, bases and stations on the ground, in the water, underground, in the air and in space.

### Base Physical Components

There are two non-structural components that may be placed into any existing home, office or other structure. Adding them into an existing building allows you to have many of the benefits of the complete physical structure without new construction or extensive rebuilding.

The main components that may be used in many situations are:
1. The Micropanel. These are the smallest components that carry the minimum set of layers, typically of sensing, low voltage power, communications and processing. They are the quickest way to upgrade a single room to integrate into the AIOS and AI Asset Management System.
2. The Subpanel. This is a single integrated module with a layered design and a grid of connections for each layer. Each subpanel may include a unique ID, which is stored in a way that it is may be communicated to other components, including the AIOS. In some embodiments, the unique ID is burned into the subpanel at the factory. Micropanels may also receive unique identifications (ID)s. In some embodiments the unique ID is a present on the subpanel as a barcode or a QR (Quick Response) code. The microprocessors are embedded into the panel so it may participate in the overall system and be controlled and managed by the AIOS and AI Asset Management System. As an example, a subpanel may be used as a wall hanging, a television mount, a shelf system, a table, a desk or a whiteboard.
3. The Panel. A component conceptually made up of many subpanels. For cost reasons specific panels omit certain layers such as connections so a panel may be made as a single low cost unit.
4. Subpanel Autonomous Handling and Installation System. Because each panel is smart and self-connecting, an autonomous installation system allows simplified self-assembly. And allows replacement of existing systems.

### Micropanels: Quick Integration of Sensors and Control

The micropanel features a subset of the disclosed systems. It is a minimal and small system designed to quickly add sensing, processing, data communications and other features to an existing room. The typical micropanel may be lightweight, portable, and battery powered. A typical configuration may feature a single “grid” system. In terms of size, a typical system may be as small as 3 cm×3 cm or as large as 0.5 m×0.5 m. Larger systems with multiple grid points are called SubPanels (see below).

The micropanel covers a portion but not the entirety of the ceiling, floor, wall, panel, or any surface plane. They are powered by local power supply and act as a small format subpanel which may include all of the functionality described here including connection of smart devices, power supply, etc. This form factor allows installation in a wide variety of areas, not just structures. This may include wall mounted applications in homes, offices, and other real estate conditions as well as mobile homes, vans, etc.

The micropanel may also be an application running on an existing appliance, smart home product, electronics, phone or tablet to support integration of control and sensing into the main system.

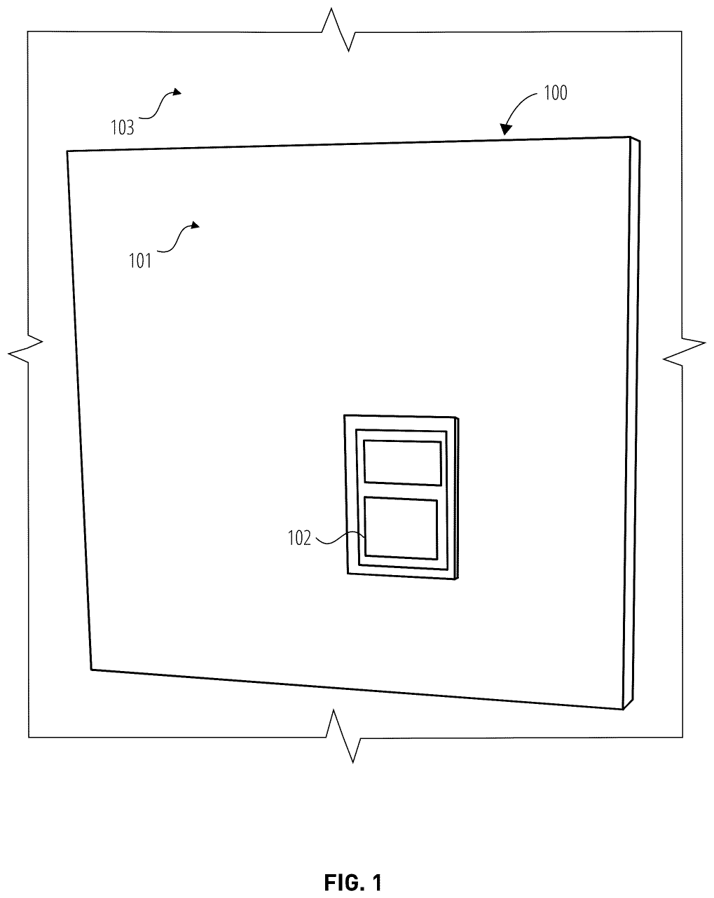

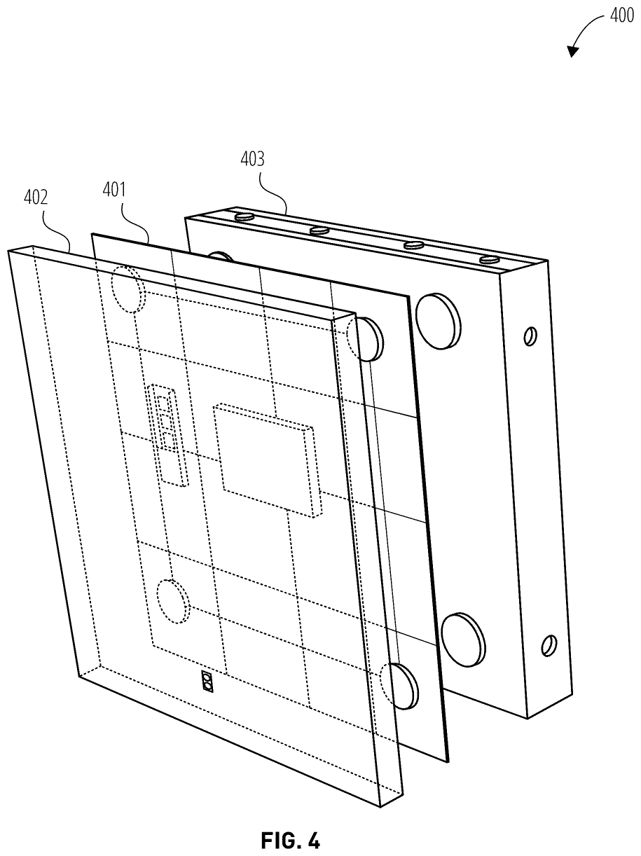

The micropanel, as illustrated in FIG. 1-FIG. 3, and as illustrated for the subpanels of FIG. 4-FIG. 8, may comprise the following layers and systems, the micropanel being a small format subpanel as previously described:
1. Wall Rear Attachment Layer. This system is light and portable and may typically have a single attachment point which may use magnetics such as a Qi2 magnetic pattern to correctly orient it and power it.
2. Front Attachment Layer. This system may typically have a single grid system that may allow small charging and other facilities.
3. Display Layer. This may typically integrate a display so it may operate as a home control and other system.
4. Sensing Layer. It may include a collection of sensors used for that particular application. Typically this may include temperature, moisture, humidity, millimeter wave or other presences, IR, accelerometer and gyroscopic systems.
5. Processing Layer. The system may include one or more processors to support the operation
6. Communications Layer. Typically this system may have a mesh access point and have the ability to be wired through the rear connection system or via WiFi, Thread or other wireless communications.
7. Low Voltage Power and Battery Layer. This may have a complete low voltage system to power the unit, and anything attached to the grid and typically have battery power that may be replenished from wireless charging, direct connection to low or high voltage as a rear attachment connection.
8. Secure Computing and write once, read many (WORM) Layers. It may include the entire security subsystem to prevent intrusions and also to record events and diagnostics. It acts as a full node in the AIOS.

Typical uses of this device may be to gather data to build the predictive model for the AI asset management system.
1. Home Thermostat and Home Control. While it does perform sensing operating, it may also have utility for users in the buildings, such as home thermostat and other home control.
2. Sensing System for AI Asset Management System. The system may also allow sensing of key data to optimize the overall building, room, cost of ownership and comfort.
3. Security and Life Safety. It may connect directly into the life system and other systems.
4. Mesh Access Points. The device may provide additional wireless connectivity as well.
5. Messenger and other Communication Services. It may be able to provide intercom and other services.
6. Third Party Applications. It may have an environment such as the Android operating system or equivalent to host other applications for user entertainment, productivity or other uses.

FIG. 1 illustrates a micropanel 100 in accordance with one embodiment. The micropanel 100 may comprise a micropanel hard cover plate 101 and an integrated smart touch screen 102 visible when assembled. The micropanel 100 may be mounted upon an existing wall 103.

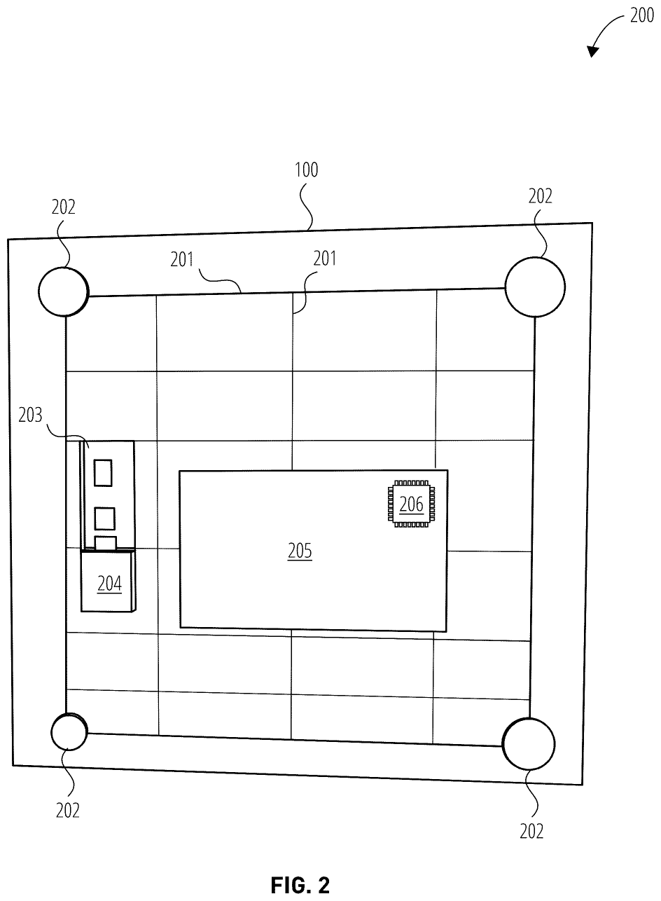

FIG. 2 illustrates a micropanel computing, power, and sensing layers 200 in accordance with one embodiment. The micropanel 100 may include internally these micropanel computing, power, and sensing layers 200 in support of its functionality within the disclosed system. The micropanel computing, power, and sensing layers 200 may comprise low voltage CAT-6 wiring 201, Qi-2 magnetic connectors 202, an embedded sensing layer 203, a sensor cover plate 204, and a microcomputing layer 205 including at least one microprocessor 206.

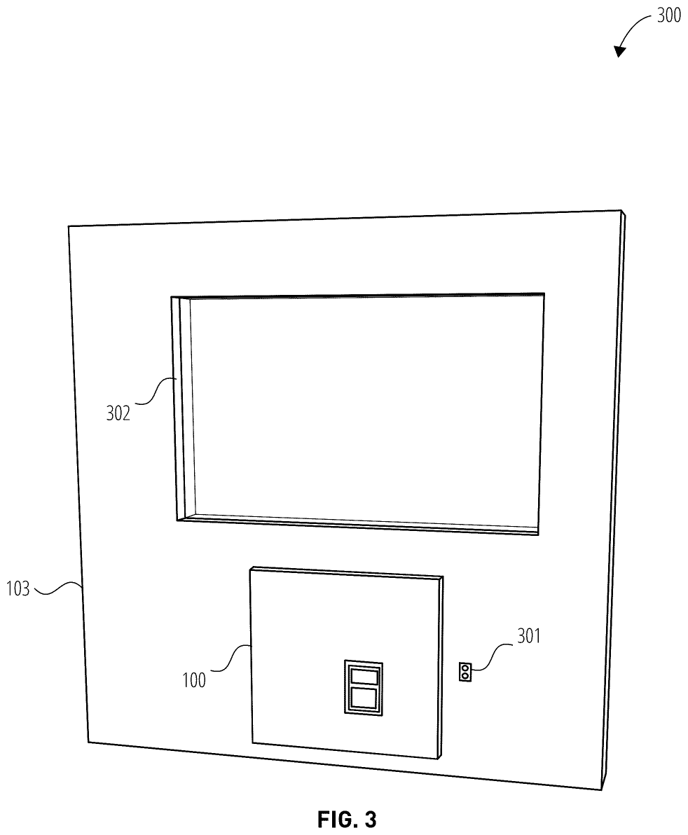

FIG. 3 illustrates a micropanel wall installation 300 in accordance with one embodiment. The micropanel wall installation 300 may comprise a micropanel 100 mounted upon an existing wall 103 having in one embodiment an existing 120V outlet 301, and a window penetration 302.

### Subpanels: Add-on to Existing Rooms and Structures

A subpanel is the smallest component that has the full set of layers of this system. It may be used as a standalone unit integrated into existing structures to improve the overall building system. A panel is multilayered with a specific system component occupying a single level.

Each layer has a regular layout of nodes (e.g., a grid of Qi chargers).
1. There are active nodes in each layer. As an example for the low power electrical, each node may be a Qi Wireless charging point. An example of a water node may be a low pressure water outlet. The subpanel uses a grid so that all active components are stacked on top of each other and in between there is redundant passive wiring/plumbing.
2. The connections between the wiring/plumbing is done with smart valves and switches. These are magnetically aligned and automatically centering. This allows a “plug and play” for all node connections.
3. Grid layout for nodes. The elements of each layer (such as a mounting point) are laid out in a regular pattern. For instance, a typical configuration may be a 1 meter×1 meter subpanel and the grid may be 0.2 meters. This may put a 5×5 point on each grid Qi Wireless chargers on each subpanel.
4. Layout is regular across many subpanels. The layout is regular in that if two panels are laid out, the regular pattern continues. This allows creation of any larger “panel” system which is completely regular.
5. Node stack. Each layer may have a different active component set and typically these are layered directly over and under each other to facilitate replacement in a “node stack”. As an example, a processor may be under the low voltage (LV) electrical switch and underneath that may be a Low Pressure water switch. A single “core” may be magnetically aligned and attached so that the entire node stack may be replaced. Each node is removable and replaceable. As technology evolves, a non-adhesive mount system is used that may allow easy replacement of nodes.
6. Node Grid. In some cases, nodes may have a “grid pattern”, so that every other node stack may be electrical and the other may be water oriented. This allows interconnection at the surface to be different. A typical “LV” node stack may be all LV electrical, that is data, low voltage power, wireless charging. Another typical “Water” node stack may have low pressure water, low pressure waster and high pressure water.

Each layer's node is connected in a regular grid of connections.
1. Connection or wiring is done in the same grid pattern. So a Qi charger may have four different ways to access power from each edge of the subpanel.
2. As an example, a 5×5 grid may have each charger connected to four power lines from the top, bottom, left and right of the panel.

The node state and connection is sensed, switched, and stored (3S):
1. Every node's state is transmitted to higher level elements. Each layer may have different data, but at a minimum the operating condition of the node and whether it is on or off is kept.
2. Every connection in the system is similarly monitored and also may be switched on and off.
3. There is a low power subpanel controller which stores this state, provides subpanel control and secure access to the data, and allows higher level systems to control the subpanel.

Subpanels are physically mounted to a backing system and to each other by a regular mechanical connection points that are magnetically aligned:
1. Between each subpanel are a set of connection points that are reversible and aligned magnetically (they may also be physically keyed and locked, but the magnetic alignment allows self-alignment and then the system may be physically locked.
2. Assembling a number of subpanels may automatically align all the connection points.
3. The state of these external connections to the subpanel are also sensed, switched, and stored by the subpanel processors.

Subpanels have multiple layers, and these are physically isolated from each other. As an example the panels are layered with moisture, electro-magnetic shielding to prevent problems in say a water layer from shorting out circuits in an electrical one. Or a communications layer is physically shielded from Mains Power to prevent interference. This may typically be done with foil or may be a physical property of the wall itself. For instance, concrete with inlays is physically resistant to water seepage.

Typical layers may include the following components:
1. Node. This is the active components at each “point” in the grid.
2. Internal Line. Each layer has a regular redundant set of electrical, optical, fluid, air or other types of lines that are in a grid layout which connect nodes to each other and the outside world. So every node has typically four connections to it (top, bottom, left and right).
3. Internal Connector. How a node may be connected/disconnected from the internal water, power or other line. This is magnetically aligned and, depending on whether it is electrical or fluid, may use either a “magnetic”, “snap in” or “water tight” connector.

Subpanel functionality is exposed vertically through a series of layers by and at the front, back, or edge of the subpanel with a vertical core. In one embodiment, the vertical core may be configured as described below.
4. Vertical Core with One or More Nodes from Multiple Layers. This is the “vertical core” at each point, so in general, different ones may be placed at different grid locations and a vertical “Core” may typically have a set of Nodes from different layers that form a multi-functional whole. For example a “compute core” may include data communications, low voltage power, and compute components. These cores are designed to be field replaceable and are exposed on a side of the subpanel, typically the front facing side.
5. Surface Connector/Attachment Point for Core. At the surface of the core where it is exposed to the outside world, there may typically be an attachment and/or connector mechanism or a hybrid. An attachment surface for example may physically mount a subpanel to another structure. A connector mechanism might be just an electrical one for Mains AC power. Or it may be a combination such as a Qi Attachment system plus a mechanical attachment system. Or a hybrid such as a data/low voltage power system with Ethernet, universal serial bus-C (USB-C) and radio frequency identification (RFID) in a single outlet. Typically, a hose bib outlet or a direct current (DC)/AC/local area network (LAN) outlet may be used separately for space and safety reasons to separate electrical outlets from fluid inlets and outlets.
6. Surface Insertion/Removal Mechanism for Core. This also describes how the “Core” is inserted and removed. The Surface attachment/connector system also integrates a removal system. This allows the combined surface plus node system to be removed for repair and replacement. This uses a mechanical interlock system and also electronic identification of cores and their positioning.
   Subpanel Functional Layers and their Lines, Nodes and Typical Connection Points
1. Substrate Layer. The various layers are themselves supported and encapsulated in a substrate layer system. This layer system may be concrete for long term reliability, it may be a thermoplastic for applications that involve the need for lightweight systems, The connection lines in the system may be “reinforcing systems” that provide additional structural rigidity to the entire subpanel. At each node point in the substrate, there may be a substrate sensing system that determines with strain gauges and movement sensing the load stress on the substrate. The substrate node may also have a mechanical load bearing system that supports a surface mechanical attachment system. This allows heavy objects to be carried on the “user facing wall”. It also allows dynamic load adjustment to occur on the “structural system” to which the subpanel is attached. The substrate may also be transparent, either glass, plastic or Lexan. This allows the system to be used in applications such as greenhouse walls and ceilings as it may allow light through the panel that may be partially occluded by the grid system. In applications that use glass, the “grid system” may use transparent components or avoid the glass area to allow the subpanel to be used as a “windows” or “porthole” or “viewing port”. In other applications, the substrate may itself be electro-optical and act as a smart shading system. Or it may use transparent armor or Lexan to allow home security or military applications but provide for both sensing and attachments of various devices. The substrate may also be heat resistant to allow use in high temperature environments. The substrate may itself be electroluminescent and allow both active lighting and emergency lighting that may be controlled at the “grid” level.
2. Display Surface Attachment and Node. The system may include a display layer that covers some portion of the grid. This may be created by attaching the display using the front attachment system for easy replacement. It may also be integrated into the actual panel by recessing it for flush mounting, but may still use the magnetic alignment and mechanical support layer for security. In this system, the display layer may typically be on the front, back or left or right side at the surface. It has a grid section but doesn't have an internal connection system. Instead, at a display node, there is a core that integrates nodes from the compute, storage, DC power and communications nodes.
3. Opacity, Windows and Penetration Support by Grid-Skipping/Bend in Layers and Internal Edge Attachment Points. A subpanel may have holes in its grid layer and may not have a regular pattern. For instance, if there is a subpanel penetrations such as doors openings or glassed openings for windows, then the “grid” may “bend” around those points that have several parallel lines in close proximity on the edges. Or the grid itself may “tighten” around a penetration. This is determined in the computer-aided design (CAD) process. As an example, for a 3×3′ penetration, if the grid is on a 1 foot center around the penetration point, the grid width may drop to 4-6″ next to the penetration and then “stretch” on either side. Typically, for penetrations like this, the “interior” edges may have edge attachment points which allow a flexible method of adding smart doors and windows which may have their own subpanel that may provide information to the overall system. There might be shades or louvers to close or open a penetration.
4. Internal Insulation Layers with Internal Sensing. A panel may have a variety of insulation systems in a layer to both protect from fluid or electrical leakage between layers or to provide better temperature control for the interior of a structure. In the simplest form, the insulation layer may not be present, but an insulation layer may be any of a set of standard ratings from R-3 to R-40 depending on application. The system allows both a single layer insulation, but using the surface mount attachment description, subpanels may be aggregated so for instance a dedicated subpanel may have insulation ratings of R-100 or more for extreme weather conditions and these may be applied in sealed safe levels to any installation. The insulation layer may have low voltage connectors to sensors at each node point that may detect temperature, moisture, movement and other key parameters in the insulation. For internal layers, temperature and moisture may also be used as an external check on important systems. For instance, it may be a fail-safe that detects overloads in electrical systems or leaks in fluid ones.

In addition to these physical layers, the MEP/I layers in each panel include:
5. Exterior Sensing Layer (Front, Back, Sides and Internal Penetrations). This layer monitors the internal physical state and ambient state of the panel. Each node has temperature, humidity, accelerometers, gyroscopes and impact sensors, millimeter wave to detect occupancy, cameras and IR may be optionally mounted as well. This may determine problems with HVAC and provide presence sensing for temperature and lighting and other controls (such as television). It may also detect moisture. The sense level may also sense wind, IR, seismic activity, CO₂, and total volatile organic compounds (TVOC), and other compounds. The sense layer may for redundancy have its own dedicated sensor processor and low voltage power and communications connections. This may allow the use of ultra lower power systems where each insulation node has a small battery, low power security operations center (SOC) that may support continuous monitoring for long periods of time. Alternatively, the sense node may be integrated into a Sense Core which instead uses the DC power, data communications and relatively higher drawing but higher performance compute layer.

In addition to these core layers, the system may typically have these additional layers.
6. Low Voltage DC Electrical. The system may typically have a low power electrical system based on standards such as Power-On-Ethernet. The DC layer has connections which are typically low voltage and fluid-proof such as Cat-6E Ethernet which allows combined data and power. The nodes in the DC layer may have a switch system that may control power draw from any of the connection lines (typically 4 in a standard grid, but this is tunable). As noted before, the power to each may be monitored and connections may be managed. The DC node may typically supply power to both internal nodes and also to surface attachments in the same “core” (that is all the nodes in other layers that in the same “vertical grid point” For instance, if a given node needs 100 W of power, a single wiring connection line maybe used and all devices on that same wiring line may shut off their current draw and use the other redundant wiring lines on “circuits” with less power draw. In this way, the system may manage power use and ensure that there is never power loss nor overload. If a connection fails, the system may reroute power to the other lines available. The DC Layer may have, in addition to switching and sensing capability, it may have power storage components. A low-power battery system in DC notes, for instance a Li-on battery or a super capacitor may be used to maintain DC power. The amount of power stored may be customized based on the needs by installing more or fewer uninterruptible power supply (UPS) systems in the low power grid. This may allow for instance a partial power failure to be rerouted to a working low power system and also serves to provide power if an entire subpanel part is isolated.
7. Wired Communications Layer. The system may include a grid of wired connection lines. Typically this may be electrical Ethernet rated cables that today support 10 Gbe to 40 Gbe. The connection lines may also use optical fiber which may allow cross subpanel operation well into the 900 Gbe range. In many cases, the low power and wired connection lines may be merged such as with Power-on-Ethernet to simplify the design. Each node in the wired communication system may have an intelligent switch which may typically handle protocols such as link aggregation control protocol (LACP) to send their traffic intelligently to the least busy connection lines. The internal connection power between the node and the lines may typically be magnetically aligned with magnetic proximity attachment. If higher reliability is needed, they may use mechanical connection after magnetic proximity alignment. The system also allows key connection as in traditional RJ-45 connectors, but also supports dynamic symmetric wire insertion such as used in USB-C.
8. Processor and Volatile Storage Layer. Internally the system has a collection of low-power microprocessors in various nodes that manages all these functions and forwards all sensing data forward. These processors may typically be 2-4 in a single subpanel for redundancy and may cooperate to determine when one of the units has failed and also divide responsibility between the processors. This layer also includes both non-volatile storage, random access memory (RAM) and solid state drive (SSD) storage. Depending on the application, the subpanel may store information itself and relay it forward. It may act as a cache so it may work independently. The Processor allows full control of systems and may route requests such as from a Thermostat to turn temperatures up or down. It is the core of integration for Smart Home technologies. The processor also maintains a 3D model of its environment which is shared with all attached panels. This 3D world update allows the panels to sense and operate as a unit. The 3D world may also be integrated with other data sources (e.g. other subpanel systems present). The system also includes a firewall mechanism to prevent “rogue” systems from executing denial-of-service (DOS) attacks and may selectively filter messages and in the worst case, severe physical access to affected components. Typically, the processor node may use a DC node and data communications node in its core. However, the processor layer may support connection lines that use a Management Ethernet for out of band communications and may also support a backup Power on Ethernet system in case the main DC layer fails.
9. Mains Voltage AC Electrical Layer. Overall, use of Mains AC power may be avoided in favor of lower power, easier to manage DC Electrical Layer. However, a Subpanel does support a full 120-240V AC power system. The connection lines use Mains AC voltage capable power lines. The connectors may use a magnetically guided, but mechanically connection system. The mounting layer may take 120-240V Mains power. It supports a grid routing system so that there may be high voltage power passed through the subpanel. Conventional power sockets may be put into the grid pattern. Typically, most attachments may use the low power system (currently up to 240 W which are most appliances lights and IT equipment) through either direct DC support with USB-C or with an DC/AC convertor in a core. The system may pass through mains power and act like an “extension cord” to other locations through its internal AC power grid. That is from one side of the subpanel to another. In certain cores, The Mains Voltage node may also be used to power the low voltage DC nodes and recharge the battery nodes in the UPS layer. Each AC node includes power drop and other sensors to determine line quality as well. And if there are outboard sensors such as an induction ring around a main power circuit, it may measure and report the power usage in a building.
10. Low Pressure Plumbing Layer. The subpanel supports a low pressure, low volume water system. This allows the use of “drip irrigation” for plants that may be hung on the wall. It also supports humidifiers and other room conditioning systems. The low pressure system is also laid out in a grid and the connections lines are typical 2-3 mm piping that supports typically 0.1-0.2 gpm compared with 20-40 gpm typical of high pressure systems. Because it uses a grid system, it does manage and control use so a single low pressure node may at its maximum get flow from 4 different connections to get to 0.4-0.8 gpm for higher use applications. The node measures the amount of water being used and supports scenarios where the water system may trickle feed a reservoir. For instance for a remote sink, the sink may have a 10-20 L tank and the low pressure system may feed that tank and refill it after occasional use. There is a moisture sensor and barrier at each low pressure water node and ability to shut and reroute water as needed. The low pressure node is typically connected in a core that includes the waste water layer. In a typical core, there is a surface attachment/connection system that uses a magnetically aligned low pressure water connector for fresh water out and drainage/grey water return. The surface attachment for this core may also include a magnetic system that may allow plant boxes, aquariums, water features to be magnetically aligned (and there is an optional mechanical surface system to ensure physical integrity typically). Another common “rear water core” may include attachments for fresh water in and waste water out. Nodes may also include a fluid reservoir system.
11. High Pressure Plumbing Layer. Again, while most water uses may be managed with low pressure and reservoirs, the subpanel does allow a layer that connects high pressure water 20-40 gpm and 40-60 psi in traditional piping in ½″-1″ sizes for the connection lines. A typical node in this system may have connection to four lines and include sensors for water pressure, flow and moisture. The plumbing layer may typically have a plumbing surface attachment layer which in that node may integrate with the waste water system. This supports high pressure applications such as laundry machines that need high flow and an integrated connection point. The use of this layer also allows “hose bibbing” so that the rear system may have a surface attachment point for a traditional ½″ hose that may power the low pressure system and has a grid system that allows routing of high pressure water as well. This may monitor moisture and humidity and temperature to determine if there has been a plumbing leak.
12. Mechanical Ducting and Liquid HVAC Layers. The subpanel may have a mechanical system. This may be in the form of air handling or may use water or liquid cooling and heating. These are also managed in a grid pattern with connection lines that are typically ducting for air/gas systems and plumbing lines for water-cooled/heated systems. The nodes in the HVAC layer may allow switching between any of the input lines in the grid. They may include sensors to determine input temperature and ambient temperature. This layer may use its own dedicated connection lines that integrate power and communications or it may use the data communications and power nodes to connect to the common systems. This may depend on reliability needs. The surface attachment point for this system allows exterior radiators or other systems to be attached or the entire surface of the subpanel may act as a heating or cooling element. If the subpanel is used in the “floor” application (see below for applications), the HVAC layer may be placed close to the surface to allow ambient “heating and cooling” through connection lines themselves acting as passive radiators. The subpanel system provides air ducting as well. With four connection points, this may provide redundancy and also allow waste management. For instance, during the day, “warm air” may be pumped into the basement levels and then used in the evenings to heat the systems. The surface attachment may allow electro-mechanical opening, closing and temperature sensing to control the areas that are temperature controlled. The surface attachment point may also allow a full AC powered packaged terminal air conditioner (PTAC) system with the surface point at that node connecting to AC power for the fan and the inbound cooling and outbound waste heat routed dynamically through the layers. As an example, cool intake air from the external unit might be routed from one line while on the other, the waste warm water may route to the external unit.
13. Rainwater, greywater and Black Water Layers. The subpanel may be used in the interior, for instance, to drain plants that may be on the panel. Or exterior of a building and allows the routing of wastewater, typically grey water such as rain runoff. The subpanel allows the use of multiple paths and may sense water flow and provide additional monitoring as needed. Typically the connection lines may be sized depending on needs. So that subpanel deployed in low water usage areas such as sinks may have smaller waste piping than for showers, laundries and toilets. The overall system may use a sparse grid system to minimize the number of “turns” that may cause clogs based on “pre-design AI”. Each node may include a shutoff system and flow monitoring as well to determine backups. The surface point may typically have a “cleanout” at specific points and to also allow periodic inspection. The system may typically be designed with independent grey and black water systems where the toilets may be attached to the black water system, but less volatile water such as from storm runoff or sinks may be handled in a separate layer, simplifying recycling and enabling wastewater reuse. Typically these systems may be “hinted” in the AI system to minimize bends and turns but also sized depending on projections of water use. The redundant water lines may be used for high capacity rain days or when there is expected heavy use (e.g., in the mornings) since each waste water node has independent switching across the various waste water connection lines.
14. Photo-Voltaic or Energy Scavenging Layers and high Voltage DC lines. The system allows a surface attachment point that may have magnetic alignment for an external layer of photo-voltaic or other wireless energy scavenging systems. This allows a subpanel to operate without direct power connection and also to provide power to other subsystems. A node in the energy recovery system may collect power and provide it at that core point to the low voltage DC system or high voltage AC depending on needs. Or it may have dedicated High Voltage DC connection lines in the layers. Another application for energy scavenging may be a surface point with light energy scavenging or wireless scavenging charging systems on the rear of the panel to allow wireless powering of subpanels from its mounting without the need for power cables, or if the power needs are low enough, from ambient lighting.

In addition to these functional layers, there are two layers dedicated to ensuring reliability in the event of failures. They have two different purposes: a) to maintain minimum function in the event of failure of all layers and b) to maintain security and prevent intrusions and attacks on the subpanel systems by adversaries.
15. Catastrophic Failsafe Control Layer. At the lowest level of the system, implemented in microcontrollers at nodes that manage the various switches and sensors is a mechanism for preventing catastrophic problems. Each layer has a set of parameters around what a catastrophic problem may be. A control node in this layer may use the low power and data communications nodes, but for greater redundancy may use connection lines between failsafe processors and also have battery backup in failsafe nodes. A fail-safe focused core may include in addition a failsafe connection point which may provide direct access to these safety systems in the event of emergency. Some uses may include for example, with the mains AC system, a sudden current draw at near the maximum capacity may most likely indicate a ground short. So an immediate shutdown like a “smart ground fault interrupter (GFI)” may be allowed at every switch point. In the water system a catastrophic failure may be the sudden loss of pressure on one side of the switch and very high flow rates indicating a major leak. And for the mechanical systems a catastrophic failure may be water or air that is much cooler or warmer than normal may be cut off. This layer is isolated from the processor layer and provides a fail-safe if all the systems fail.
16. Secure Enclave, Identity and Fallback Management and Write-Once Storage Layer. Over a 100-year life, a subpanel may be subject to many security and hacking attacks. The subpanel uses a “secure enclave” or processors, storage and programming in secure nodes to provide ultimate fail-safe security. It may also have dedicated secure connection lines in this layer with dedicated and separated power and data communications. Thus, upon the determination of vulnerability and problems, this system may reboot and restart the system. This system is highly constrained and uses “verifiable computing” techniques to minimize the potential for its corruption. That is a set of processors which run a limited set of software, and which may not be easily modified. It maintains the security credentials of each subpanel to provide cryptographically secured identity and encryption. This system oversees the overall operation of the processor layer and other functions. The internal processor and storage layer is installed at the start of the manufacturing process with an encrypted unique identification. It stores its position and location at all times and a read out of the subpanel for diagnostic purposes is available. This forms an indelible record of the history of the subpanel for manufacturing and warranty purposes.

FIG. 4 illustrates the layers of a subpanel 400 in accordance with one embodiment. The subpanel 400 may comprise a subpanel layer 401, a cover plate layer 402, and a wall rear attachment layer 403.

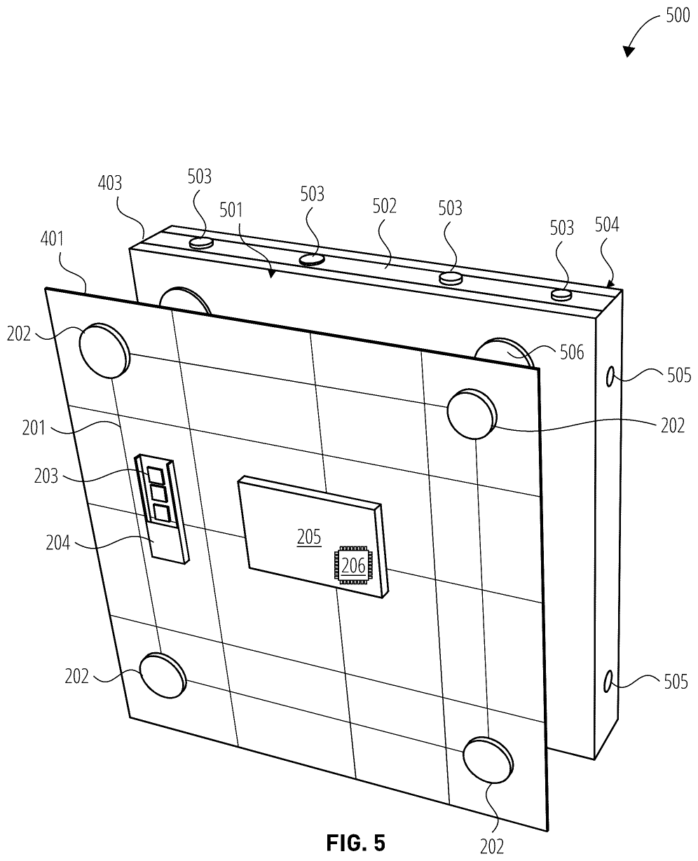

FIG. 5 illustrates subpanel and wall rear attachment layers 500 in accordance with one embodiment. The subpanel and wall rear attachment layers 500 may comprise a subpanel layer 401 that includes low voltage CAT-6 wiring 201, Qi-2 magnetic connectors 202, an embedded sensing layer 203, a sensor cover plate 204, and a microcomputing layer 205 including at least one microprocessor 206. The wall rear attachment layer 403 may include an internal wall surface 501, structure and insulation 502, vertical wall connections 503, a wall finish 504, horizontal wall connections 505 and surface connection layer 506.

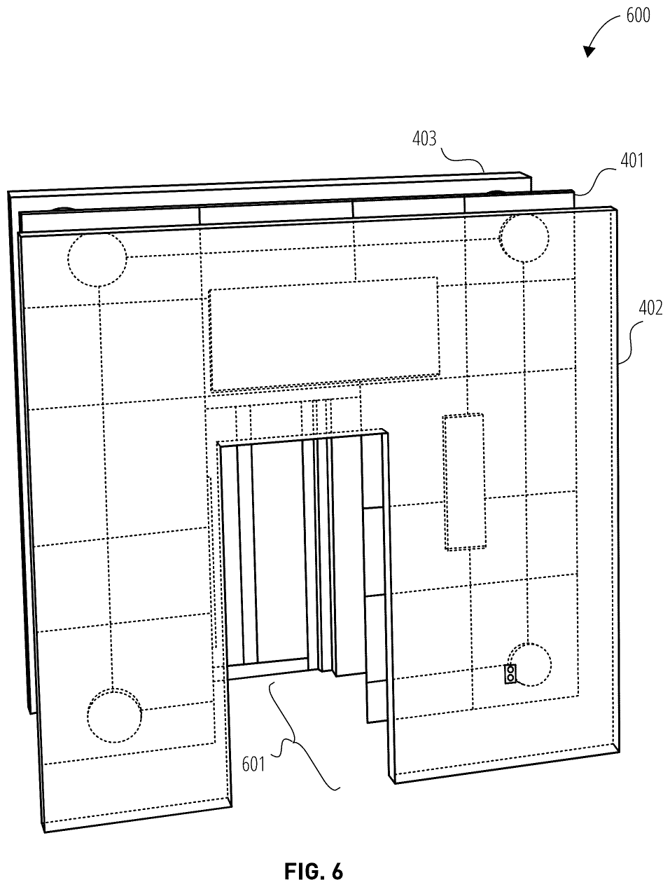

FIG. 6 illustrates a subpanel with a door penetration 600 in accordance with one embodiment. The subpanel with a door penetration 600 may comprise the subpanel layer 401, cover plate layer 402, and wall rear attachment layer 403 previously introduced, which may each be configured with a door penetration 601 as shown.

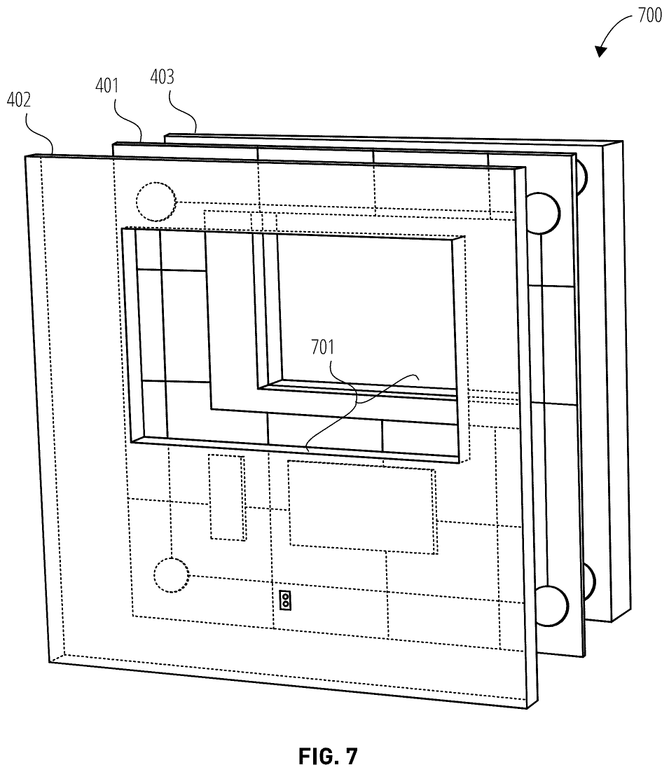

FIG. 7 illustrates a subpanel with a window penetration 700 in accordance with one embodiment. The subpanel with a window penetration 700 may comprise the subpanel layer 401, cover plate layer 402, and wall rear attachment layer 403 previously introduced, which may each be configured with a window penetration 701 as shown.

### Subpanel: Surface Points for External Attachment and Connection

All system layers may be exposed on either the front, back or side surfaces with a set of standardized nodes that may include any variety of layers listed above. These are done at the “node” points in the grid pattern that covers all six sides of a subpanel. While any layer's surface point may be used with any other surface point integrated together on top of a single node, the common combinations may be:
1. Precision Mount Attachment/Connector Surface Point with Automated 3D leveling. This attaches the subpanel to a surface behind it, it is mounted on a wall or to legs if it is to be deployed as a chair. Or to the ceiling if it is deployed as a ceiling panel. The mounting layer has a grid so that the structure element to which the subpanel is affixed may itself be magnetic or similarly removable. The surface points are in a grid of permanent magnets that may use a pattern such as the Qi2 magnet standard. This pattern may be as dense as desired from one pad every 1 meter to as little as 0.3 meters. This allows devices up to 20 pounds to be affixed using multiple magnets. This layer has nodes that may include dedicated leveling logic or in the core, it may connect to the processor layer to run self leveling technology. It integrates “bubble” sensors from the sensing in the node and with an attached device may indicate when it is “true,” that is, upright, vertical and not tilting in any dimension. For structures that are not exactly true, it automatically produces ‘shim information and the attachment points may automatically adapt to the real layout and “true” the entire panel with offsets from the physical back attachment. This surface component may typically include RFID to identify the connection point. This surface attachment may also include mechanical locking to the substrate layer that locks the surface point to any of the substrate stiffening lines.
2. Magnetic Attachment, Universal Low Voltage Power and Network Surface Point. This is the outer-facing layer of the subpanel upon which other objects (such as a wall light or a thermostat may be affixed). This has a regular grid system with the primary attachment being non intrusive. It may typically be a grid of magnetic attachment points. By changing the size and strength of these magnets, the weight that may be held may be tuned. For instance, a 7N magnet system such as used in Qi2 charging may scale to allow large objects such as a flat panel television to be attached by using multiple attachment points. These attachments are sensed by the system so the total load on the subpanel may be known and if there are objects that are too heavy, the system may notify the installer or user. Each mount point has an RFID chip and a presence detector so the location and type of device are known and when attached, the device may know where it is on the subpanel. Each affixing point may be standardized and may typically feature a ring of magnets that conform to the Qi2 standard (this allows anything attached to be correctly positioned). In addition to wireless power currently supported up to 15 W in Qi2. In addition, the center of the Qi magnetic system may have a standard Network and Power jack. A typical system may use a single Ethernet RJ-45 jack that supports up to 10 Gbe and 240 W of power to any connection point. The jack itself may be completely mechanical as the current RJ-45 standard. The design allows a full magnetic connection to a USB-C style 24-pin connector depending on the application. The full magnetic connection, once the device is centered by the Qi magnets, additional positioning magnets at the connect level may align and securely physically connect all the pins. This may allow other forms of communications such as Thunderbolt 4 or USB-4 depending on the application, if a high speed point to point connection is needed so that attached device has a choice of Wireless charging, direct high power charging via Ethernet or USB-C, high speed internet protocol (IP) networking or high speed direct device access using peripheral component interconnect express (PCIe) protocols over USB-C.
3. Multipoint Flat Panel Surface Point Grid with Automated Weight Management. This is an integrated system that is designed for large and flat attachments like flat screen televisions. In this mode there are a collection of surface points that operate together. The cores in each surface point recognize that they are being used together because there is an RFID interchange at each connection point. Strain gauges in the surface points and parameters sent by the attached device inform the panel what the expected load is. If the magnetic points are powerful enough, then the system may allow the installation to proceed. If the device needs are too high, the surface points may deploy a mechanical locking surface point that may be integrated into the substrate nodes and lock into the substrate node mechanical points in the core under the surface point grid.
4. AC Mains Power Attachment/Connector Surface Point. The system supports both direct 120-440V Mains Power connection from the High Voltage layer and also DC-AC conversion in the Attachment/Connector. This may allow devices drawing up to 2 A on 120V systems (240 w)/internal connector which may work for most lamps, electronics. The Attachment/Connector has a built-in GFI/current detection system to prevent overdraws. With four internal line connectors, a single mains power connector may support up to 960 w draw from the Low Voltage DC layer. This emulation connector may support traditional AC powered devices to use the panel without the need for High Voltage AC Power except in specific places reducing overall cost.
5. Wireless Communication Phased Array Diversity Antennas Surface Point. Each node point may also have a wireless transmitter array. This may support mesh WiFi, Thread, Zigbee or other low power standards. This layer may also sense where there are obstructions with the sensing system and may avoid locations where things are affixed by working with the attachment layer. It may also contribute sensing data through wireless interference. This layer may also allow different surface attachments to emit differently and implement beam forming to focus communications to other objects in the room including other subpanels.
6. Side Attachment/Connector with Rotary Motor, Magnetic and Auto Id Surface Point. The subpanel also has a layer around the edge of the panel that allows magnetic attachment and alignment. This allows subpanels to be precisely laid out in a “grid” or other pattern without the need for manual centering. Like the front and back system, it integrates with the sensor layer and processor layer to allow precise alignment with other panels and in the physical world to ensure the panels are mounted “true”. The system allows “play” in the system with a calibrated distance for connection. The edge attachment also supports “off subpanel” connection for all the layers listed below. These use the same magnetic approach to self attach. And may use the Mechanical attachment layer for additional physical attachment as needed. When two panels come together, they identify their physical location and their capabilities by interchanging data. Typically, the data communications layer (see below) may first be connected, and the processor layer may provide detailed configuration information. This may allow each successive subpanel to collect its role in the whole assembly. Thus, the first panel may need to be configured and then all information may be fed forward as it is installed. A typical use of the side attachment may be to play seamlessly with other parts of the panel. It may also be used as an attachment point for other components. For instance, curtain and louvers may attach easily also be powered and controlled from the side attachment.
7. Watering Surface Point. This surface points runs on top of a grid node and interconnects a low pressure water system, low power DC lighting and waste water out. It facilitates arrays of hanging plants and living walls and for industrial uses supports vertical farming and other applications that rely on lighting control and water. The watering points are magnetically aligned and feature a self-latching mechanism which by apply pressure causes the system to automatically latch so no welding or other permanent techniques are needed.
8. Plumbing Surface Point. This allows connection of high volume water such as sinks, showers and toilets. It integrates a data connectivity, low voltage power, higher pressure water system or a low pressure system with water reservoir (for most cases where a short burst of 2-3 gpms of water is needed, a 2-5 gallon reservoir may be refilled with a low pressure, easy to maintain, 0.1-0.2 gpm system. This system allows “plug and play” for a wide variety of subpanel supported plumbing fixtures which may integrate with both the home control system allowing smart home control of these fixtures and automatic shutoff in case of emergency. The water surface point, these liquid systems are magnetically aligned and then mechanically self-latch and they may quick releases with a fixture. They do not need permanent bonding although this may be applied if desired.
9. Hard Surface Attachment Point. In addition to the rear and front mount magnetic attachment, the system has a hard attachment that mechanically locks the subpanel at the rear or in the front. This allows much greater loads to be placed on the subpanel and also enhances security and prevents unauthorized removal of components. The Back Mount and Front Attachment magnetic systems are used to center each mechanical attachment system.
10. Motion Control Surface Attachment Point. A subpanel may include motorized systems that allow it to move over other subpanels. The grid points may include this rail and motor system. This allows subpanels to rise and open and close. This allows groups of subpanels to accordion over a surface creating automatic door systems.

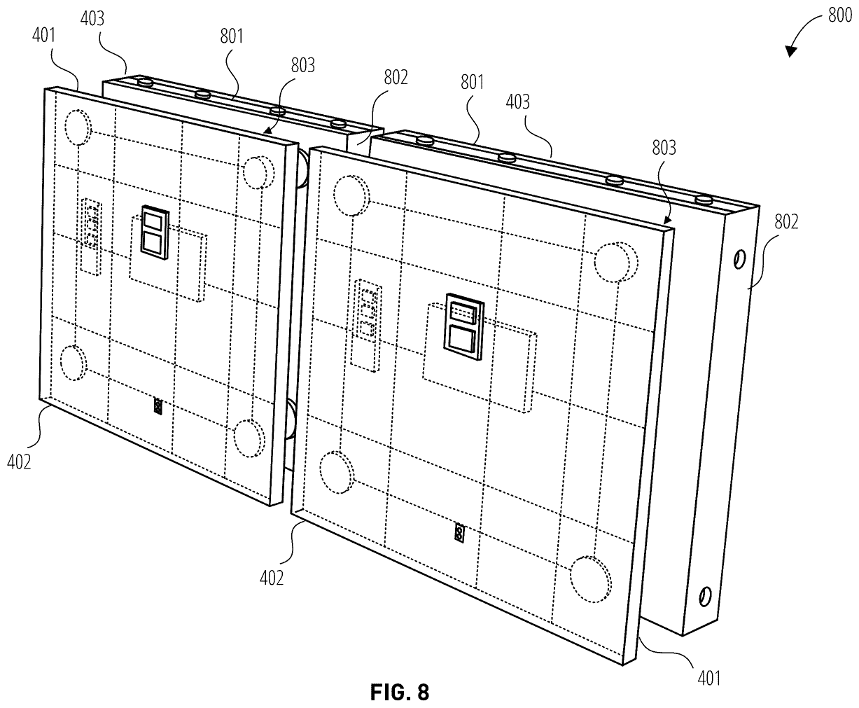

FIG. 8 illustrates subpanel surface points and external attachments 800 in accordance with one embodiment. The subpanel surface points and external attachments 800 may be configured in the subpanel layer 401, cover plate layer 402, and wall rear attachment layer 403 as shown. The subpanel surface points and external attachments 800 may include a vertical connection layer 801, a horizontal connection layer 802, and a surface connection layer 803.

### Subpanel: Mounting General Features

A subpanel is a subpanel system that encompasses the entire surface of the ceiling, floor, wall, panel, or any surface plane transforming all areas of the surface to function with subpanel capabilities. It may be embedded or surface mounted and includes the outlined functional layers above. Macro subpanels may be affixed as a surface installed, magnetically connected subpanel. Typical surface mounted macro subpanels include a protected hard attachment layer to protect the subpanel and associated systems below. Alternatively Macro subpanels may be embedded within the ceiling, floor, wall, panel or surface plane.

### Subpanel: Handler and Installer

The subpanels are self-identifiable, intelligent, and have their power supply. There is an autonomous installation system. When subpanels appear on site, they may be preprogrammed with their expected location before they reach the installation site. Alternatively, the handling system may interrogate a subpanel and assign it a location.

The assembly system moves automatically to a room, and the first installed panel provides orientation. The handler places a subpanel and uses RFID on the grid to guide a subpanel precisely to a course location, which is then magnetically attached to the panel. Then, the subpanel may provide precise skew information to orient subpanels properly.

### Subpanel: Interior Mounting

There are a large number of conventional, “dumb” objects that may integrate a subpanel and provide immediate benefit for existing users in existing structures they include:
1. Wall Mounted: Charging and Home Control with Presence detection. In this application, the subpanel may be magnetically mounted to a conventional wall much as a pegboard or whiteboard might be. However, the addition of these layers dramatically increases functionality. If you hang a phone or tablet to it, it may automatically charge. And because of the RFID identification at each point, the phone application may be notified and all the HVAC and lighting controls. The user may leave a dedicated tablet in each room, or they may just park their personal device there (for instance during a meeting) and get a charge. An application that is subpanel aware may also download all the meeting notes and other relevant information by simply “tapping” on the wall panel.
2. Seamless Data Access Points. This same wall panel may provide a full mesh network without needing extra access points or other unsightly things. Because it has motion and presence sensors, the system may determine the room occupancy and request additional bandwidth from the upstream systems.
3. Television mount that is “penetration-less”. That is the multiple magnets may hold the large device. And it may access power via Qi2 charging. In the current standard as typical television draws 50 W so four Qi2 Chargers may provide both four corners mounting and also 4×15 W or 60 W of power. The system includes RFID in each mount point so the processor may determine what device and what the loads are.
4. Smart Lighting Systems. Qi connections and low voltage supply connect seamlessly with smart lighting systems. Integrated with smart windows/blinds, lighting levels have the ability to be reactive to unit conditions to provide optimal light or default to presets and custom lighting adjustments. Light systems may include surface mounted sconces, floor lamps, embedded LED puck lighting in ceiling, lighting strips etc.
5. Social Media. Occupancy sensors, cameras, and other embedded sensors play a role in live streaming or other social media applications.
6. Smart Bookshelf Shelves with wireless charging. The system allows a simple bookshelf that also supports charging of any device. It uses the Qi connection on the wall or the wired power to provide power to it. In this case each “shelf” is in itself a subpanel and these may be connected to a backing subpanel that provides backbone power.
7. Smart Mirror/Medicine Cabinets. Subpanels may also form the basis for a smart mirror/medicine cabinet. Integrated subpanels in cabinet shelving may sense for temperature, humidity, and pressure creating the opportunity for optimally controlled atmospheres for medicine storage. Furthermore, integrated scanning may create a “facial recognition locking system” to limit access to the mirror as well as interior mounted cameras scan medicine labels which, combined with pressure/weight sensors may monitor pill usage and quantity. For example, if a once-a-day pill has not been taken it may sense the net weight of the bottle and notify the patient or if the prescription is running low it may notify both patient and medical practitioner for refill.
8. Generative AI for Design: Layout, Aesthetics and Reliability Components. Given a set of parameters such as number of residents, unit type, rent levels, operating cost, public safety, regulations, zoning, amenities as well as time to travel and to food, work and desired lifestyle, the AI expert may automatically generate a series of site layouts, unit mix, and other variable conditions that meet these constraints. Furthermore, with access to real time costing data, these models may supply up to the minute construction budgets, construction schedules, and underwriting proforma to developers, owners, and investors. It may produce 3D models and VR walkthroughs for further design work, and for investors and tenants. The system may also meet the MTBF needs and perform simulations given varying conditions and climate change assumptions for the next 100+ years to determine redundancy needs, etc.
9. Hanging Plants and Natural Humidifiers. A subpanel may be used to hang plants to make a living wall using the low pressure water system to fill and the waste water system to drain the plants. The system may be attached to “natural low presume” humidifiers that provide aerosol water humidification or “swamp cooling” in hot dry climates.
10. Whiteboard, Picture Mounting without Wall Penetrations. The system may be used for simple mechanical fixtures as well. Instead of having to repair walls, the magnetic attachment system allows posters, photos, whiteboard to be hung and moved quickly and easily without damage. If these are electronic devices, they may use the additional facilities. So for instance an electronic whiteboard may record the data and send it to all the people in the room.
11. Portable Heating and Air Conditioner. A subpanel may carry both hot and cold water as well as forced air to uncomfortable locations. If mounted in a series, it may bring forced air in a “surface mount” method that does not rely on extensive remodeling.
12. Ceiling Mounted Panels for Lighting and Safety. Subpanels may be used to power LED lights over the low voltage DC system. This may support LEDs with up to 240 W (equivalent to 2.4 KW incandescent flood lights). This allows rapid reconfiguration of lighting just by detaching them and magnetically reattaching them. For indoor scenarios, this allows rapid reconfiguration of rooms from a ballroom to a conference room for example. Since subpanels may be mounted on the ceiling, this also supports industrial lighting scenarios as well with full motion control, presence detection and fault notification since the system may detect modules that are failing. If there are LEDs mounted as a “hot spare”, the system may turn on a row of lights and may turn on the backup row without stopping production or work.
13. Home Security and Life Safety Systems. Because the system has ambient sensing, a subpanel in each room may acts as a life safety system. This may sense dangerous chemicals, monitor spaces for danger. And in a ceiling application, the high-volume water system provides a redundant and controlled sprinkler system that may be zone controlled and managed. The sensor may both detect fire, turn on modules that are needed in the grid, and shut them off automatically. Having a grid of high pressure water may significantly reduce the danger of a single failure preventing sprinklers from firing and may reduce damage by selective deployment of sprinklers in areas that are under direct threat.
14. Hospital, Senior Care, Memory Care, etc. Integrated subpanels in medical and senior facilities allow staff to easily track and monitor patients quickly. Sensors located from micropanels through fully integrated panels (floor, wall, etc.) may track patient movement and locate the individual quickly. Interconnecting wearable medical devices with panel systems may alert staff in the event of a medical emergency and provide the exact location of the patient in need. This tracking extends to memory care and other facilities where patients with compromised cognition may lead to walking off or getting lost.
15. Surface Mounted Electrical and Plumbing and HVAC Upgrades. Instead of unsightly surface mounts the grid system allows upgrades of high pressure water systems and also for additional mains power. This may be used for adding more power for home theaters or offices without overhead conduits and trays. In an era of climate change, this may allow the addition of additional power for air conditioning and also these units may be used as whole room air conditioners with the addition of “swamp cooling” and also both chilled water and cold air systems.
16. Kitchen and Bath Cabinetry. These are panel mounted and may support cabinetry. This is superior to a wall mounted system in that both power and water may automatically be fed. The magnetic system between panel cabinet units allows precise alignment without special fixtures. Also this supports charging and water access through the low pressure water and other systems. The panel system allows easy removal and replacement of cabinetry and other modules as needed.
17. Floor Mounted “Rug” Subpanels. When affixed with the proper surface such as an oak veneer or carpeting, subpanels may be used on floor surfaces. This provides “power” in any location in a room simply by placing a device on top of the appropriate grid point. In addition, the self leveling and self-connection may dramatically simplify installation and replacement. When a section needs replacement, the processor layer may instruct the mechanical systems to “unlock” and the subpanel may be removed and replaced. Also with the RFID, ultra-wideband (UWB) and other localization technologies, a floor mounted system may provide millimeter precision location of objects on the floor and their movement for security uses and also for home control. These floor layers may have additional insulation layers if the floor is not well insulated.
18. Bolt-on Wall, Floor and Ceiling Liquid HVAC. A subpanel may be used to provide additional warmth (in addition to insulation). For instance a subpanel may be used in front of the bathtub to provide “foot warming”. It may be used to provide in-room air conditioning and heating either via the H/AC layer or with the forced air systems for HVAC
19. Floor Drain and Moisture Sensing Subpanel. A series of subpanels may be laid out to provide waste water draining through the waste water level. This may be an add-on to a room such as a laundry room where inadequate drainage is present and additional surface mount is needed. This may also provide immediate moisture and leak detection.
20. Smart Windows and Doors. With penetration support, doors and windows may be constructed in a subpanel or through multiple subpanels. Both power and light sending are available.
21. Maintenance Notifications. Subpanel sensors including pressure sensors, electrical sensors, etc. may report the event of subpanel damage, penetration or other adverse conditions.
22. Robotic Vacuum and other Floor Robot navigation. Sensors detect debris and other minor inconveniences and may a) notify smart vacuum system to commence cleaning process b) map a path based upon occupancy sensing to optimize cleaning. A subpanel floor system allows full integration of floor robotic systems. Instead of needing a dedicated charging and docking station, the subpanels may provide both navigational information (via the RFID and sensing layer). A robotic vacuum may know where it is in the room. In addition, any set of grid power points may serve to charge such systems obviating the need for dedicated charging stations. A robotic system may also use the Low-Pressure Water and Waste Water system on a side panel or the floor panel by using the sensing and attachment system. This may allow such functions as automatic clean water filling and dirty water disposal.
23. Smart Home Entertainment Systems. A panelized home entertainment may comprise components that may attach and integrate directly into it. Powered Speakers may be placed on any gridded surface as a floor, ceiling or wall mount. When a speaker is added, it learns its location from the subpanel and may be configured as any component of multichannel sound systems such as Dolby 7.1 surround. Because the location of the speakers is known and occupants are known the speakers may “beam form” to provide whole room audio that sounds good at any location. In addition, for video equipment, this may be mounted in any part of the subpanel and its location is known. This may allow the construction of “surround video” room systems where a 3D video may be transmitted to the appropriate panels around the room creating a full virtual experience. When game consoles are placed on a panel, they may get power and internet and immediately know the location, capabilities and power of every speaker and display system in the room and automatically provide a full experience.
24. Smart Windows Shades, Blinds and Curtain Management. A Subpanel may be placed above a wall opening such as a door or a window and an electronic curtain system may be attached. Because the subpanel knows its location in the room and also knows the overall ambient light and other human desired attributes, it may open and close shades and other openings automatically. The power may be drawn from the subpanel system and does not need batteries and other components.
25. Hurricane Windows and Doors. An externally mounted storm door and window may be created with smart panels. This may comprise subpanels to either side of an opening.

And using the movable mechanism moving subpanels may cover the windows the sensing layer may detect temperature, wind and rain to allow automated closure and storm data to be sent to the overall home control system.

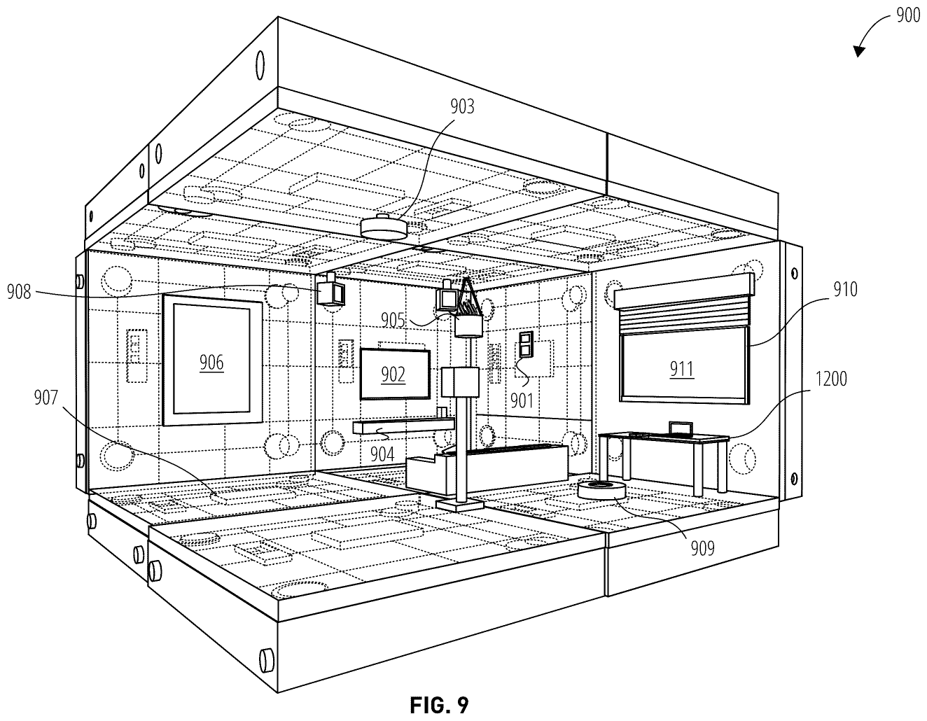

FIG. 9 illustrates interior mounting 900 in accordance with one embodiment. The interior mounting 900 may include a micropanel panel hard cover plate 901, a penetrationless television hanging 902, a smart lighting system 903, smart bookshelves with wireless charging 904, hanging plants and natural humidifier 905, a white board or picture penetrationless hanging 906, floor mounted subpanels 907, a smart home entertainment system 908, robotic vacuum navigation 909, a smart window with shades and blinds 910, a hurricane window 911, and a smartdesk with wireless charging 1200. This list is not intended to be limiting. Many additional possibilities may be readily anticipated by one of ordinary skill in the art.

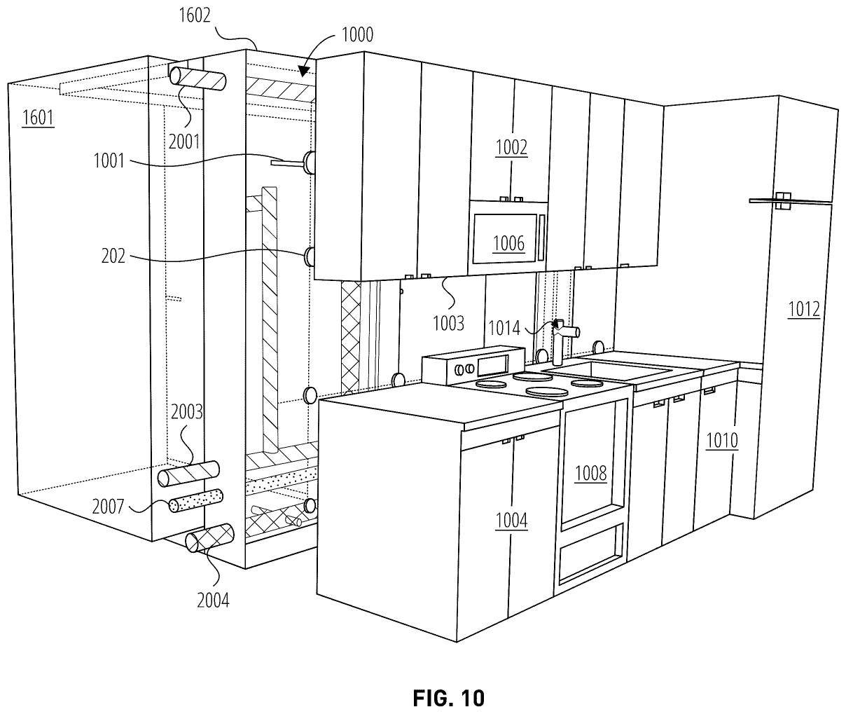

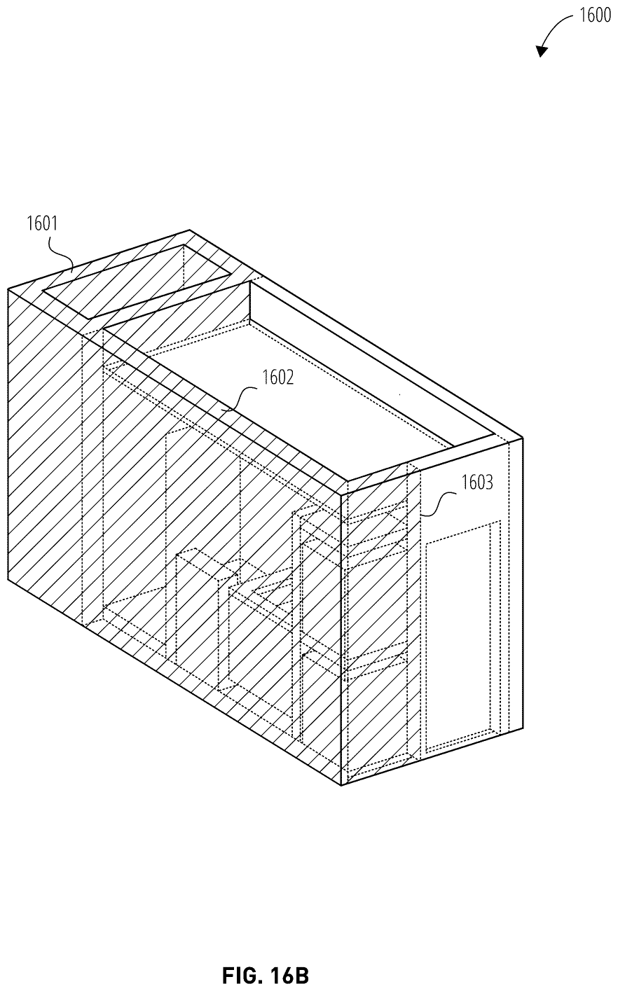

FIG. 10 illustrates a kitchen cabinet mounting layer 1000 in accordance with one embodiment. The kitchen cabinet mounting layer 1000 may comprise a hanging rail 1001 which may support hanging cabinets 1002 and Qi-2 magnetic connectors 202 which may power a smart lighting system 1003 beneath the hanging cabinets 1002. The kitchen cabinet mounting layer 1000 may permit through-access to the elements of the utility hub layer 1601 and utility wall layer 1602 to hanging cabinets 1002, standing cabinets 1004, smart microwave/hood exhaust smart microwave/hood exhausts 1006, smart oven smart ovens 1008, smart dishwashers 1010, smart refrigerators 1012, sink/smart valve technologies 1014, and appliances that may interface with the fire suppression life safety layer 2001, utility wall structure 2002, low pressure water distribution layer 2003, waste distribution layer 2004, and horizontal mains AC distribution 2007 pictured here. These elements are described in greater detail with respect to FIG. 16A-FIG. 23B.

### Subpanel: Exterior Mounting

The subpanels are for various external uses. Subpanels may also be used as an add-on to upgrade existing structures.
1. Insulation Layer and Exterior Leak Monitoring System. Subpanels may be mounted with additional insulation layers to provide spot insulation on walls. After a thermal examination of a structure, there are often “hot and cold spots.” Subpanels may be mounted in these locations to provide additional insulation, and the sensing layer may provide IR, temperature, moisture, and other monitoring for problematic building areas
2. Surface-mounted Low Voltage Connection (Surveillance Camera, Sensor Panel, AV, etc.). Instead of mounting a camera standalone, a panel may be mounted, and plug-and-play cameras and other sensors may be mounted. In addition to providing power and other services, a series of panels may be surface-mounted from the power source, allowing an array of cameras to be moved and deployed. As an example, a sensor may be a millimeter wave radio system and allow phased array sensing of
3. Hanging Garden and Living Wall. The system may be mounted to allow plants in a hanging garden and living wall on the exterior of buildings with support for lighting via LV lights attached to the grid and plant watering and sensing.
4. Smart Solar Panel System. Because the system is self-leveling at the mourning points, when photo-voltaic cells are loaded, the subpanel may monitor energy output and use the dynamic mount points to change the orientation of the panels to maximize solar output. The system is self-assembled, which allows the power to move through the LV layer and also allows full maintenance and control.
5. Billboard and Display Systems. The subpanels allow assembly into larger displays and other non-electronic and powered billboards. They are self-assembling and self-leveling, enabling various display systems to be assembled from them.
6. Power Points and Hose Bibs Subpanels. A set of surface-mounted exterior subpanels may provide a system for high-voltage, low-voltage, high-pressure hose bibs and low-pressure watering around any structure. This may allow exterior upgrades while providing all these outlets for exterior use, such as landscaping, irrigation, and home maintenance.

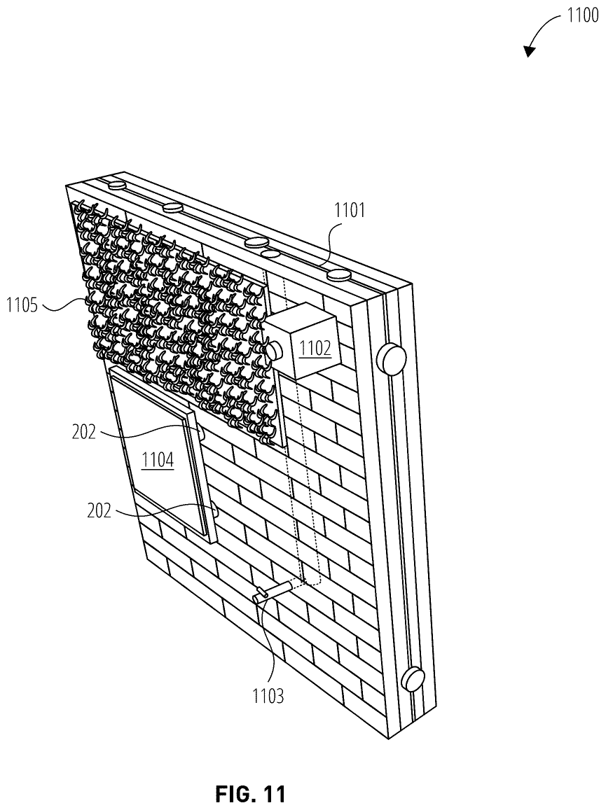

FIG. 11 illustrates an exterior mounting layer 1100 in accordance with one embodiment. The exterior mounting layer 1100 may comprise Qi-2 magnetic connectors 202, an internal sensing and insulation layer 1101, a surface mounted low voltage system 1102, a power point and hose bib subpanel 1103, a billboard display system 1104, and a hanging garden or living wall 1105.

### Subpanel Furniture

An additional application of subpanels is for furniture and other moveable fixtures in a structure. A subpanel used this way is completely integrated with other subpanels, essentially making “smart furniture” that plugs seamlessly into the AI system. These systems are not wall-mounted so that they may work in any home, but they provide all the basics and work well in settings where subpanels are mounted in a home. Uses include: 1. Smart Panel Desk. In this system, the table itself has a subpanel grid. Placing a phone or tablet with Qi charging may support charging at any node grid without additional chargers. Also, the system may allow laptops and computers with a Qi charger underneath to charge without a cable. Just placing a laptop on the surface may charge it. And when the grid is narrow enough, a desktop or laptop may draw from 2, 4, or even 6 nodes to get up to 6×15 W or 90 W of charging. In addition, the table itself may serve as a wireless access point, and any phones laid there may be notified, and smart home control may be performed. Finally, the table itself may be paired with other subpanels in the room and allow automatic projection of a laptop in place on the table to any of the larger flat screen panels in the room. Plants may be placed on the table using the low-power water system and automatically watered and drained through the wastewater layer. Desktop lamps and monitors may be powered simply by placing them on the panel desk. When connected, a monitor may be powered through the power layer, and the compute layer may detect it and automatically connect it to a laptop or desktop machine placed on the desk, or any personal computers connected to the overall system may be notified and automatically connected.
2. Smart Panel Conference Table. The system allows multiple panels to be placed together and connected to form larger conference tables, facilitating larger group meetings. The laptops on the table and the phones may work together. Placing a computer on the table may allow sharing all documents and “electronic handouts.” In addition, paired with a smart wall subpanel, projection televisions and cameras mounted on the walls may work as an integrated conferencing or family gathering system.
3. Smart Panel Rugs. A set of subpanels may operate as a rug with a buildable external covering. Since these may have to be charged, a Smart Table may be placed on top, and the connection may be made for Qi charging from the floor panel to the table. It may also access wired Ethernet, and power is directly provided. This may also allow floor lights and accessories to be directly powered entirely wirelessly, and the RFID system may allow immediate identification of where the light is and “zero setup” integration of a light into a smart home.
4. Smart Panel Coffee Table. In this affordance, a panelized coffee table may have plants and any controllers placed on the table that may be sensed and connected with any monitors or computer monitors in AI City. Placing a remote control or a phone or tablet may automatically configure that device to control any television, game console, or entertainment system in the room.
5. Smart End Tables. Like these other designs, end tables and other systems may be plugged automatically into a Smart Panel or with a regular outlet. The sensing system may identify where these tables are and add them to home control. The system may understand users' daily habits and, for instance, have smart end tables run at 80% charge, whereas those for the work desk may charge to 200%.
6. Smart Bed. An integrated subpanel within a bed frame may sense movement, adjust bed levels, adjust climate conditions, and more. Smart beds may also charge devices with a range of uses.
7. Room Fans, Air Conditioners, and Heaters. A panelized system may be mounted at the bottom of such appliances, allowing wireless connection to Desks, counters, or other surfaces. This may support automatic power, setup, and remote control of any appliance.
8. Smart panelized Kitchen Counters and Panelized Appliances. These panelized systems may be used on other counter systems such as kitchen and bath. Using the smart panel may allow moisture detection for leaks and allow charging of electric toothbrushes, kitchen appliances, and other devices just by placing them on the surface. They may also interchange data and connect directly to a smart home system without setup. Appliances may have a subpanel system in the rear or bottom. This may power appliances such as espresso machines and blenders simply by placing the product on a surface or against a wall, which may lock it into place and provide power, communications, and location information. Panel-aware appliances may automatically identify themselves with their “host” panel and may then be integrated into the smart home control system. They also provide an inventory for insurance and other purposes of what is in the room.
9. Subpanel Sinks, Bath Cabinets, Showers, Toilets and Laundry. Using the plumbing surface points allows the integration of subpanel-supported plumbing fixtures. A sink may use the surface point to directly connect water and waste outlets using magnetic alignment and automatic mechanical locking of components, and it also allows complete control from smart home systems. In addition, the sink itself may be a smart panel that allows electro-mechanical control of the faucets and easy attachment and detachment of fixtures for replacements and upgrades. The sink may integrate a processor node and communicate with the home system. It may also have a reservoir system for local hot water heating and a reservoir to allow low-volume water to “refill” the tank if the sink is used periodically. Shower units may be a single panelized system with wastewater exiting through a waste surface point into an underlying panel. Water may be magnetically aligned and electro-mechanically connected to a water surface point. For low volume applications, a 5-10 gallon reservoir may be integrated into the panelized water system, allowing show heating to reduce the need for whole structure hot water. A panelized toilet may integrate a waste surface point. All water connection points use a similar magnetically guided system that aligns each side. This is followed by a quick-release latching system to remove them when needed, providing a good seal efficiently. Leak sensors are also deployed at these connection points to monitor failures and notify the AI system as needed for rerouting and replacement/repair.
10. Automatic authentication systems Panels. A smart panel may be used for access control. It may be placed next to doors to detect people and allow the remote control system to be mounted non-intrusively. Tablets and phones may be attached and remembered there.
11. Floor-standing lights and appliances with Subpanel. A standing light may have a subpanel at its base. This may allow power and also support smart lighting features. Once the light is attached, it may know its location in the room. The same is true for humidifiers and other systems so they may be immediately integrated into the smart home control system.
12. Panelized connection for beds, chairs, and couches. The connection for chairs and couches may use the smart panel system. This may allow couches to get wireless power for their reclining systems and open the way for smart sensors in beds and other systems. In general, this type of furniture may have dimensions that may match the “grid” layout of the panel so that the legs may magnetically sense and lock into the subpanel grid. This may allow any table or other system to be powered and tied into the communication system without additional wiring. Furthermore, once these pieces are placed, the overall subpanel system may communicate and know their exact physical location, enabling smart lighting control.
13. Self-powered Wall Clocks, Lights, and other hangings. If a subpanel does not have power, a photovoltaic panel may be connected to it magnetically and provide self-power. This may allow devices such as wall clocks or small speaker systems to operate without wired connections.
14. Panelized Self-Aligned Smart Door, Window, and Skylight power through Hinge or Latch (with Qi Charging points when closed. Specialized door and window systems may connect power and internet through a subpanel. While doors and windows move in their closed position, they may be magnetically attached to the power system. This may allow automated recharging of smart door systems and powering automated window opening and closing systems or windows that use electro-optical connections. This may automatically be used for skylights and other ceiling-mounted systems to provide lighting and thermal balance. Because the panels are already location-aware, these smart door and window systems may not need programming. They may know their location automatically and be connected automatically to the smart home system. In addition, a smart door, window, or skylight may have processor and sensing layers. This may allow a smart door to be “self-hanging.” When hung, the sensors may detect the relative position of each subpanel edge around the door. Then, the appropriate mechanical shimming may be actuated to hang the door perfectly and keep it hanging properly. This system also allows “setup-free” lock configuration since the door is installed and may “know” its location immediately. A panelized door may also allow a door camera to be placed on it and additional sensors, for instance, detecting if the door is open or heat is leaking out.

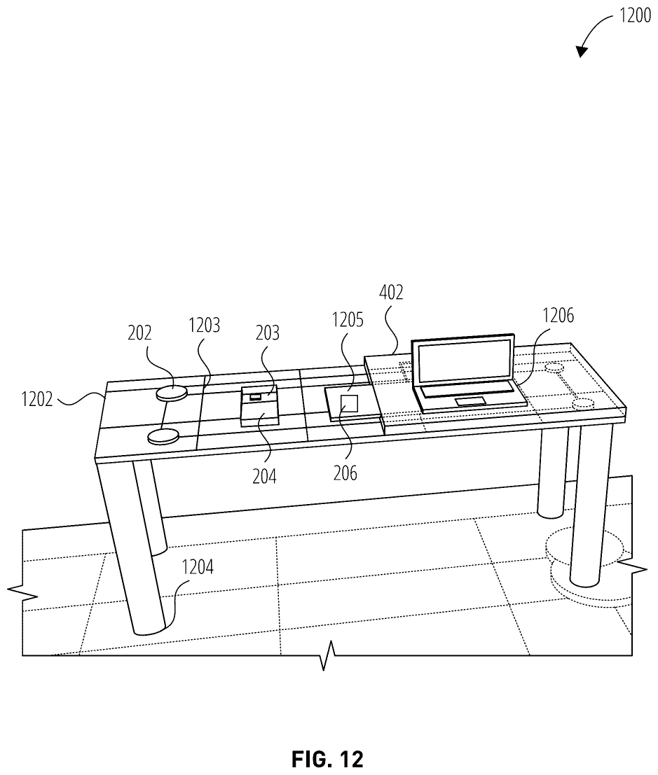

FIG. 12 illustrates a smartdesk with wireless charging 1200 in accordance with one embodiment. The smartdesk with wireless charging 1200 may comprise Qi-2 magnetic connectors 202, an embedded sensing layer 203, a sensor cover plate 204, a microprocessor 206, a cover plate layer 402, a furniture subpanel layer 1202, a low voltage or Cat 6 wiring 1203, a connection to a floor panel 1204, a microcomputing layer 1205, and a device connection 1206.

### Panel: Whole Room Components

A panel comprises an individual floor-to-ceiling component comprising subpanels as defined above. The typical use of a complete panel may be for the complete refurbishment of a room. A subpanel is typically used for partial upgrades. Still, a full panel allows an entire wall, floor, or ceiling to be replaced with many benefits primarily because a whole panel system protects the underlying walls and other systems, may be built with attractive and wear-resistant subpanels, and most importantly, allows “partial” replacement of wall and other sections without major renovation cost and time. It is simple to connect to the processor layer, instruct a particular subpanel to “de-connect,” and then replace that panel.

A panel reflects a fully integrated component system such as S/MEP/I or partial systems that function through a series of panels. Panels are composed of subpanels, and they may be composed into a variety of “whole wall, floor, and ceiling components” such as:
Standard Panel: Add-on and Full
Specialized Standard Panels
Ceiling Panels
Floor Panels
Wet Systems Panel
High Voltage Systems Panel

### Panel: Full Wall and Decorative Layer

The standard wall panel is foundational panel for interior and exterior applications. Each panel is formed using an external non-combustible, weather-proofed material, insulated core, and embedded subpanel, as defined above. External applications may be molded to form different finish conditions, while interior conditions maintain a flat surface with surface-mounted electrical boxes for power supply.

For efficiency, while panels may be assembled from subpanels, in whole-room applications, subpanels may be assembled as a complete whole. So, while a subpanel may be 1 meter×1 meter, a typical panel may be 10′×10′ and integrate all nine subpanels into a whole. This simplifies manufacturing, improves physical strength, and reduces cost while maintaining the ability to replace an individual panel rather than an entire wall.

Having an entire panel allows much more efficient integration and dramatically reduces costs. Instead of having a computer control system for every subpanel, a panel may have a single computer control system, lowering costs. One tradeoff may be that an entire panel may need to be replaced instead of a single subpanel replacement.

A standard panel may typically have two different widths. A compact width may be employed when used in existing rooms, reducing the interior dimensions of the room. Such systems may typically be 4″ or less.

A standard panel also allows the application of a “decorative layer.” This allows for using these panels with custom paint, wood veneers, stone veneers, and other attractive finishes that may refresh any room with a new look.

A panel may provide a subset of the layered systems available for cost reasons. For instance, a common cost optimization may be removing the high-voltage, high-pressure water, and waste-water systems from a panel because they may not be used in a family or living room.

### Panel Plus: Structural and Insulation Layers

Each standard panel maintains a 10′ base width with variable lengths depending on asset type. Stand wall depths and insulation values target-level thermal resistance values (R-Values) reflected in passive house construction, with a range of R-40 to R-60 for walls, R60 to R-90 for roofs, and R-30 to R-50 for slabs. These panels are connected to form vertical wall systems. Conceptually, they have a “Structural Layer” mated to the system, providing additional insulation layers and structural support to keep the entire panel rigid.

### Panel: Penetration Capable

Specialized Standard Panels are formed the same as standard panels and include the same integrated subpanel system; however, they are modified to include wall penetrations and openings for installation of windows, doors, external HVAC Systems such as PTAC, exhaust, variable refrigerant flow (VRF), etc. Specialized panels may include systems such as dynamic glazing, smart HVAC systems, cloud-managed access-controlled doors or other keyless smart locks, and other similarly designed applications that include intelligent, networked technology. Specialized panels connect integrated subpanels to these applications and function as a single operating system when applied in future hierarchies.

### Remodeled Room: Full Panel Usage

These base panels may be used to perform whole-room upgrades. For example, a complete system for a kitchen may include the following:
1. Ceiling panel system. This may consist of a fire alarm and attachments for lighting
2. Wall panel system. This may allow panelized cabinetry installation
3. Floor panel system. This may allow the installation of sinks and another system.

A complete remodel may protect the base surfaces and support all panelized furniture and other systems.

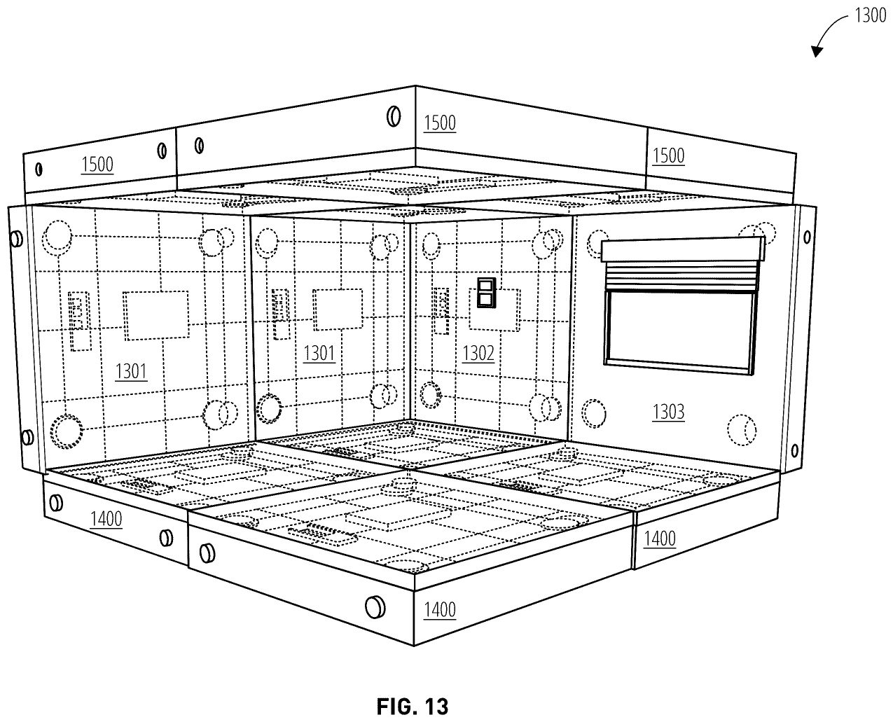

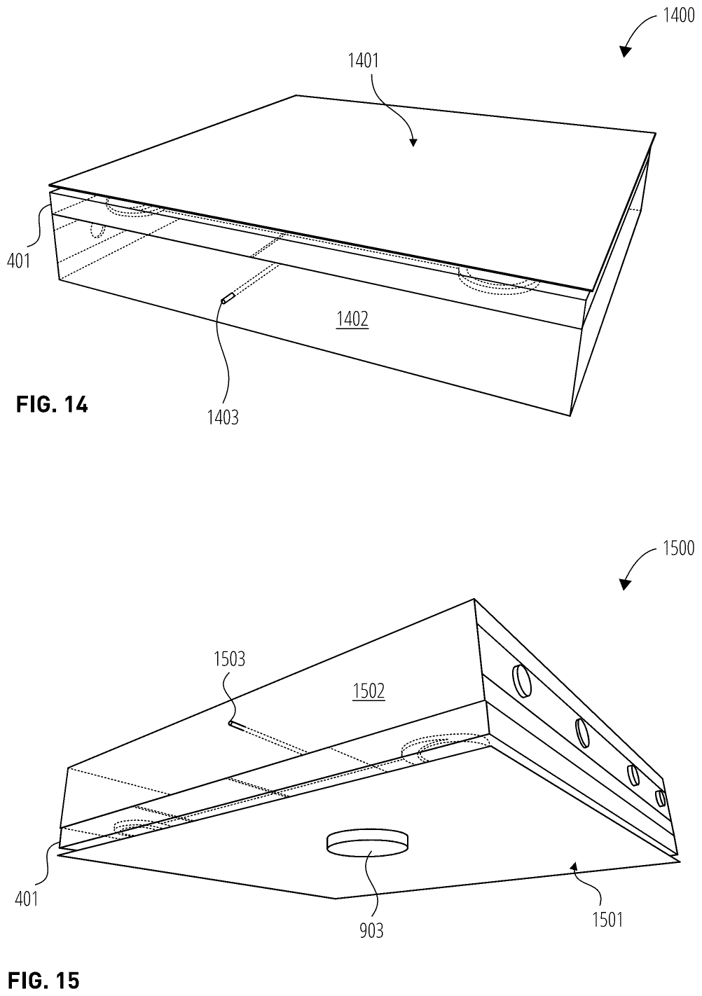

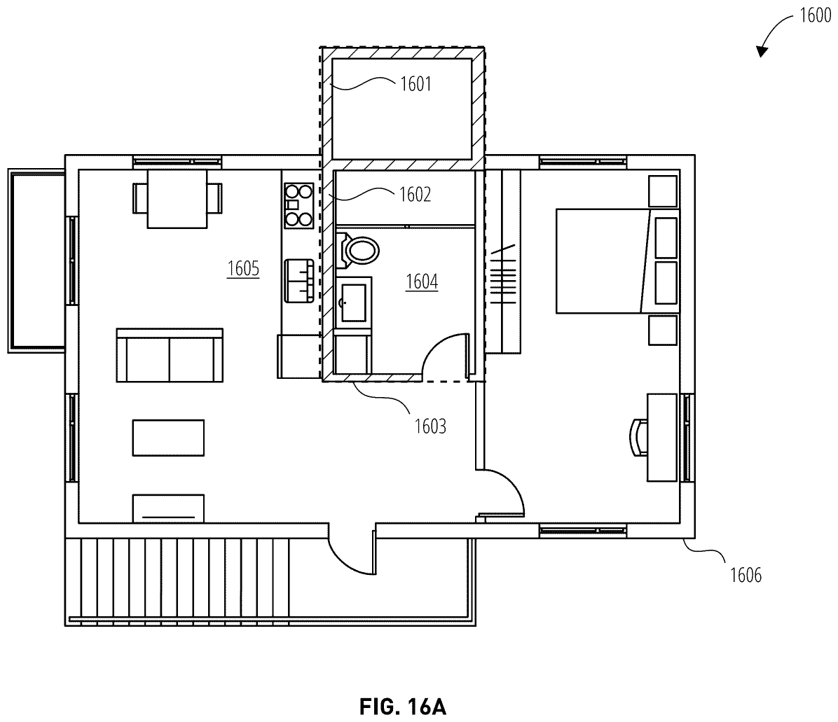

FIG. 13 illustrates whole room panel components 1300 in accordance with one embodiment. The whole room panel components 1300 may comprise standard panels 1301, specialty panels 1302, window penetration panels 1303, floor panels 1400 such as are described in greater detail with respect to FIG. 14, and ceiling panels 1500 such as are described in greater detail with respect to FIG. 15.

### Floor Panel

Floor panels are similar to standard panels in that they reflect the same internal subpanel as outlined above. However, they have a load-bearing capacity of at least 20 lbs per square foot. They have the same capabilities as Floor sub-subpanels but are typically formed for whole-room

These panels may also have a “Decorative layer,” allowing wood flooring, carpeting, and other attractive surfaces. The decorative layer may typically use the mechanical attachment system and grid system to allow “point replacement” of the decorative layer, as floors typically have different wear and traffic patterns.

The floor panel works the same as the wall and ceiling panels, so it may be used for high voltage, reading and sensing occupancy, and maximizing energy use. This allows the unit to be powered from any unit. In vertical applications (multi-floor), floor panels serve as the floor and corresponding ceiling conditions in the unit below. It increases redundancy for power and other essential utilities. The most efficient panel size is 10′×10′, such that all bays may be standardized and all automation may be the same. This may significantly reduces manufacturing costs.

FIG. 14 illustrates a floor panel 1400 in accordance with one embodiment. The floor panel 1400 may comprise a subpanel layer 401, a finish floor layer 1401, a substrate cavity layer 1402, and a low voltage CAT-6 and DC power supply 1403.

### Ceiling Panels

These are panels designed for ceiling application; they may typically be lighter as they need to be hung and may typically delete systems not needed in ceilings, such as the wastewater system.

FIG. 15 illustrates a ceiling panel 1500 in accordance with one embodiment. The ceiling panel 1500 may comprise a subpanel layer 401, a cover plate 1501, a substrate cavity layer 1502, a low voltage CAT-6 and DC power supply 1503, and a light fixture 1504

### New Build Panels: Cost Reduction Focused

While any combination of subpanels and panels listed above may be used in home construction, several important specialty panels may be very useful to reduce the cost of new builds. These may typically use the “Standard Panels” without Wet and High Voltage Systems for most of the build (this is the low mix of panels), and then a few “high mix” panels may provide livability at a much lower cost.

In addition to these physical panel layers, the MEP/I layers are located within a volumetric box comprising three primary components:
1. Utility Hub Layer
2. Utility Wall Layer
3. High Voltage AC Mains Panel Layer/DC Electrical Distribution Layer.

FIG. 16A and FIG. 16B illustrate a utility system layer 1600 in accordance with one embodiment. FIG. 16A shows a plan view of the utility system layer 1600 in an exemplary housing layout. FIG. 16B illustrates a volumetric detailed view of the utility system layer 1600. The utility system layer 1600 may comprise a utility hub layer 1601, a utility wall layer 1602 and a high voltage AC mains panel layer 1603, which may supply utilities to a bathroom 1604 and a kitchen 1605 of a housing unit 1606.

### Utility Hub Layer: High Voltage, High-Pressure, HVAC, Fire-Life Safety, Energy Storage Layers

The Utility Hub Layer provides the central utility backbone for the MEP/I subpanel systems. The Hub is typically a modular form designed to connect to the Utility Wall and sits outside the overall housing module as described in the further architectural hierarchy. All major utility systems are housed within the prefabricated volume, including High-Voltage Mains power supply, High-Pressure Water Systems, HVAC Supply, Fire-Life Safety Systems, Energy Storage layers, etc. These systems and their corresponding components are hung from a prefabricated series of racks that securely fix the supply to the Utility Hub. Once affixed, the system may be connected to the Utility Wall (described below), which provides the supply lines for the corresponding needs, including low-pressure cold/hot water supply for kitchen and baths, AC Mains electrical supply, stored energy, water suppression, and ducted heating/cooling ventilation. Each Utility Hub may be serviced via an external door system that allows access for personnel to repair, maintain, and service the enclosed building systems. The utility hub may serve a single unit, a stack of units, or an entire cluster of units.

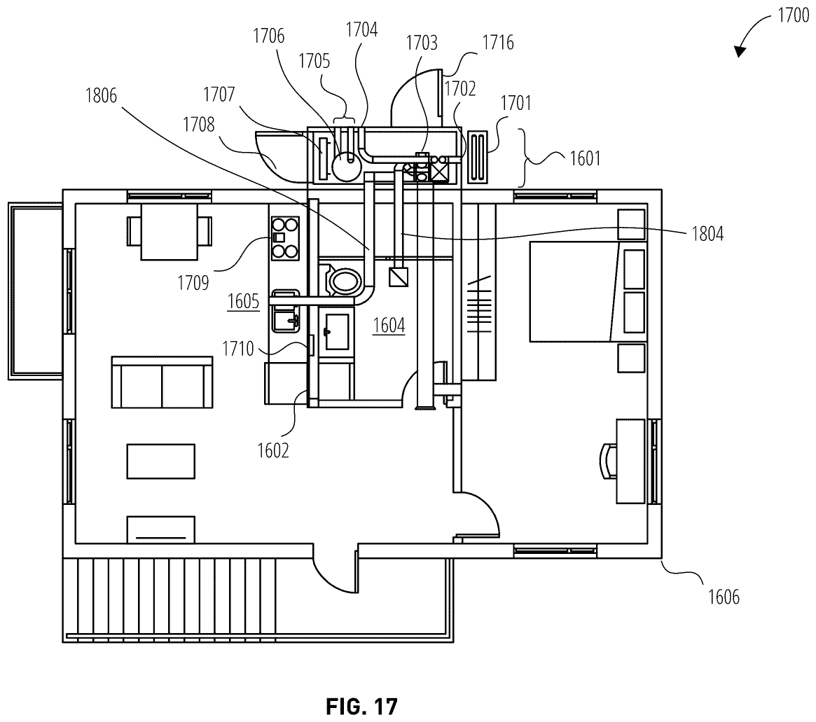

FIG. 17 illustrates high-pressure water, HVAC, energy storage, and AC electrical distribution layers 1700 in accordance with one embodiment. The high-pressure water, HVAC, energy storage, and AC electrical distribution layers 1700 may be supported by the utility hub layer 1601 and utility wall layer 1602 in order to provide utilities to the bathroom 1604 and kitchen 1605 of a housing unit 1606, and may include 6″ duct 1804 and 8″×8″ duct 1806. The high-pressure water, HVAC, energy storage, and AC electrical distribution layers 1700 may comprise an air cooled condensing unit 1701, an exhaust air outlet 1702, an integrated energy recover ventilator and heat pump 1703, a ventilation air inlet 1704, a water heater air inlet and outlet 1705, a heat pump water heater 1706, a 5 kW power wall with battery storage 1707, access door 1708, a recirculating hood 1709, a load center with smart screen 1710, and an access door 1716.

The subpanel may have a mechanical system. This may be in the form of air handling or may use water or liquid cooling and heating. These are also managed in a grid pattern with connection lines, typically ducting for air/gas systems and plumbing lines for water-cooled/heated systems. The nodes in the HVAC layer may allow switching between any of the input lines in the grid. They may include sensors to determine input temperature and ambient temperature. This layer may use dedicated connection lines that integrate power and communications or the data communications and power nodes to connect to the standard systems. This may depend on reliability needs. The surface attachment point for this system allows exterior radiators or other systems to be attached, or the entire surface of the subpanel may act as a heating or cooling element. Suppose the subpanel is used in the “floor” application (see below for applications). In that case, the HVAC layer may be placed close to the surface to allow ambient “heating and cooling” through connection lines, acting as passive radiators. The subpanel system provides air ducting as well. With four connection points, this may provide redundancy and also allow waste management. For instance, during the day, “warm air” may be pumped into the basement levels and used in the evenings to heat the systems. The surface attachment may allow electro-mechanical opening, closing, and temperature sensing to control the areas that are temperature controlled. The surface attachment point may also allow a complete AC-powered PTAC or similar system with the surface point at that node connecting to AC power for the fan and the inbound cooling and outbound waste heat routed dynamically through the layers. For example, cool intake air from the external unit might be routed from one line; on the other, the waste of warm water may be routed to the external unit.

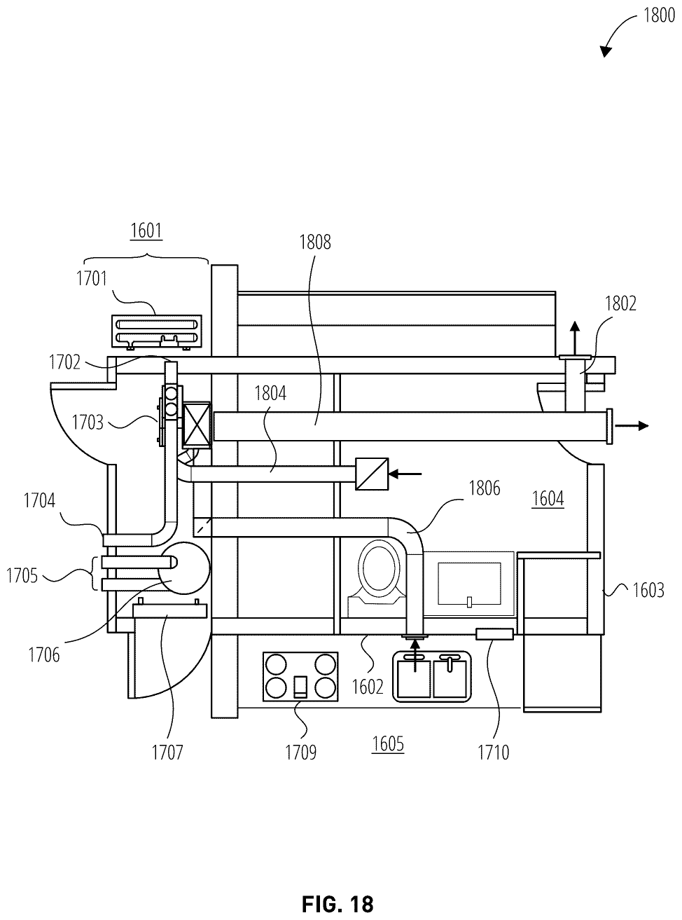

FIG. 18 illustrates mechanical ducting and liquid HVAC layers 1800 in accordance with one embodiment. The mechanical ducting and liquid HVAC layers 1800 may be supported by the utility hub layer 1601, utility wall layer 1602, and high voltage AC mains panel layer 1603. The mechanical ducting and liquid HVAC layers 1800 may include an 8″ duct 1802, a 6″ duct 1804, an 8″×8″ duct 1806, and a 12″×10″ duct 1808 in support of the equipment and operation of the high-pressure water, HVAC, energy storage, and AC electrical distribution layers 1700.

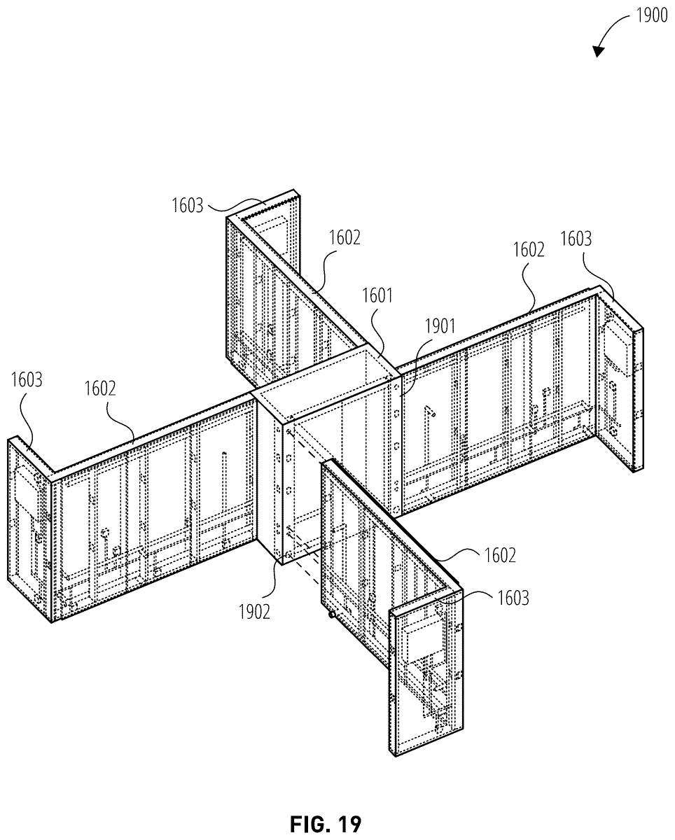

FIG. 19 illustrates a utility hub and utility wall connection layer 1900 in accordance with one embodiment. The utility hub and utility wall connection layer 1900 may support utility wall to hub connection 1901 from a utility hub layer 1601 to one or more utility wall layers 1602 and high voltage AC mains panel layers 1603 through utility wall hub connectors 1902.

### Utility Wall Panel Layer: High Voltage AC Distribution, High-Pressure Water Connection, Low-Pressure Water Distribution, HVAC Supply, Fire-Life Safety Supply, Waste Water, Utility Connection for Bath and Kitchen Units

The Utility Wall Layer is the connection point between the Utility Hub and the distribution of major building systems. This includes low-pressure hot/cold water supply distribution, high voltage AC electrical distribution, all wastewater discharge runs, HVAC distribution, and fire life safety distribution. Additionally, the Utility Wall provides the connection points for all bathroom fixtures, including shower/tub, toilet, bathroom vanity, washer/dryer, kitchen appliances, kitchen sink, refrigerator, etc. Pre-panelized, the Utility Wall and Utility Hub are connected within a factory or similar setting.

The subpanel supports a low-pressure, low-volume water system. This supports “drip irrigation” for plants that may be hung on the wall. It also allows humidifiers and other room conditioning systems. The low-pressure system is also laid out in a grid, and the connection lines are typical 2-3 mm piping that supports typically 0.1-0.2 gpm compared with 20-40 gpm typical of high-pressure systems. Because it uses a grid system, it manages and controls use so a single low-pressure node may, at its maximum, get flow from 4 different connections to reach 0.4-0.8 gpm for higher use applications. The node measures the water used and supports scenarios where the water system may trickle feed a reservoir. For instance, the sink may have a 10-20 L tank for a remote sink, and the low-pressure system may feed that tank and refill it after occasional use. There is a moisture sensor and barrier at each low-pressure water node and the ability to shut and reroute water as needed. The low-pressure node is typically connected to a core that includes the waste water layer. A typical core has a surface attachment/connection system that uses a magnetically aligned low-pressure water connector for fresh water out and drainage/grey water return. The surface attachment for this core may also include a magnetic system that may allow plant boxes, aquariums, and water features to be magnetically aligned (and there is an optional mechanical surface system to ensure physical integrity typically). Another common “rear water core” may include attachments for fresh water in and wastewater out. Nodes may also include a fluid reservoir system.

While the Mains electric supply may run predominately through the Utility Hub and is distributed through the Utility Wall, the Mains Voltage AC Electrical Layer provides a central hub for connecting all high power systems as well as access to electrical panels.

Overall, we discourage using Mains AC power and instead use lower power, easier to manage DC Electrical Layer. However, a subpanel does support a full 120-240V AC power system. The connection lines use Mains AC voltage-capable power lines. The connectors may use a magnetically guided but mechanically connected system. The mounting layer may take 120-240V Mains power. It allows a grid routing system to pass high-voltage power through the subpanel. Conventional power sockets may be used in the grid pattern. Typically, most attachments may use the low-power system (currently up to 240 W, used for most appliances, lights, and IT equipment) through direct DC support with USB-C or a DC/AC converter in a core. The system may pass through its internal AC power grid through mains power and act like an “extension cord” to other locations. That is from one side of the subpanel to another. In specific cores, The Mains Voltage node may also power the low-voltage DC nodes and recharge the battery nodes in the UPS layer. Each AC node also includes a power drop and other sensors to determine line quality. Outboard sensors, such as an induction ring around a primary power circuit, may measure and report the power usage in a building.

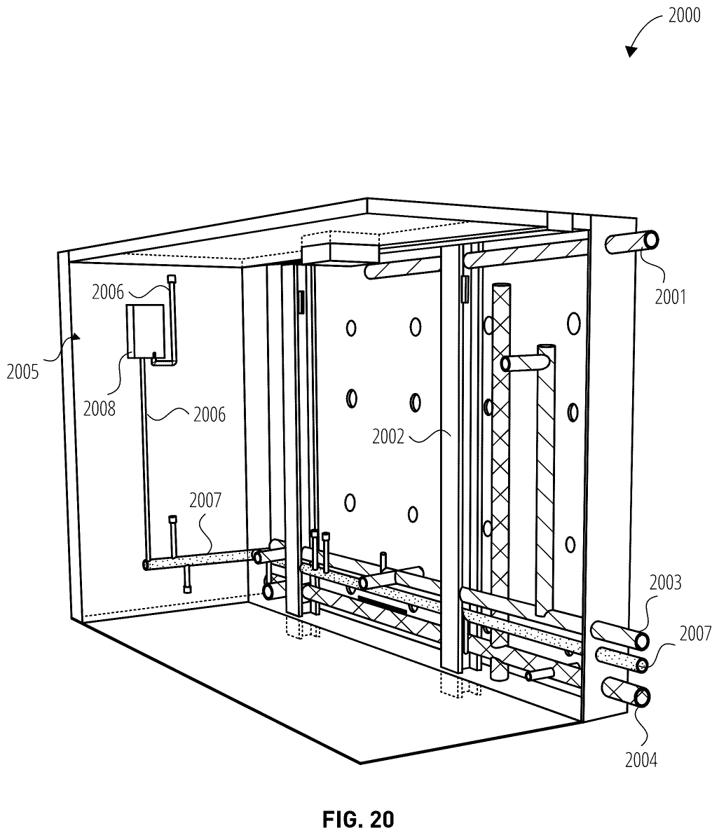

FIG. 20 illustrates a low pressure system and high voltage distribution layers 2000 in accordance with one embodiment. The low pressure system and high voltage distribution layers 2000 may comprise a fire suppression life safety layer 2001, a utility wall structure 2002, a low pressure water distribution layer 2003, a waste distribution layer 2004, a high voltage AC mains panel layer 2005, vertical mains AC distribution 2006, horizontal mains AC distribution 2007, and an electrical box 2008.

Again, while most water uses may be managed with low pressure and reservoirs, the subpanel does allow a layer that connects high-pressure water 20-40 gpm and 40-60 psi in traditional piping in 12″ sizes for the connection lines. A typical node in this system may have a connection to four lines and include sensors for water pressure, flow, and moisture. The plumbing layer may typically have a plumbing surface attachment layer, which may integrate with the wastewater system in that node. This supports high-pressure applications such as laundry machines that need high flow and an integrated connection point. This layer also allows “hose bibbing” so that the rear system may have a surface attachment point for a traditional 12″ hose that may power the low-pressure system and a grid system that allows routing of high-pressure water. This may monitor moisture, humidity, and temperature to determine if a plumbing leak exists.

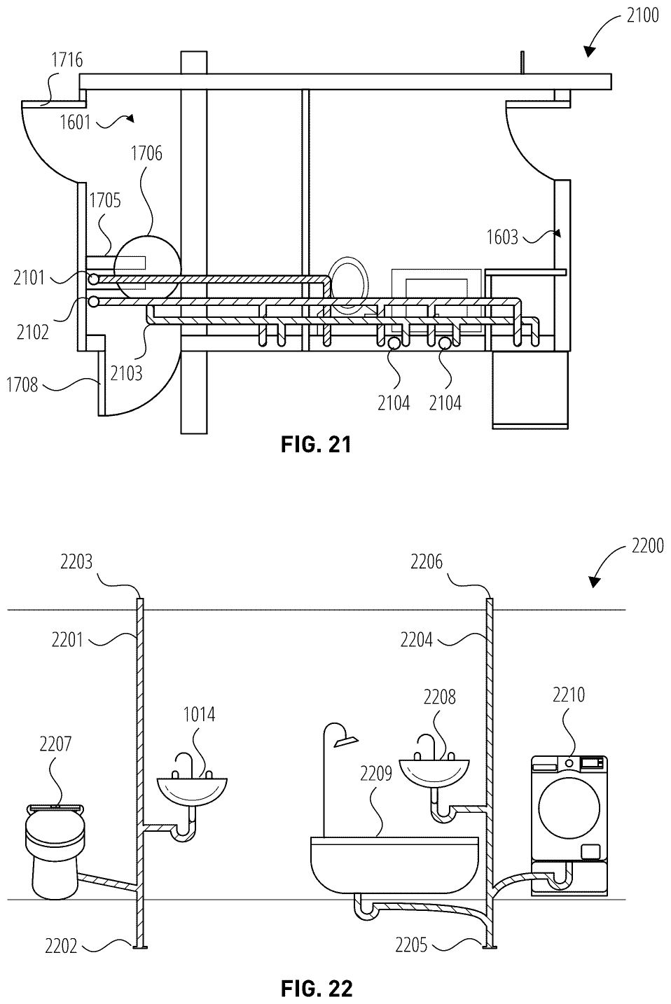

FIG. 21 illustrates high pressure plumbing layer connections 2100 in accordance with one embodiment. The high pressure plumbing layer connections 2100 may include a water heater air inlet and outlet 1705, an access door 1708, an access door 1716, a non-potable cold water riser 2101, a cold water riser 2102, a hot water riser 2103, a drainage stack 2104, and a heat pump water heater 1706.

The subpanel may be used in the interior to drain plants on the panel. Or the exterior of a building, which allows the routing of wastewater, typically grey water such as rain runoff. The subpanel allows multiple paths, senses water flow, and provides additional monitoring as needed. Usually, the connection lines may be sized depending on needs. So, subpanels deployed in low water usage areas, such as sinks, may have smaller waste piping than showers, laundries, and toilets. The overall system may use a sparse grid system to minimize the number of “turns” that may cause clogs based on “pre-design AI.” Each node may include a shutoff system and flow monitoring to determine backups. The surface point typically has a “cleanout” at specific points and allows periodic inspection. The system may typically be designed with independent grey and black water systems where the toilets may be attached to the black water system, but less volatile water, such as from storm runoff or sinks, may be handled in a separate layer, simplifying recycling and enabling wastewater reuse. Typically, these systems may be “hinted” in our AI system to minimize bends and turns but also sized depending on water use projections. The redundant water lines may be used for high-capacity rain days or when heavy use is expected (e.g., in the mornings) since each wastewater node has independent switching across the various wastewater connection lines.

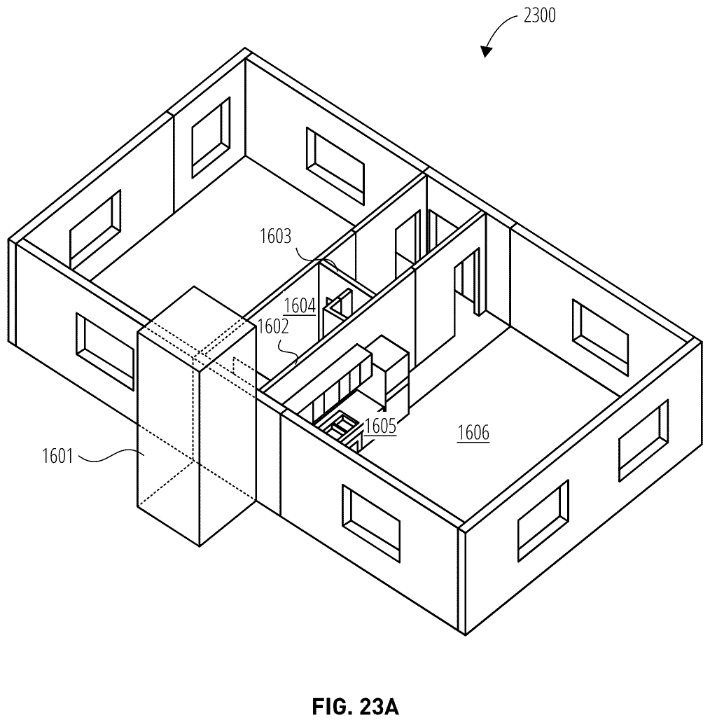

FIG. 22 illustrates rainwater, gray water, and black water layers 2200 in accordance with one embodiment. The rainwater, gray water, and black water layers 2200 may comprises a black water stack 2201, a black water connection to a unit below 2202, a black water connection to a unit above or vent to atmosphere 2203, a gray water stack 2204, a gray water connection to a unit below 2205, and a gray water connection to a unit above or vent to atmosphere 2206. The black water stack 2201 may connect to drains for a toilet 2207 and a sink/smart valve technology 1014. The gray water stack 2204 may connect to drains for a bathroom sink 2208, a shower and tub 2209, and a washing machine 2210.

In addition to the core layers described above, the system may typically have these additional layers: 1. Low Voltage DC Electrical. The system typically has a low-power electrical system based on standards such as Power-On-Ethernet. The DC layers are generally low voltage and fluid connections-proof, such as Cat-6 Ethernet, which allows combined data and power. The nodes in the DC layer may have a switch system that may control power drawn from any of the connection lines (typically 4 in a standard grid, but this is tunable). As noted before, the power to each may be monitored, and connections may be managed. The DC node may typically supply power to both internal nodes and surface attachments in the same “core” (that is, all the nodes in other layers that are in the same “vertical grid point.” For instance, if a node needs 100 W of power, a single wiring connection line may be used, and all devices on that same wiring line may shut off their current draw and use the other redundant wiring lines on “circuits” with less power draw. This way, the system may manage power use and ensure no power loss or overload. If a connection fails, the system may reroute power needs to the other lines available. The DC layer may have power storage components, switching, and sensing capability. A low-power battery system in DC notes, such as a Li-on battery or a supercapacitor, may be used to maintain DC power. The amount of power stored may be customized based on the needs by installing more or fewer UPS systems in the low power grid. This may allow, for instance, a partial power failure to be rerouted to a working low-power system and also serves to provide power if an entire subpanel part is isolated.
2. Wired Communications Layer. The system may include a grid of wired connection lines. Typically, this may be electrical Ethernet-rated cables that today support 10 Gbe to 40 Gbe. The connection lines may also use optical fiber, enabling cross-subpanel operation well into the 900 Gbe range. In many cases, the low-power and wired connection lines, such as with Power-on-Ethernet, may be merged to simplify the design. Each node in the wired communication system may have an intelligent switch that may typically handle protocols such as LACP to send their traffic intelligently to the least busy connection lines. The internal connection power between the node and the lines may typically be magnetically aligned with magnetic proximity attachment. They may use mechanical connection after magnetic proximity alignment if higher reliability is needed. The system also allows key connections, as in traditional RJ-45 connectors, and supports dynamic symmetric wire insertion, such as that used in USB-C.

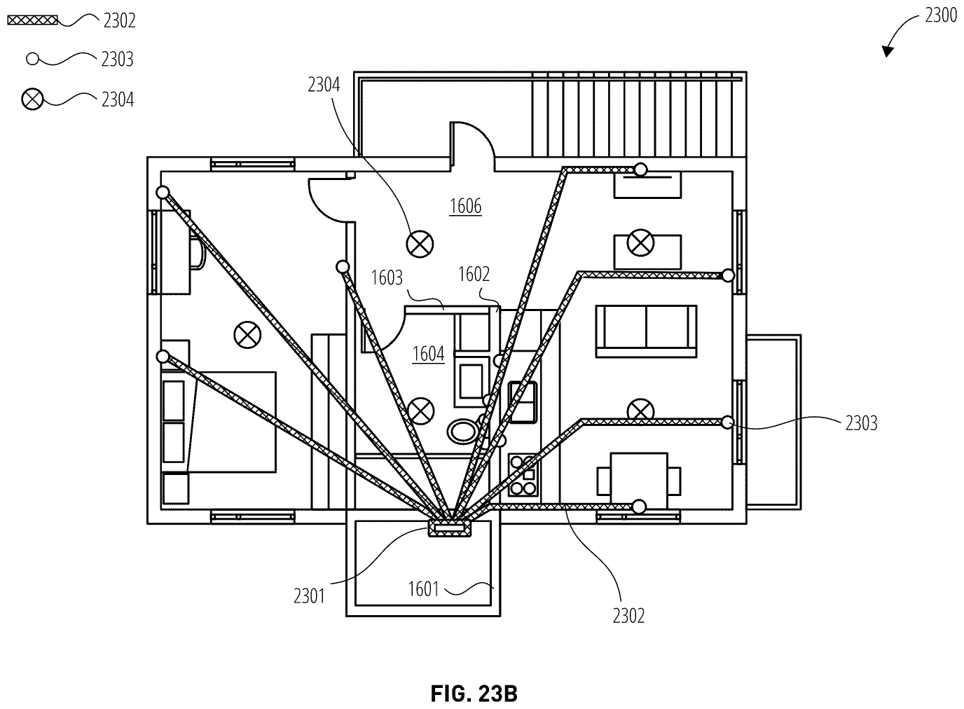

FIG. 23A and FIG. 23B illustrate a low voltage DC electrical layer 2300 in accordance with one embodiment. FIG. 23A illustrates a perspective view of the utility hub layer in the context of an exemplary housing unit. FIG. 23B illustrates a plan view showing connections to low voltage components. The low voltage DC electrical layer 2300 may be supported by the utility hub layer 1601 providing utilities to a housing unit 1606 and may comprise a DC distribution panel 2301, under-floor DC cables 2302, wall termination outlets 2303, and smart lighting system 2304.

### Optimized Panels Retain Full System Control

Each panel type is designed to physically connect and interconnect subpanel operation, sensors, and other functional operating systems between a set of panels. Two or more panels connected establish a panel system. These systems are intended to work in concert with one another, optimizing S/MEP/I by integrating data supplied by subpanel (embedded or surface mounted) with AI-assisted operating systems. For example, by connecting a standard panel to the wet systems panel, embedded subpanels within the standard panel monitor data such as internal and external temperatures and communicate with sensors located within the wet systems, which monitor water pressure, temperature, etc. If pressure drops or internal water temperatures fall, the sensors supply data to the central AIOS to notify the operator/owner/resident and apply corrective measures to avoid loss or failure. These panel-to-panel connections provide a multifunctional system stemming from the subpanel application.

### Aggregated Physical Components

The basic subpanel and cost-optimized panel system provide the building blocks that allow composition into rooms, apartment units, buildings, and entire cities. However, they need supporting systems to make them functional, so the additional components needed are described here:
1. Box. The additional components are to make a structural sound “box” or room.
2. Module. The additional components to assemble a set of boxes into whole “modules” such as an apartment, an office or a medical exam suite.
3. Structure. The additional components needed to assemble modules into a “structure” such as a multi-tenant apartment, a mixed-use building or a hospital
4. Development. The additional components needed to compose a set of structures into a self-contained “development” such as a “residential neighborhood”, “office park,” or “medical complex

### Box

A Box is established when four (4) or more panels are connected in a system and then attached to a Structural Frame to create a partially or fully enclosed room or environment. A Box is multipurpose. First, it provides the basic block to form structurally habitable space. Load bearing floor panels, vertical panels (wet systems panels, high voltage panels, and standard/specialty panels) are interconnected to create a series of boxes that supply a variety of spaces across all uses. Furthermore, the integration of panel/subpanel functionality (sensors, computing, etc.) and the connection of those panels in Box form allow for data to flow both directly between adjacent panels and across the open void between panels. Data collected from these sensors is compiled and filtered through the AI Assisted Operating System for unit optimization, reporting, etc.

These Boxes are optimized for shipping with a maximum width of 10′, however length may extend beyond 10′ depending on use. For residential applications, a 10′×20′ Box is the ideal configuration for multimodal transportation. For Example, as detailed below, a common Box used in Residential construction may include a “Wet Systems” Box which includes a system of standard floor panels, standard panels, standard specialty panels, wet systems panels, and high voltage panels. Panels are connected to the structural frame and both physical panels and subpanel systems are connected. Panels are connected to the frame and to adjacent panels through standardized universal connections and each subpanel system connected to adjacent panels. Sensors in each panel provide information including temperature, air pressure, water temperature, water pressure, occupancy, etc. which, in turn, is sent through subpanel computing to optimize unit functionality.

### Module

While a Box combines panels to produce a transportable semi to fully enclosed space, a Module combines two or more boxes to create larger systems of spaces arranged on a horizontal plane to form a range of applications from full units to building “floors”. For example, a Wet Systems Box combined with an open box is the basis to form a studio apartment. Further Box additions may result in a mix of unit types including one-, two- and three-bedrooms.

Mechanical in modules may use commercially available wall mounted systems for modules integrated with surface points that attach to the panelized walls using a combo connector with Mains AC, data communications and grey water and cooled fluid input from an external unit. The system may be smart PTAC units with direct connection to the AI Asset Management system. These systems are operated via a centralized smart home hub so as to connect into a software system. For larger modules, a panelized centralized HVAC systems may be distributed vertically and integrated within the panelized wall systems through the integration with the HVAC air handling system if it is forced air or with the chilled water and high voltage power layers. This allows a variety of systems to be integrated (and upgraded) with the panelized system.

### Standard Module Composition (Unit)

From subpanel through panel to boxes into modules, these forms may be generated by connecting sub-hierarchy to compose a fully formed space. These formations are done by a set of simple panel formations. Combining the panel forms above, a “unit” for example may be created by combining seven unique panel types with, for example, thirteen separate panels.

### Structure: Specific Components to Connect Modules

A Structure is defined as one or more sets of Modules structurally supported by building foundations and enclosed with a roof system. These components are physical components provide the support and aggregation facilities to that turn a collection of modules into a complete structure.
1. Modules. These are multiple complete living, working or other occupancy units.
2. Floor Module. These modules are fitting to standard floor layer. The floor layer provides the basic interconnect lines for all the major S/MEP/I systems. In addition, it may add specialized modules such as hallway, elevator core and systems core. These use the same grid system to provide services. The dual systems core ties in all the systems layer into a central location on each floor. There may be typically be two sets of AC, DC and other power, two sets of water fittings. This allows one “side” to undergo maintenance while maintaining services on the other. The Structure Floor may also have its own concentration of nodes, for instance, typically the low voltage DC may be terminated at each floor and the floor layer may have a data communications, and processing layers that provide distributed processing on each floor as well as battery backup. This may isolate power and other failures to single floors.
3. Structure Aggregation Modules. This layer ties together all the systems of the structure. As an example, there may typically be dual redundant data processing systems and storage systems and backup power systems as needed
4. Utilities Module. This is the interconnection point to the outside world through the foundation layer and an attachment/connection surface point for utilities. Certain utilities may be centralized such as hot water or thermal heating. Instead of a water tank sized for maximum demand in each module, the structure works have central hot water and HVAC. It may use the panel layers rather than needing per module heating. The AI system may predict usage and fill reservoir in the structure as needed to meet peak demand for heating or cooling.
5. Foundation Module. Foundation systems range dependent upon the size, density, and load of the structure

### Structure: Shallow Foundations

Slab foundations. Slab foundations, also known as mat foundations, fall into the shallow category of building foundations. They consist of a thin layer of concrete that covers the entire surface area of the building. These foundations are ideal for small structures such as houses and sheds. They are typically 10-20 centimeters deep and provide a small amount of insulation.
Raised foundations. Raised foundations are elevated from the ground by small concrete pillars to support the foundation and allow access to fixtures or storage. These building foundations provide structures like houses with crawlspaces but, they need to be well ventilated to prevent rot or mould from causing structural damage.
Wall or Strip Footing. This is another type of shallow building foundation that may economically support small dense loads, particularly if they're situated on dense sand or gravel. Typically constructed of plain or reinforced concrete, stone, brick, or Logicwall, these wall footings provide support to walls that are 2-3 times thicker than that of the building's exterior.
Isolated Footing. Isolated footing is a building foundation that utilizes a combination of columns with wide bases and slab bases made from plain or reinforced concrete. This footing is used to anchor the building 1.5 meters into the ground. Isolated footing works particularly well when placed at longer distances, and it may support small to medium loads.
Combined Footing. A combined footing is used to support greater loads with two or more columns in a row. It may also be rectangular in shape with large conjoining slabs. This building foundation is excellent for providing extra support in a smaller footprint for structures that need to be built on soil with low load-bearing capability.
Cantilever Footing. Cantilever footing or strapped footing is the same concept as combined footing with a more economical footprint for sites where the foundation may not extend past the property line. It utilizes slabs for columns that may be close together, supported by a ‘strap’ of concrete between them instead of one solid piece.

### Structure: Deep Foundations

Driven pile foundations. Pile foundations are deep, heavy load-bearing foundations used when the weight of the building is too great for the soil underneath. Long piles made from timber, steel, reinforced or composite concrete are driven deep under the surface to anchor the structure above and provide stability found within the hard strata of the earth. They are most commonly used for high-rises or heavier structures where the load to surface-area ratio is high.

Pier foundations. Similar to raised foundations, pier foundations are another form of deep foundations including cylindrical concrete columns that are lowered into excavated ground. They are widely used in the commercial construction industry for their strength and versatility. They are narrower than driven pile foundations, sustainable and are ideal in areas with soil that is too hard for piles.

Cassion Foundations. Cassion foundations are large hollowed-out blocks, typically constructed on-site above the ground, sunken into the ground and then filled with concrete. Offering sturdy support to structures that need shore protection, such as the coastal construction of bridges, piers and maintenance of ships, they may pump water out to keep the construction area dry. These foundations are large, expensive and become an integral part of the structure, restricting their usage to complex sites.

### Structure: Low Rise Slab Module

Typical Garden Style/Low-Rise need significantly reduced foundation systems to support building loads. Typically, these types of structures rely on shallow foundations to support structure. There are two ways of approaching these shallow supports. In this system, we enhance the foundation with a “foundation layer” that includes a gridded system where the connections provide LV power and data communications and each node has a set of sensors for moisture, vibration, position, settling and other key parameters in the foundation. This panel may be installed as a surface mount system or directly into the foundation structure itself.

“Slab on Grade” Foundations are used throughout low rise and garden style housing production in conditions where site grading may be easily executed. Our AI Design management system automatically chooses the correct foundation structure based on an AI model that takes into account a.) site conditions allowed and b.) timeline for site work (i.e., utilities, site grading, permitting, etc.) allowed for the work to be completed concurrent to unit production.

The system automatically determines if a deeper foundation may be needed, and may design using the appropriate foundation layer.

### Structure: Low Rise Rainwater Capture and Landscape Modules

Further excavation of the slab allows for the installation of stormwater detention for the use of rainwater capture and monitoring. The rainwater may be routed through our rainwater system. This may be connected directly to a sewage line. But the software may analyze the payback for using a collection of small subterranean cisterns for stormwater detention/reclamation for non-potable use such as irrigation. In a rainwater recovery system, each rainwater node senses the quantity and quality of the water through the use of both pressure, volume and water analysis sensors. And also dynamically determines the flow of rainwater using the grid of waste water connection lines. This dramatically reduces the likelihood of catastrophic drainage problems as the gutter system has multiple redundant flow points and provides the cleanout surface points to be dynamically inserted and removed as needed.

The system also allows for integration with water treatment for closed-loop water systems. Because the AI system monitors the overall water grey flow and integration weather conditions and maintain, as a history of past weather conditions, it may dynamically determine if there is going to be a flooding or other event and events residents and building owners. It may for instance preemptively drain cisterns and other storage systems in preparation for expected overflow. The AI system dynamically monitors both the condition of foundations, the historical flow capability and the dynamic rain and wind conditions.

The system also determines the absorption level of the structures external landscaping and other locations. Panelized water and moisture panels may be deployed in the landscaping, which allows for the gridded layouts of sprinklers. And the system may preemptively determine that with heavy rainfall expected in two weeks, to run the rainwater capture system at full to saturate the ground more fully to make “space” for the addition water flows

### Structure: Low Rise Raised Foundation S Layers

Another foundation system in this design for Low-Rise/garden development is the employment of raised foundations in the form of piers and footings are commonly used for these types of developments. They rely on a shallow pile (concrete or similar material) or footing that supports the building load along various points based upon the weight of the building and soil conditions. Use of shallow piers or footings allow for the building to sit above soil conditions and allow for water and other natural materials to flow below the building. The application data management (ADM) system takes as input for variable soil conditions, site grading, etc. and produces a shallow piers or footing scheme one of two approaches. Both approaches use a panelized leg pier. This includes a processor unit and sensor system that provide seismic, load, temperate and stress data that interconnects with surface points that are in the building structure itself.
1. Fixed Leg Piers/Footings: Using a variable seized concrete pier (mass and volume as determined by the vertical load of the structure) the building is connected by a simple set of pre-measured legs fixed by heavy bolt systems.
2. Variable Leg Piers/Footings: The “Variable Leg” system that utilizes the same variable sized concrete pier as described above, however the pier is equipped with a threadable connection between the pier/footing and the leg to allow for variable heights to support building load. This allows the building to accommodate grade inconsistencies in the field and allows adjustment in the installation process. Once the pier has been placed and the subsurface which may support the unit attached, site installers may adjust leg height to ensure that the building may be level. The system includes a electro-mechanical system to adjust the legs/piers lengths to account for future settling of the building and potential loading issues.

Utilizing shallow piers or footings has significant advantages. First, with our integrated design system, we may manufacture various size piers in the facility to be delivered to the site for installation, significantly speeding up time and minimizing the amount of site work needed. And with our RFID and tagging system, the piers maintain a complete installation and maintenance record for owners. Furthermore, ownership of building foundation systems removes risk from the general contractor by minimizing the overlap of product production and construction site work. Second, in the use case of emergency housing or temporary housing this allows all properties of the building to be a.) quickly installed in nearly all conditions where housing may need immediate installation b.) allow for removal and relocation. Removal and relocation gives owners flexibility for location and may likely qualify as temporary housing similar to mobile home parks there by giving these modules the ability to be applied under a wider range of municipal zoning.

### Structure: Low-Mid Rise/High Rise Structure Foundation Modules

Today, dense modular construction beyond 35′ needs more intricate structural systems. Due to site constraints for urban and suburban conditions where these structures may be developed, foundations and other subsurface conditions necessitates more site specific foundation to accommodate structural support. In many cases, due to the mass of the structure, shallow foundation systems may not be used and rely upon deeper foundations such as piles or caissons to be installed to reach earth conditions needed to support the load. Piles may be driven as shallow as 3-4 m and up to 50 m while caissons may reach depths as far as 100M. In addition to increased foundational capability, low structures may need some portion of heavier structural systems such as steel or post-tension concrete to accommodate the building structure. In this product type (referred to as Type V construction) these structures support up to 3 stories through heavier structural systems while the remainder of the structure may utilize conventional wood or similar load bearing structures. Type III (Mid Rise)-Type I (High Rise) may need fully supported heavy structural systems to support building loads. Lastly, these structures may need both a structural core to support vertical transportation and provide structural integrity and interior corridors to maximize efficiency of the structure.

To meet this need, the system has a Structure Utility Interconnection Surface Point that connects the Structure Core Layer to external systems. This system may typically be dual and redundant, so that if one utility connection fails, the building remains powered. As discussed in our structural approach, we have a universal connection as opposed to a uniform structural system. This allows for a.) use of a variety of structural systems determined based upon applicability, regional use, and ease of building approval by local inspection b.) variable use in product type (IE. office, industrial, retail, etc. may need different structural systems.

### Structure: Roof Modules

Roof systems include rain-screen or other moisture barriers integrated within roof panels, and increased structure to assume a load of plantings, rooftop decks, solar, and energy storage (if desired). These modules may typically have a sensor layer and processor layer to measure the performance of the roof system.

Primary roof surfaces may include a commercial roof membrane and attachments for solar installation. They may also include additional battery storage as well. Other roof applications may allow for variable soil depths for eco-roofs as well as load bearing capacity for roof top decks.

### Development

A development is defined as a fully permitted, approved, and delivered operational structure with the capacity to be occupied. Developments may be single or multi-structured, a single use or mix of uses, and may include one or more contained real estate parcels. A development may include infrastructure including utilities, roads, sidewalks, public spaces, etc. connected to or independent from a city, municipality, town, etc. Often a development includes one or more financial structures with a single or multi-entity “Developer” overseeing the creation of the physical real estate. Developments may be defined primarily by their financial structures and may typically include investor lead equity sources and lender debt obligations however they may include a wide range of complex capitalization structures that support project creation.

During this phase of the hierarchy the investor, lender, owner, developer, and other ownership forms are introduced. All functions at the subpanel and panel levels play an integral role in impacting overall project risk perception. As such physical component integration focuses largely on development oversight/management and reporting to a) optimize building performance, b) assess potential risks, and c) provide real-time asset management functions.

Just as modularization and layerization move much of the custom on-site construction work into the controlled manufacturing environment, the Development is also constructed through a series of Super Modules and Super Layers which support multiple structures built into a single integrated whole.

### Development: Infrastructure Super Module

In traditional development, all the core pieces of infrastructure are “custom built” and “buried” as quickly as possible. This system treats an entire development as an integrated whole with a design for long term 200-year reliability. The core super module needed is for infrastructure.
1. Single module meant to be connected and has a road on top. The infrastructure super module is a single physical component that is typically placed under the road surface with complete sensor data and physical access for long term repair. The module has all the facilities needed to make a structure operate, that is all utilities, vehicle and pedestrian access.
2. Individual modules buried and flexibly connected. Each module is typically 20-40′ in length and is buried. It uses super connections that tie the modules together. These connection points are monitored and are flexible to allow for underground settling and seismic events.
3. Module construction starts at the assembly facilities and self builder. The bootstrap is to build a manufacturing assembly facility at the main access point to the development. This may be where the main utilities such as power, water and communications enter and where waste water exits. A special “digger/transporter” may excavate to the appropriate depth and then take an assembled super module transported from the factory and place it into the correct position. Auto leveling technology such as those used with the panel system are employed. These modules are fully equipped with the panel systems to allow their easy maintenance with Wifi, data access and surface connecting points to inspect individual layers that are underground.
4. Human and robotic access side tunnel layer and integrated lift points. The module includes an open access side tunnel to allow access while underground. An individual super module may be easily excavated and lifted as every super module includes “lift points” and rapid disconnect between components, but typical repair and replacement may be handled in the “side tunnel” space.
5. Redundant infrastructure paths to each structure. The AI Design System may ensure that there is adequate redundancy, such that there may be two “infrastructure routes” to each structure. Thus, even if an entire infrastructure path fails, the other is available to allow continued occupancy. For cost reasons, the support may be lower (less water, lower power), but the building may still be occupied. If a typical infrastructure failure (such as a water main break or a power break occurs every 30 years and takes a month to fix, the likelihood that both of these systems may break is once every 5,000 years).
6. Roadworks/Pedestrian layer. The top super layer in the super module is the road work or pedestrian walkway layer. This layer may result in super modules that are not buried to be lost but reside under structures that undergo constant instruction and maintenance. The road work layer is designed to be liftable as a unit (just as the entire module is as well). This layer has its own vibration, moisture, strain and load sensors to measure the quality of the road layer.
7. Road Drainage Layer. This layer may typically be connected to the rainwater sublayer in the waste water layer below.
8. Automated Driving Aids Layer. The system may include a road driving aids layer that may make it easy for robotic or semi-autonomous systems to navigate the road network. This may first be used in building the structures and then later during operations for routine tasks such as maintenance, package delivery and intra-development transit systems. These systems may typically include guide wire technology under the road surface and optical systems on the road layer itself. Note that in inclement climates, the temperature management system may be needed to allow automated operation
9. Roadworks Temperature Management Layer. In cold climates, the roadworks sublayer may include an optional heating layer that uses heated liquid or gas to condition the road surface. In very warm climates, the system may be reversed to use a liquid or gas cooling system to maintain roadworks temperatures that may prevent cracking and other failures.
10. Insulation Layers. Typical between layers may be an insulation layer that provides thermal, heat, electrical and moisture isolation. The layers themselves are instrumented and their own sensing relay network that flows through the processing layer.
11. Monitoring Layer. Each module has its own processing, sensing and data and low voltage layer with battery backup. It relays these through the module connection point to the AI Management System.
12. Maintenance and Access Layer. This may typically include a human accessible tunnel that may be used for maintenance and predictive repair.
13. Low Voltage Communications Layer. This is a layer that has conduits that are the interconnect lines. They support low voltage communications such as cable, Ethernet or optical fiber. Each has a sense sublayer and may be accessed at each module for inter module repair and diagnosis
14. High Voltage Power Layer. There may be an insulation layer to protect the low voltage from interference, but this may carry the 440V and above power to structures. It has the power sensing and load detection sensors that are sent to the monitoring layer. Note that this system may allow regeneration if the structures have solar or other generation schemes and may include switching to allow this.
15. Water Layer. This system carries fresh water into the structure. The water layer may include hot water carriage or steam carriage if there is district heating available (see below)
16. Waste Water layer. This is typically segregated into rain, grey and black water sublayers. In a single neighborhood, these may be directly connected to the external utility providers (typically a combined sewage system), but the three options allow more flexibility if the overarching district or municipality support it.
17. Self Leveling Support Layer. Although the modules may be precision laid by the automated infrastructure module system, the system includes a self leveling system that allows small adjustments of the modules as the system settles and otherwise changes. The system operates in all 3 dimensions to control the yaw, pitch and roll of each module.

This scheme allows complete robotic creation of a road system with easy to maintain utilities that provide all the construction facilities needed from day one. The road gets built first, then the structure assembly work happens.

Inside each Infrastructure Supermodule are the following layers typically in this order:

### Development Infrastructure Module Variants, Grid Layout and Automated Sizing

The AI Design System may model the overall design of the development, size the energy, water and other needs and considerations such as grading and hills to build the lowest cost system. It may also manage the sizing of the system given expected future needs. A typical grid system may be:
1. The buildings may ideally be in a grid (or deformed grid), that is there is infrastructure module access from four sides of the building.
2. The road system may be constructed so the buildings may be accessed from at least two sides from the roadway.
3. The infrastructure paths may then double connect to each building

To allow for turns and intersections in addition to the “base infrastructure super module described above), there are variants such as:
1. Y Infrastructure, this creates a fork in the road where two module paths may be taken.
2. L Infrastructure module. This allows turns.
3. Cross-roads modules. This allows intersections to be built.
4. Each module connection has a flexible joint that allows both settling, seismic activity and also smaller bends in the road.

### Parking Module

Vehicle parking and general storage are an important component of any development. We use a Panelized module that may have these layers.
1. Roof panels. These are likely of a different grade than the full structure. And may include Panelized solar.
2. Enclosure panels. In areas of extreme weather it may have a Panelized enclosure complete with low voltage power for heating. And heavy insulation layers.
3. Roadway Ground panels. These may be of vehicle strength.
4. High voltage layer. These may support electronic vehicles.
5. LV, Mains AC, High pressure water and Greywater. These may support car washing and cleaning.
6. Parking Stall Panels. Integrated panels that optimize storage of automated cars.

### Access Road Module

Note that parking lots and “dumb access roads” may be built with a simpler infrastructure module that just carries the roadway and driving aids layers and perhaps the temperature management layer. This may allow modular replacement and autonomous driving.

### Development Assembly Facility

While it may not be economical in most cases to produce things on-site, for developments there is an Assembly Super Module. This is the first module constructed and allows “all weather assembly” of knocked down panels into modules. The components of this facility are:
1. Utilities Substation connect Point. The utilities are the first thing to be connected. This provides power, water and sewage for workers.
2. Panelized On-site Enclosure. The first thing to be built is a large assembly enclosure. This uses hand assembled industrial panels. These panels are designed for industrial use. They include a High Voltage Layer supplying 440V power and have large mechanical attachment surface points. The industrial panels are similarly upsized. All handling systems connect and process information and are powered through the same panelized system used in structures being built. It allows for rapid reconfiguration of the structure as an ops center, repair center, resident storage and light industrial post-construction.
3. Construction Office and Workforce Housing. The first modules to be assembled may be office and workforce housing. These may be hand built and provide convenience in peri-urban locations, create culture and train new associates on how the system works. Ideally these workers may be amongst the first residents of the development and long term maintenance staff as well. Living with what you have built helps guarantee pride and high quality.
4. Materials Handling System. This takes the various panels and allows their delivery. This may typically be an semi-autonomous handling system because each panel is “live” with its own RFID so automated handling and input into the AI Construction System may happen.
5. Test-Supported Panel Carriers. Panels are shipped from the factory encased in a full test carrier. This carrier protects the panel and has all the surface connections populated. The test carrier may itself be panelized and provides continuous self test of the panels from the manufacturing center to delivery. This approach maximizes the change of detecting early failures of components as soon as possible. All tests are stored in the WORM layer for upload to the predictive AI. Both the unit under test and test carrier results are managed to determine if it's a true panel failure or a carrier failure. Depending on AI prediction, the module may be held in the carrier for additional test time.
6. Test fixture Environmental Testing. The panel may undergo specific environmental testing with simulated temperature, vibration and moisture checks. While the panel goes through the same testing at the factory, depending on predictive confidence, the assembly system may delay units for additional tests. These tests are added to the part database and kept in the panels themselves for cradle to grave failure tracing.
7. Box Assembly and Test System. This may be a “layer cake fixture system”. This allows panels to be stood up and assembled into modules. The assembly system is also designed to allow full testing of each side of the panel before assembly. And after assembly the box goes into continuous test mode.
8. Fully Assembled Infrastructure and Modules Handlers. The modules are built on robotic or wheeled assemblies, so that they do not need to be stacked when they are complete.
9. Infrastructure Submodule Excavation and Place System. This system does the excavation for each individual infrastructure super module. When complete, the excavation system moves to the side and a module lift moves forward. And a crane or other system places the module. Full system test is then done on the module from the main Assembly Module. Note that turns and curves are handled by having a flexible joint system between the modules that allows them to rotate. Modules may also be placed crosswise with a special Junction module that allows Y connection, T and X-connections as well.
10. Foundation Build System. Depending on type of foundation used this may be as simple as a pick-and-place autonomous system to place piers or it might involve custom human controlled excavation
11. Structure Assembly System. Once a module reaches a structure, the structure assembly system moves the modules from the assembly system to the structure and automatically lifts components into place. More detailed assembly may be carried out quickly indoors given the panelized nature of the structures.
12. Post Construction Operations. After the initial construction is complete, the assembly building may be left in place with module handlers and repair facilities. This may allow the repair and refurbishment of components onsite. This facility may also be used for delivery systems, refuse and other systems using the “module handling” system to transport items to and between structures.
13. “Continuous” As Built Documentation. All the construction data along with the panel details, version control and sensing data may be captured into an As Built documentation to record the measurements and elements of the building after the construction has been completed. This may be available in an electronic form and may be stored in the AI Asset Management System and Design. As systems settle and have other abnormalities, the AI system may continuously assess the actual condition of the real structure.

### Development-Wide Enclosure System

At the development level, a major cost is the roofing and exterior siding needed for each building. A pre-planned development may significantly lower both the cost of construction and cost of operations with a single development-wide roofing system. This system may consist of transparent panels similar to a greenhouse and it may provide power generation capability that is much more affordable.

Moreover a development-wide roofing and enclosure system may allow “green spaces that may be used at night and during inclement weather. Finally, this may considerably reduce the cost of roofing each building and reduce the amount of insulation needed in each structure.

Finally, when building a development, the installation process may start with a roofing system and thus provide shelter regardless of the weather.

The roofing system may include movable walls that may allow operating in very hot weather, cold weather and during the forest fire and other poor air quality situations.

### Development Operations Center, Delivery and Maintenance

After the development is complete, part of the assembly center may be repurposed to operations and other uses to support the development.

For day to day operations, a development may include an operations center that provides an overview of all structures and infrastructure components. The AI system may detect utilities and other usage and predict failures of components.

Particularly in remote locations, this operations center may also serve as a caching point to conserve resources. For instance, it may have a data caching operation to predictively cache internet requests from development users. It may predict bandwidth uses and curb excess use as needed.

Finally, in locations where water or power or other resources are in short supply, it may maintain water and power reservoirs for peak usage and manage use between structures on the site. It may also do development wide activities such as lower water usage over the winter months in anticipation of hot summers.

The assembly facility retains the module handling system so it is ideal for reuse as
1. Package and automated mail delivery.
2. Refuse and recycling collection.
3. Repair and maintenance particularly if it retains the structure assembly gantries it may be used for roof repair exterior repair.

It may also be used for assembly to other developments in a pre-planned District.

Finally this large enclosed space may be used by development occupants:
1. Storage space for home goods, automobiles, recreational equipment (generating additional fees).
2. Light manufacturing or maker space using the high voltage systems.
3. Indoor exercise, pickleball or other training facilities or other use.

### Master-Planned District

District combines 2 or more developments into a uniform area, section, or neighborhood of a city, town, or municipality. That area is broadly defined by a set of characteristics, local landmarks, or other defining qualities of the area as set forth by social or community values. Functionally, districts are support systems for developments. As highlighted above, a development introduces the concept of the developer, owner, investor, lender, manager, etc.

A district often does not have a single ownership structure and therefore does not have the same focus around investor risk, however a district allows developments to connect into a greater system of oversight. A district may be established by both private and public resources. For example, a district may be master planned and developed by one or more private developers which connects into a larger publicly controlled city, town, or municipality or may constitute an existing part of a city, town, or municipality that is simply defined by its characteristics, landmarks, etc. (Ex. South Waterfront District in Portland, Oregon; Fenway Neighborhood/District in Boston).

Within a district, are several district-level modules that may be present in a master-planned district:

### District Panel Production

The concept of a centralized factory or hub of factories becomes important both to supply the production of future developments as well as supply developed subpanel embedded infrastructure. Production facilities may include additional functions for robotics and other automated elements of mechanized public infrastructure including the storage and power supply.

Furthermore, as highlighted below, automated delivery and installation of retrofits and new construction through subpanel integrated infrastructure (streets, sidewalks, etc) allow for easy delivery of product throughout the district.

### District-Specific Modules Tree

At the district level, subpanels and panel functionality extend beyond the structure and into a greater realm of public infrastructure.

Our AI planning system may support urban planning projections with a series of larger and more capable infrastructure modules.

For instance individual districts may have widely varying utility and transportation needs so the size of the roadway may have to change and the size of utility stacks.

Subpanels may be integrated into streets, sidewalks, and other pedestrian/vehicle surfaces supplying power, sensing occupancy and monitoring the vitality of the surface (i.e. potholes and other surface abrasions are easily monitored and remedied).

AI supported robotics providing supportive services (maintenance, cleaning, etc.) use subpanels sensors to supply a path way as well as identify service needs. Sensors, cameras, and other subpanel functionality play a key role in public safety including future robotic patrol and other automated security systems including early detection of fire, seismic activity and warning, etc.

### District-Wide Utilities: Heating, Sewage, Etc.

Furthermore, district level utility infrastructure may be supported by panel and subpanel integration. In a smart district, municipal infrastructure connects into the system optimized, AI supported system. Potable water, waste water/sewage, trash/recycling, and electrical grids may be linked via subpanel sensors and AI supported computing to optimize district systems.

Panelized structures for energy deployment include all subpanel functionality and AI systems controls to manage energy deployment, generation, and storage. Panelized structures may provide all levels of utility operations including trash/recycling, water treatment, deployment, and reclamation, etc.

### District-Wide Services: Trash, Delivery

Integrated with district subpanel infrastructure allows for robotic supported functions such as trash/recycling pick up. Furthermore, resources may be recycled and utilized in district infrastructure. For example, a district may include robotic operated trash and recycling collection. Subpanel sensors allow robotic operations to track pathways to provide collection services and deliver to district trash and recycling facilities. District trash and recycling facilities may capture waste energy and heat from the recycling process to provide supplemental energy which may be stored within public energy facilities. Residual waste material may be used as a mix for road development.

### District Services: Non-Panelized Developments

Integrated subpanel functions may oversee all development utility deployment and oversee and monitor that deployment for non-panelized developments within the district.

For developments, a district provides the placemaking needed to attract district growth and generates a system overlay that supports developments. Interconnected subpanel through the entire hierarchy of physical components through district level infrastructure allows for greater optimization, support, and oversight.

### District Load-Balancing and Caching Services

With an entire district, the AI system aggregates usage patterns and predicts future usage. This allows the system to for instance take power generation from a residential district and apply that power to the office district during business hours. It allows predictive caching of data to lower internet usage and also provide district-level compute and other facilities that may otherwise have to go long haul taxing bandwidth.

### City, Town, Municipality Modules

A city, town, or municipality is established by combining two or more districts into a fully functioning, governing collection of neighborhoods and areas. Where a district may include public and private oversight, a city, town or municipality is entirely controlled by a public entity which oversees all public facilities (utilities, public safety, public infrastructure, etc.).

### City-Wide Operations Center

A panelized city, town, municipality, as described in the “district” hierarchy, infrastructure, utilities, public safety, maintenance functions, and other core functions integrated may use subpanel capacity and AI computing provide public entities oversight, control, and optimization of city, town and municipal functions.

### City-Wide: Self Generation Optimization

Certain services may be economic at a city scene, and a panelized city makes that level easier to reach. For instance a single large city solar array may be prohibitively large if sized to absolute maximum demand, but our ai system working across buildings and developments accurately predicts usage patterns. And is able to trim peak loads by reducing usage in empty buildings and beyond thermal reserves by overcooking at night for example.

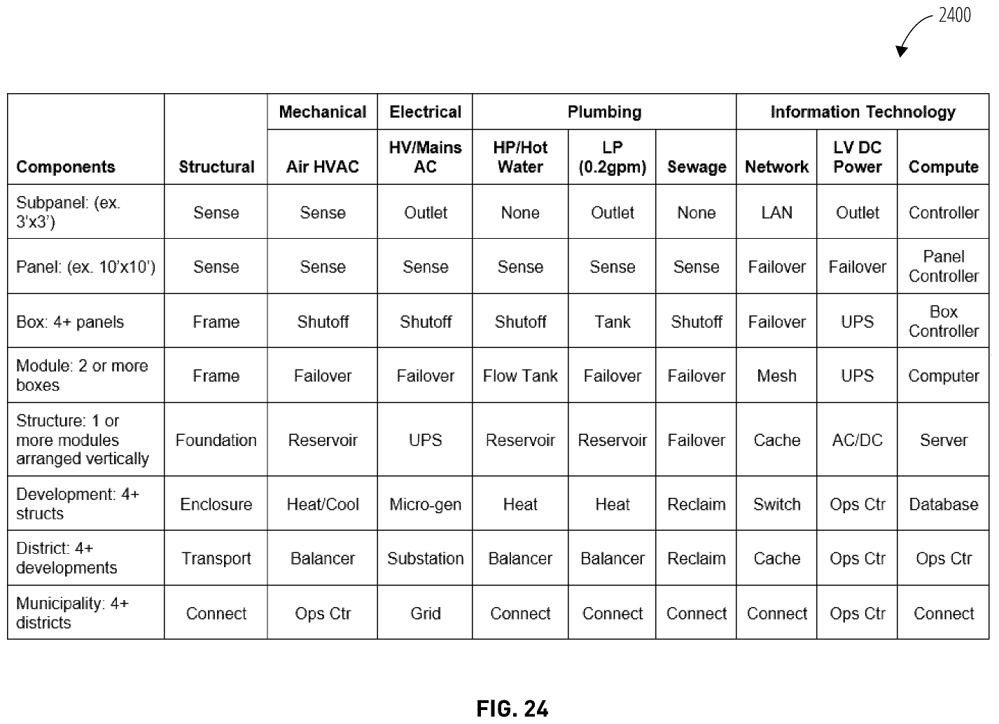

FIG. 24 illustrates exemplary physical component integration with major systems elements 2400 in accordance with one embodiment. In this manner the disclosed physical components may be integrated with existing or purpose built infrastructure systems in support of creating and maintaining structures and communities. The terms and abbreviations used therein are further defined as:
Sense: Collect S/MEP data
Frame: Load bearing system
Foundation: Ground connection
Enclosure: Weather-proof walls and roof
Transport: road, pedestrian access
Connect: external world hookup
Shutoff: Automated on/off
Failover: Switch to redundant system
Reservoir: Thermal storage (e.g., water tank)
Heat/Cool. Active thermal (e.g., heat pump)
Balancer: Load balance, move surplus to shortage
Ops Center: Central overview console
UPS: Electricity storage (typically batteries)
Micro-gen: Generation on site (solar, geo)
Genset: Alternative generation
Grid: Connect to utility grid
Flow Tank: Low to high pressure reserve
Heat: Water (may combine with HVAC)
Reclaim: Grey water reuse system
Wi-Fi/Ethernet: Network connectivity
Cache/Switch: for network data

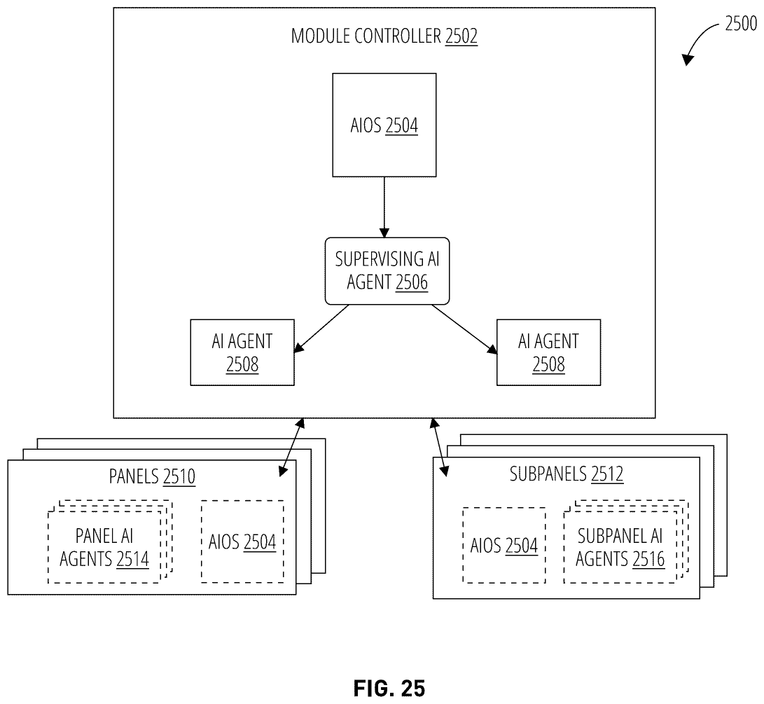

FIG. 25 illustrates a system controller 2500 comprising a module controller 2502, an AIOS 2504, a Supervising AI Agent 2506, AI agents 2508, Panels 2510, Subpanels 2512, optional Panel AI agents 2514, and optional subpanel AI agents 2516.

In exemplary embodiments, the major components of the AI operating system AIOS 2504 include a layered architecture with software modules residing at each level of the building hierarchy. As an example, when a smart panel begins operating, the AIOS 2504 component is stored in a processor module inside the Panels 2510 and/or Subpanels 2512. The AIOS 2504 may also be stored in the module controller 2502. The boot strap process has that AIOS startup. It then detects the sensors that are available to it, it detects the networks which are available (both hardwired and via radio frequency such as WiFi or Bluetooth). The module controller 2502 contains an AI model which manages the system in a series of AI agents 2508 that are dedicated to specific tasks. The AI agents may be stored on Panels 2510 as Panel AI agents 2514, or on Subpanels 2512 as subpanel AI agents 2520. These agents have a workflow that can be pre-constructed and also new workflows can be enabled by the AIOS Supervising AI Agent 2506. The Supervising AI Agents 2506 may be located in the module controller 2502, or in individual Panels 2510 and/or Subpanels 2512. As an example, when the system starts, it gets the unique ID of the panel that is burned into the panel at the factory to create a log for the panel from manufacture to installation to use dates. As new sensor data arrives such as the temperature, electrical draw and other properties, it stores this into the system. The machine learning agents then decide what data can be made available to the higher-level module system.

When the system starts, the AIOS 2504 in the panel may determine which panels are logically adjacent to it and where the module controllers 2502 is. In this way, any single panel can wakeup and add itself to the array of “neighbors” that is other panels that are in the same room. The physical connection is a simple way to determine this, if the connection is physical, then it knows that the other panel is in a particular direction (up, down, left, right, etc.), the higher level system in this case.

The system operates in a distributed fault tolerant way so that if the panel does not detect a higher level agent, it will continue to cache the data that it has and store it in an encrypted form that is accessible only to the manufacturer and also to the owner of the system. The owner identification is store by the manufacturer (or their representatives such as a reseller) when the panel is sold. The encryption with the owner key ensures that only when the owner has given permission and the manufacturer has given permission can data be read out.

As a non-limiting example, the panel may contain an agent that monitors heat or fire, water incursion, electrical usage and it dynamically determines when there is an out-of-range reading. It will then inform both its neighbors and the module controller 2502. In this way events are moved up the chain from panel to module etc. to the city. Each layer in the AIOS gets data passed up to it automatically.

This system allows the creation of agents at different layers with layered security and also allows access. For instance, a module AIOS software would run in the module controller and have a collection of panels, which are its “children”. As events from them arrive, the module can construct high level abstractions. As an example, if a panel module has a Lidar sensor to sense movement, then the system AIOS component can add these together to get a 3D map of objects in the room. Similarly with smoke or fire detection, if the top and left room panes detect heat and smoke, the Module AIOS component can infer there is a fire event in that corner of the room and informal the Room and higher-level controllers of these events.

Since the AIOS is distributed the instructions can also flow downwards as well as upwards. For instance, if the District-wide AIOS determines weather and other conditions are likely to result in a high heat (for example a 40° C. heatwave), then the AIOS module can generate events that flow downward into the hierarchy. As an example, the AIOS module at the district level may determine that “super cooling” in the night of unoccupied rooms can create a thermal reservoir, it can inform the lower Building and Room and then Modules to take this action and cause additional cooling that will counteract the high heat. Similarly, a Building OS will get electrical and occupancy events. The AIOS may have a predictive model of electrical and hot water and cooling use, so may direct lighting in unoccupied rooms to shut off and also preheat hot water in preparation for the evening “return to home.”

The system is designed so this functionality is embedded in a series of software AI agents that can be updated and changed over time. So the system can add new functions as needed and the agents can learn based on actual building performance and usage.

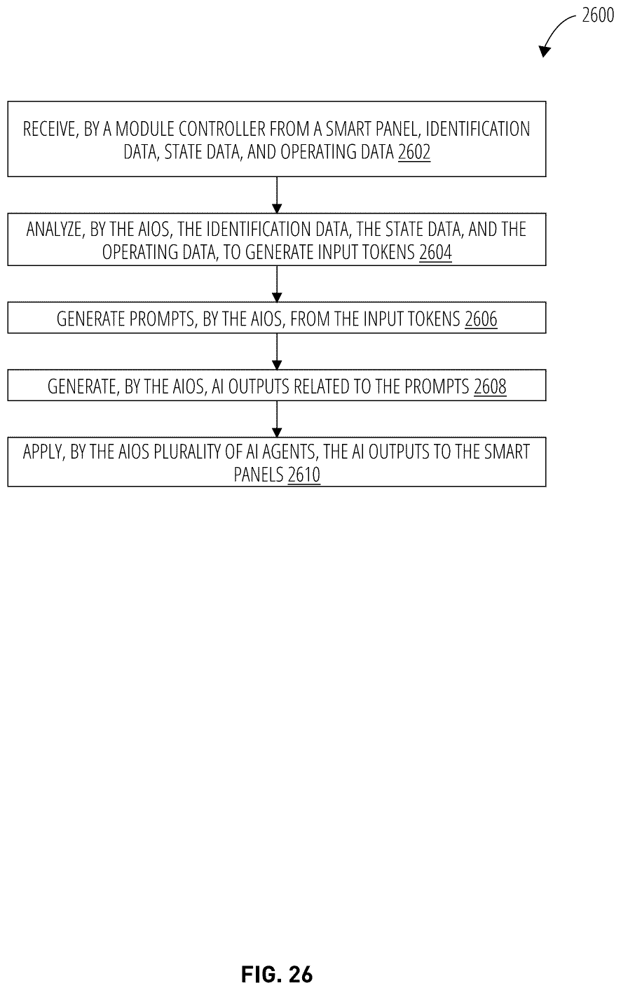

FIG. 26 illustrates an example method 2600 for monitoring and controlling a smart panel system. Although the example method 2600 depicts a particular sequence of operations, the sequence may be altered without departing from the scope of the present disclosure. For example, some of the operations depicted may be performed in parallel or in a different sequence that does not materially affect the function of the method 2600. In other examples, different components of an example device or system that implements the method 2600 may perform functions at substantially the same time or in a specific sequence.

According to some examples, the method includes receiving, by a module controller from a smart panel, identification data, state data, and operating data at block 2602.

According to some examples, the method includes analyzing, by the AIOS, the identification data, the state data, and the operating data, to generate input tokens at block 2604.

According to some examples, the method includes generating prompts, by the AIOS, from the input tokens at block 2606.

According to some examples, the method includes generating, by the AIOS, AI outputs related to the prompts at block 2608.

According to some examples, the method includes applying, by the AIOS plurality of AI agents, the AI outputs to the smart panels at block 2610.

According to some examples, the method includes generating, by the AIOS, AI outputs related to the prompts at block 2612.

According to some examples, the method includes applying, by the AIOS plurality of AI agents, the AI outputs to the smart panels at block 2614.

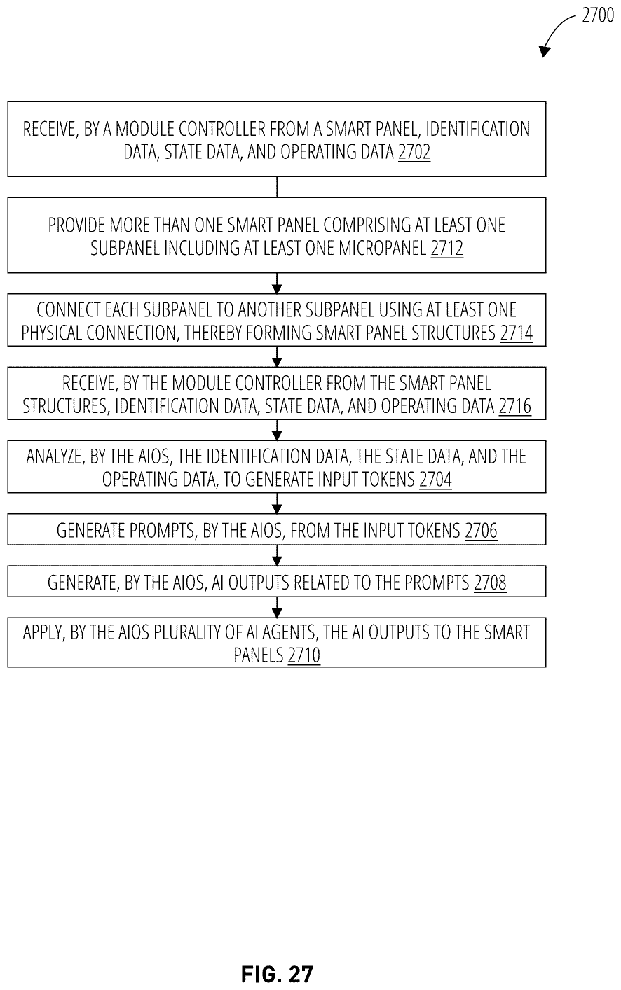

FIG. 27 illustrates an example method 2700 for creating a smart panel system. Although the example method 2700 depicts a particular sequence of operations, the sequence may be altered without departing from the scope of the present disclosure. For example, some of the operations depicted may be performed in parallel or in a different sequence that does not materially affect the function of the method 2700. In other examples, different components of an example device or system that implements the method 2700 may perform functions at substantially the same time or in a specific sequence.

According to some examples, the method includes receiving, by a module controller from a smart panel, identification data, state data, and operating data at block 2702.

According to some examples, the method includes analyzing, by the AIOS, the identification data, the state data, and the operating data, to generate input tokens at block 2704.

According to some examples, the method includes generating prompts, by the AIOS, from the input tokens at block 2706.

According to some examples, the method includes generating, by the AIOS, AI outputs related to the prompts at block 2708.

According to some examples, the method includes applying, by the AIOS plurality of AI agents, the AI outputs to the smart panels at block 2710.

According to some examples, the method includes providing more than one smart panel comprising at least one subpanel including at least one micropanel at block 2712.

According to some examples, the method includes connecting each subpanel to another subpanel using at least one physical connection, thereby forming smart panel structures at block 2714.

According to some examples, the method includes receiving, by the module controller from the smart panel structures, identification data, state data, and operating data at block 2716.

According to some examples, the method includes generating, by the AIOS, AI outputs related to the prompts at block 2718.

According to some examples, the method includes applying, by the AIOS plurality of AI agents, the AI outputs to the smart panels at block 2720.

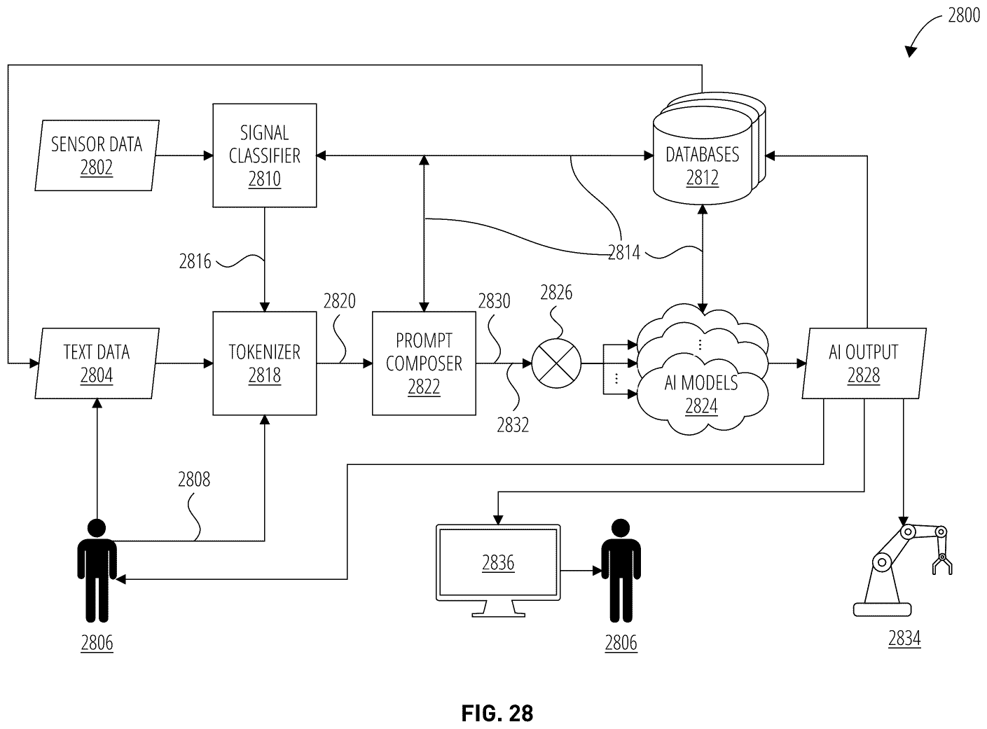

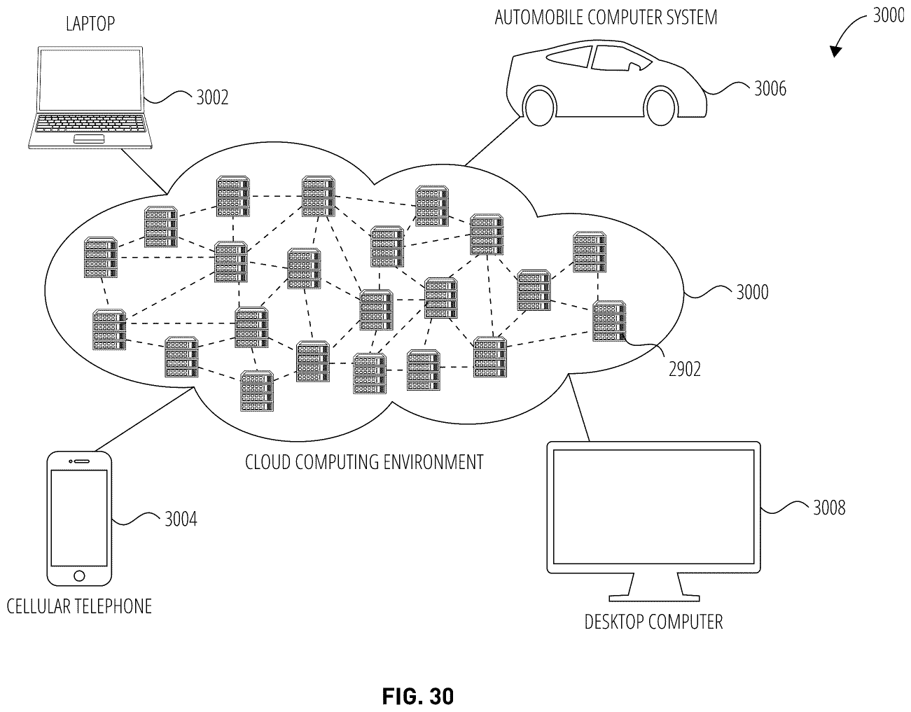

FIG. 28 illustrates an AI system 2800 in accordance with one embodiment. The AI system 2800 may comprise a sensor data 2802, a text data 2804, a signal classifier 2810, a tokenizer 2818, a prompt composer 2822, an AI model 2824, an AI output 2828, a database 2812, a user 2806, and a model selector 2826. The AI system 2800 may in one embodiment be implemented on a single computing device such as the computer system/server 2902 described in greater detail below. In other embodiments, the elements of the AI system 2800 may be distributed across cloud computing nodes 2900 interconnected in a cloud computing environment 3000 as described with respect to FIG. 30.

Input to the AI system 2800 may be in the form of sensor data 2802, text data 2804, user 2806, and other forms of data, as will be readily understood by one of ordinary skill in the art. The sensor data 2802 may be provided by sensors providing digital or analog readings. These sensors may be connected in a computing environment and may thus provide output sensor data 2802 for storage in various forms of computer memory and for processing by computer processors. Text data 2804 may be provided as input from various sources, including human users 2806 operating a text entry peripheral attached to a computational device, such as a keyboard, a microphone with its audio output processes by speech-to-text algorithms, etc. Text data 2804 may also include historical data stored in various memory structures. Users 2806 may also provide input to the AI system 2800 in the form of user selection data 2808 through a computational input/output (I/O) interface such as a mouse, keyboard, microphone, touchscreen, etc. This description is not intended to be limiting, and additional sources of sensor data 2802, text data 2804, and user selection data 2808 may readily occur to one of ordinary skill in the art.

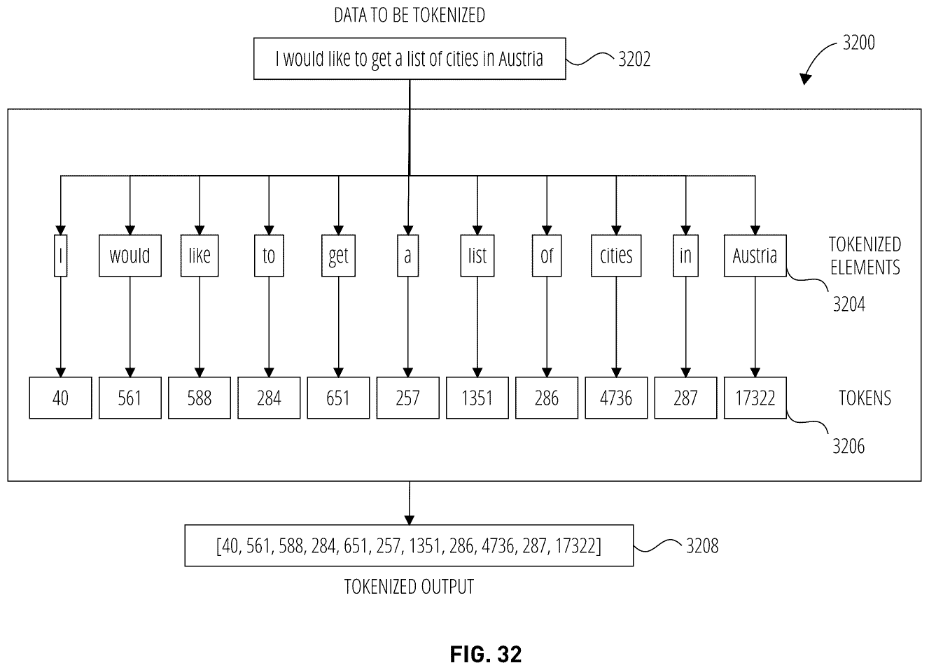

Sensor data 2802 may be sent to a signal classifier 2810 in order to analyze and interpret the data provided by sensors. In one embodiment, the signal classifier 2810 may act as a specialized tokenizer trained or otherwise programed to recognize and interpret sensor signals and tokenize sensor data 2802 such that the phenomena detected by the sensors and recorded in the sensor data 2802 may be communicated in a manner interpretable by other elements of a computational system, such as the components of the AI system 2800 described here. A database 2812 may include stored data 2814 which may be made available to the signal classifier 2810 in order to classify current text sensor data 2802 quickly based on known classification so similar signals based on prior knowledge, programmed relationships, or AI system 2800 learnings. In one embodiment, the signal classifier 2810 may provide such signal classifications 2816 directly to the prompt composer 2822. In another embodiment, signal classifications 2816 may be sent for further tokenization by the tokenizer 2818. text data 2804 and user selection data 2808 from the user 2806 may also be sent to the tokenizer 2818. The tokenizer 2818 may develop input tokens 2820 from the various streams of input data as is described for the exemplary tokenizer 3200 illustrated in FIG. 32. The input tokens 2820 may be provided as input to the prompt composer 2822.

The prompt composer 2822 may receive the input tokens 2820 developed from the sensor data 2802, the text data 2804, the user selection data 2808, and other sources of data available to the AI system 2800 not pictured here. The prompt composer 2822 may also receive input in the form of stored data 2814 from one or more databases 2812. Using these inputs, the prompt composer 2822 may construct a single token, a series of tokens, a body of text, and/or a series of conditional or unconditional commands suitable to use as a prompt 2830 to one or more connected AI models 2824. For example, a series such as “conditional on command A success, send command B, else send command C” may be built and sent all at once given a specific data precondition, rather than being built and sent separately.

The prompt composer 2822 may generate tokens or other prompt elements that identify a requested or desired output modality (e.g., text, audio/visual, computer/robotic commands, etc.). The prompt composer 2822 may generate an embedding which may be provided separately from the prompt 2830 for use in an intermediate layer of the AI model 2824. The prompt composer 2822 may generate multiple tokenized sequences at once that constitute a series of conditional commands. In some embodiments, the prompt composer 2822 may utilize a formal prompt composition language such as Microsoft Guidance. In such a case, the composition language may utilize one or more formal structures that facilitate deterministic prompt composition as a function of mixed modality inputs. For example, the prompt composer 2822 may contain subroutines that process raw signal data, such as may be included in sensor data 2802 and user selection data 2808, and utilize this data to modify prompts 2830 in order to ensure specific types of AI outputs 2828.

In one embodiment, the prompt composer 2822 may be configured to identify among multiple available AI models 2824 the one best suited (specifically trained, historically successful, etc.) for addressing the need represented by the data in the prompt 2830. In this case, the prompt composer 2822 may provide a model identifier 2832 interpretable by a model selector 2826. The model selector 2826 may be configured to route the prompt 2830 to the specific AI model 2824 indicated by the model identifier 2832. In this manner, the AI system 2800 may be able to optimize model usage for the most quickly generated and most accurate AI output 2828.

AI models 2824 may include large language models (LLMs), a Generative Pre-trained Transformer (GPT) model, a generalist agent such as Gato, and other models such as may be readily anticipated by one of ordinary skill in the art. These AI model 2824 may be configured to supply AI outputs 2828 based on the prompt 2830. The AI output 2828 may be multimodal in some embodiments, and may take the form of text output, audio output, visual output, programmatic output such as computer or robotic commands, etc. AI output 2828 may be sent to users 2806, which may be the person providing the text data 2804 or user selection data 2808 inputs or other users similarly in contact with the AI system 2800 through a computational interface. The AI output 2828 may be sent to interconnected computing devices or systems 2836 such as these users 2806 may utilize. The AI output 2828 may be sent to robotic systems 2834 configured to perform automated tasks based on the AI output 2828.

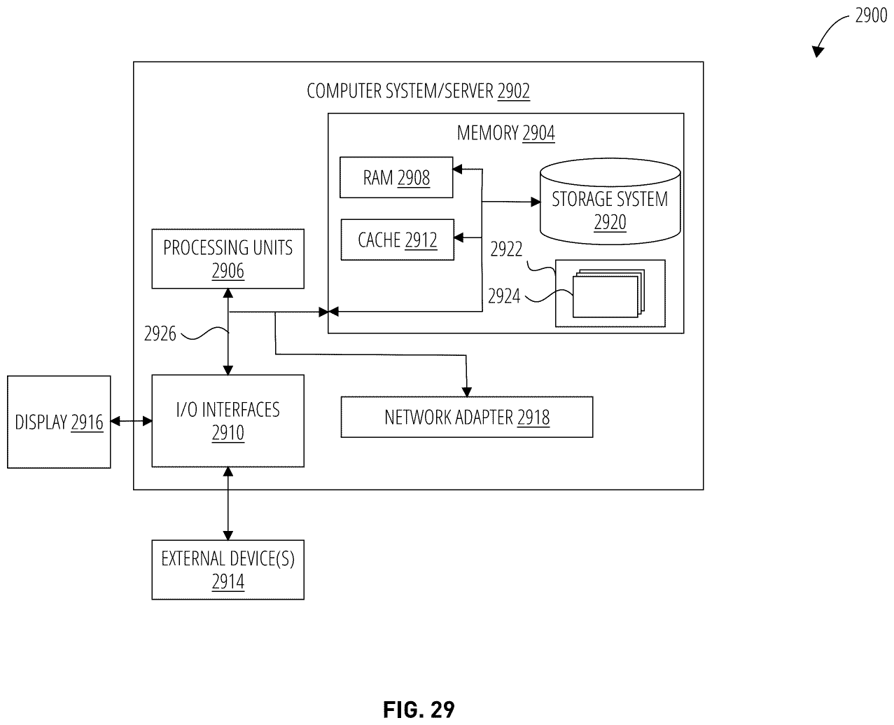

As shown in FIG. 29, computer system/server 2902 in cloud computing node 2900 is shown in the form of a general-purpose computing device. The components of computer system/server 2902 may include, but are not limited to, one or more processors or processing units 2906, a system memory 2904, and a bus 2926 that couples various system components, including system memory 2904, to processing units 2906.

Bus 2926 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 2902 typically includes a variety of computer system readable media. Such media may be any available media that is accessible by computer system/server 2902, and it includes both volatile and non-volatile media, removable and non-removable media.

System memory 2904 may include computer system readable media in the form of volatile memory, such as Random access memory (RAM) 2908 and/or cache memory 2912. Computer system/server 2902 may further include other removable/non-removable, volatile/non-volatile computer system storage media. By way of example, a storage system 2920 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media may be provided. In such instances, each may be connected to bus 2926 by one or more data media interfaces. As will be further depicted and described below, system memory 2904 may include at least one program product having a set (e.g., at least one) of program modules that are configured to carry out the functions of the present disclosure.

Program/utility 2922 having a set (at least one) of program modules 2924 may be stored in system memory 2904 by way of example, and not limitation, as well as an operating system, one or more application programs, other program modules, and program data. Each of the operating system, one or more application programs, other program modules, and program data or some combination thereof, may include an implementation of a networking environment. Program modules 2924 generally carry out the functions and/or methodologies of the present disclosure as described herein.

Computer system/server 2902 may also communicate with one or more external devices 2914 such as a keyboard, a pointing device, a display 2916, etc.; one or more devices that allow a user to interact with computer system/server 2902; and/or any devices (e.g., network card, modem, etc.) that allow computer system/server 2902 to communicate with one or more other computing devices. Such communication may occur via I/O interfaces 2910. Computer system/server 2902 may communicate with one or more networks such as a local area network (LAN), a general wide area network (WAN), and/or a public network (e.g., the Internet) via network adapter 2918. As depicted, network adapter 2918 communicates with the other components of computer system/server 2902 via bus 2926. It may readily be understood that although not shown, other hardware and/or software components may be used in conjunction with computer system/server 2902. Examples include, but are not limited to: microcode, device drivers, redundant processing units, external disk drive arrays, RAID systems, tape drives, and data archival storage systems, etc.

Referring now to FIG. 30, illustrative cloud computing environment 3000 is depicted. As shown, cloud computing environment 3000 comprises one or more cloud computing nodes 2900 with which computing devices such as, for example, a laptop 3002, a personal digital assistant (PDA) or cellular telephone 3004, an automobile computer system 3006, and/or a desktop computer 3008 may communicate. This allows for infrastructure, platforms, and/or software to be offered as services from cloud computing environment 3000, so that each client need not separately maintain such resources. It is understood that the types of computing devices shown in FIG. 30 are intended to be illustrative and that a cloud computing environment 3000 may communicate with any type of computerized device over any type of network and/or network/addressable connection (e.g., using a web browser).

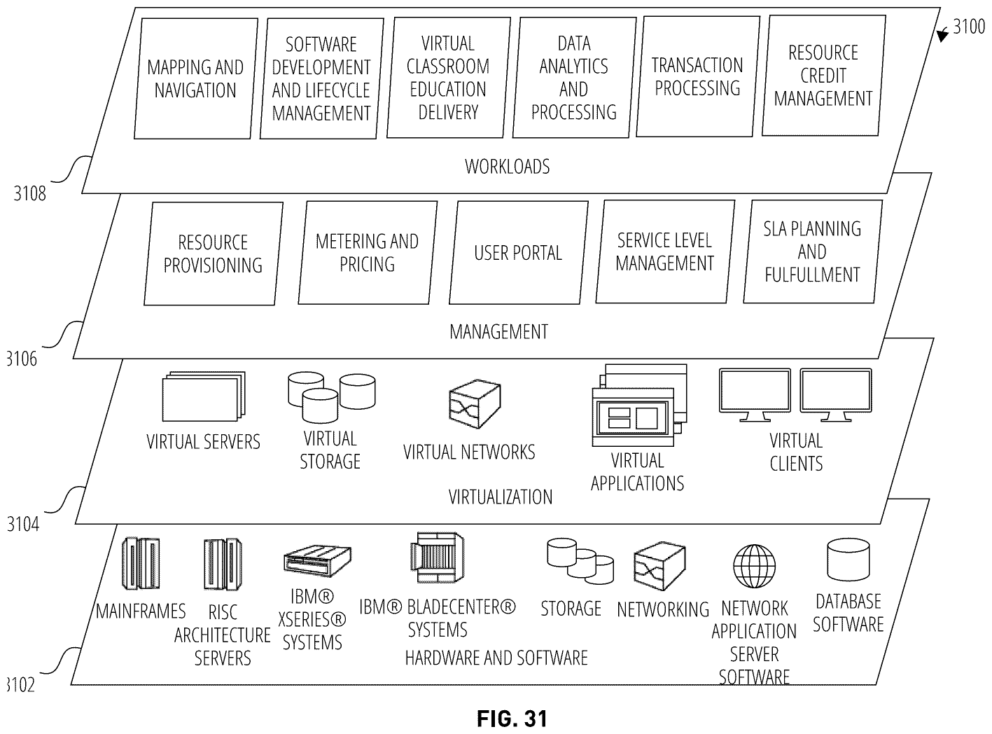

Referring now to FIG. 31, a set of functional abstraction layers provided by a cloud computing environment 3000 such as is illustrated in FIG. 30. It may be understood in advance that the components, layers, and functions shown in FIG. 31 are intended to be illustrative, and the present disclosure is not limited thereto. As depicted, the following layers and corresponding functions are provided:

Hardware and software layer 3102 includes hardware and software components. Examples of hardware components include mainframes. In one example, IBM® zSeries® systems and RISC (Reduced Instruction Set Computer) architecture based servers. In one example, IBM pSeries® systems, IBM xSeries® systems, IBM BladeCenter® systems, storage devices, networks, and networking components. Examples of software components include network application server software. In one example, IBM WebSphere® application server software and database software. In one example, IBM DB2® database software. (IBM, zSeries, pSeries, xSeries, BladeCenter, WebSphere, and DB2 are trademarks of International Business Machines Corporation in the United States, other countries, or both.)

Virtualization layer 3104 provides an abstraction layer from which the following exemplary virtual entities may be provided: virtual servers; virtual storage; virtual networks, including virtual private networks; virtual applications; and virtual clients.

Management layer 3106 provides the exemplary functions described below. Resource provisioning provides dynamic procurement of computing resources and other resources that are utilized to perform tasks within the Cloud computing environment. Metering and Pricing provide cost tracking as resources are utilized within the Cloud computing environment, and billing or invoicing for consumption of these resources. In one example, these resources may comprise application software licenses. Security provides identity verification for users and tasks, as well as protection for data and other resources. User portal provides access to the Cloud computing environment for both users and system administrators. Service level management provides Cloud computing resource allocation and management such that desired service levels are met. Service Level Agreement (SLA) planning and fulfillment provides pre-arrangement for, and procurement of, Cloud computing resources for which a future need is anticipated in accordance with an SLA.

Workloads layer 3108 provides functionality for which the Cloud computing environment is utilized. Examples of workloads and functions which may be provided from this layer include: mapping and navigation; software development and lifecycle management; virtual classroom education delivery; data analytics processing; transaction processing; and resource credit management. As mentioned above, all of the foregoing examples described with respect to FIG. 31 are illustrative, and the present disclosure is not limited to these examples.

FIG. 32 illustrates an exemplary tokenizer 3200 in accordance with one embodiment. data to be tokenized 3202 may be provided to the exemplary tokenizer 3200 in the form of a text string typed by a user. In one embodiment, the text string may be generated by performing voice-to-text conversion on an audio stream. The exemplary tokenizer 3200 may detect tokenizable elements 3204 within the data to be tokenized 3202. Each tokenizable element 3204 may be converted into a token 3206. The set of tokens 3206 created from the tokenizable elements 3204 of the data to be tokenized 3202 may be sent from the exemplary tokenizer 3200 as tokenized output 3208. The set of tokens 3206 may be such as are used to create the prompt FIG. 28.

For structured historical data such as plaintext, database, or web-based textual content, tokens may consist of the numerical indexes in an embedded or vectorized (e.g., word2vec or similar) representation of the text content such as are shown here. In some embodiments, a machine learning technique called an autoencoder may be utilized to transform plaintext inputs into high dimensional vectors that are suitable for indexing and tokenization ingestion by the prompt composer 1614 introduced with respect to FIG. 16.

In some embodiments, data to be tokenized may include audio, visual, or other multimodal data. For images, video, and similar visual data, tokenization may be performed using a convolution-based tokenizer such as a vision transformer. In some alternate embodiments, multimodal data may be quantized and converted into tokens 3206 using a codebook. In yet other alternate embodiments, multimodal data may be directly encoded and for presentation to a language model as a vector space encoding. An exemplary system that utilizes this tokenizer strategy is Gato, a generalist agent capable of ingesting a mixture of discrete and continuous inputs, images, and text as tokens.

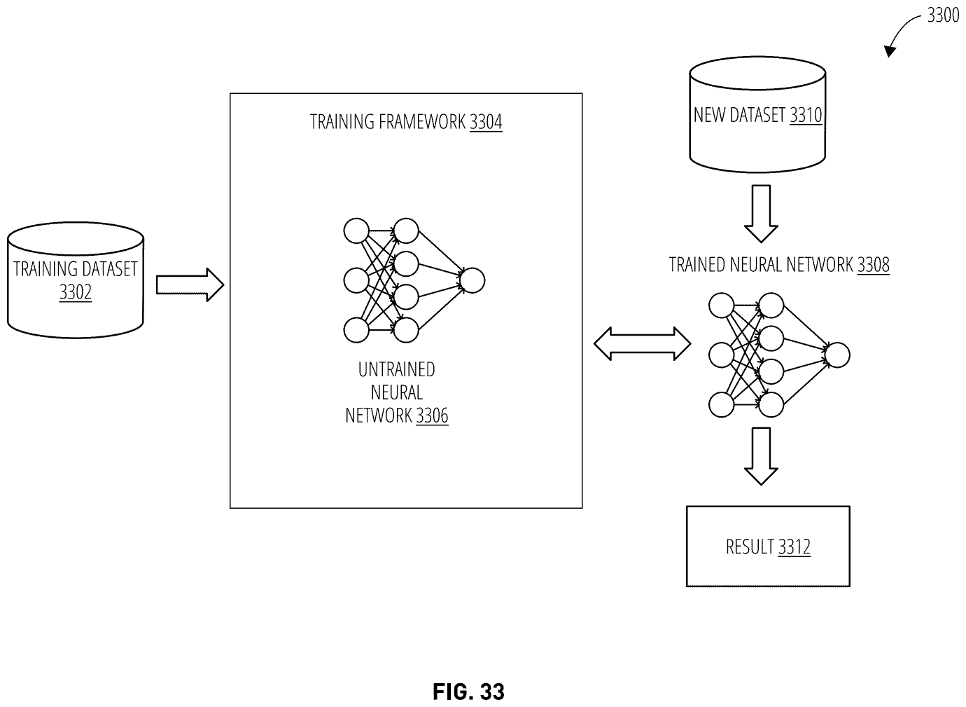

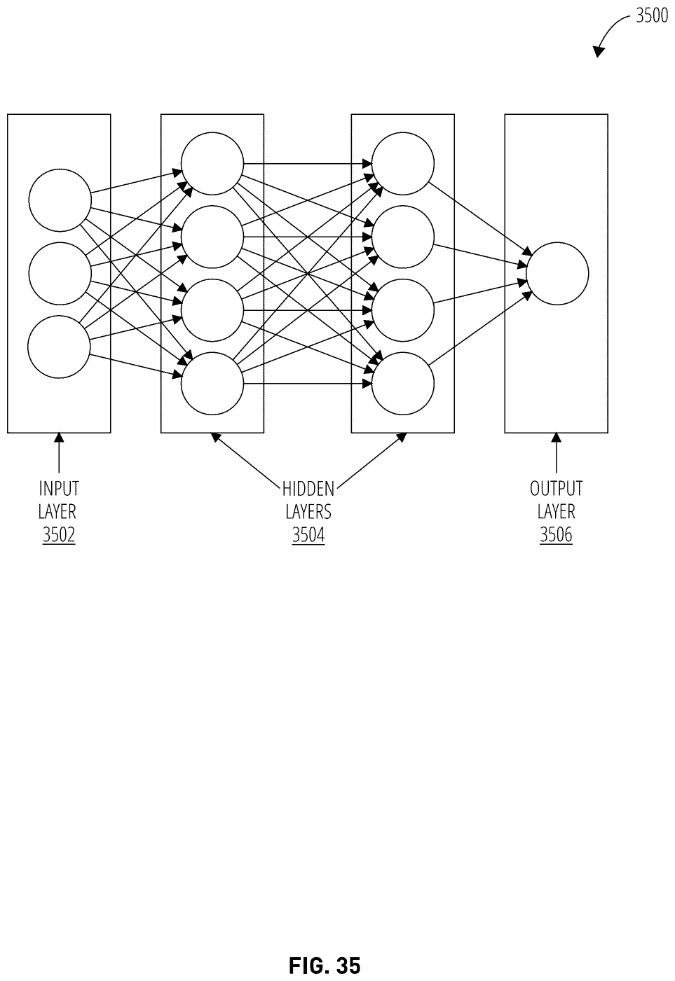

FIG. 33 illustrates the training and deployment of a deep neural network 3300, such as the basic deep neural network 3500 illustrated in FIG. 35, according to at least one embodiment. In at least one embodiment, untrained neural network 3306 is trained using a training dataset 3302. In at least one embodiment, training framework 3304 is a PyTorch framework, whereas in other embodiments, training framework 3304 is a TensorFlow, Boost, Caffe, Microsoft Cognitive Toolkit/CNTK, MXNet, Chainer, Keras, Deeplearning4j, or another training framework. In at least one embodiment, training framework 3304 trains an untrained neural network 3306 and allows it to be trained using processing resources described herein to generate a trained neural network 3308. In at least one embodiment, weights may be chosen randomly or by pre-training using a deep belief network. In at least one embodiment, training may be performed in either a supervised, partially supervised, or unsupervised manner.

In at least one embodiment, untrained neural network 3306 is trained using supervised learning, wherein training dataset 3302 includes an input paired with a desired output for the input, or where training dataset 3302 includes input having a known output and an output of untrained neural network 3306 is manually graded. In at least one embodiment, untrained neural network 3306 is trained in a supervised manner, processes inputs from training dataset 3302, and compares resulting outputs against a set of expected or desired outputs. In at least one embodiment, errors are then propagated back through untrained neural network 3306. In at least one embodiment, training framework 3304 adjusts weights that control untrained neural network 3306. In at least one embodiment, training framework 3304 includes tools to monitor how well untrained neural network 3306 is converging towards a model, such as trained neural network 3308, suitable to generating correct answers, such as in result 3312, based on input data such as a new dataset 3310. In at least one embodiment, training framework 3304 trains untrained neural network 3306 repeatedly while adjusting weights to refine an output of untrained neural network 3306 using a loss function and adjustment algorithm, such as stochastic gradient descent. In at least one embodiment, training framework 3304 trains untrained neural network 3306 until untrained neural network 3306 achieves the desired accuracy. In at least one embodiment, trained neural network 3308 may then be deployed to implement any number of machine learning operations.

In at least one embodiment, untrained neural network 3306 is trained using unsupervised learning, wherein untrained neural network 3306 attempts to train itself using unlabeled data. In at least one embodiment, an unsupervised learning training dataset 3302 will include input data without any associated output data or “ground truth” data. In at least one embodiment, untrained neural network 3306 may learn groupings within training dataset 3302 and may determine how individual inputs are related to other data in the training dataset 3302. In at least one embodiment, unsupervised training may be used to generate a self-organizing map in a trained neural network 3308 capable of performing operations useful in reducing the dimensionality of the new dataset 3310. In at least one embodiment, unsupervised training may also be used to perform anomaly detection, which allows the identification of data points in new dataset 3310 that deviate from normal patterns of new dataset 3310.

In at least one embodiment, semi-supervised learning may be used, which is a technique in which training dataset 3302 includes a mix of labeled and unlabeled data. In at least one embodiment, training framework 3304 may be used to perform incremental learning, such as through transferred learning techniques. In at least one embodiment, incremental learning allows trained neural network 3308 to adapt to new dataset 3310 without forgetting knowledge instilled within trained neural network 3308 during initial training. A trained neural network 3308 such as the one described may be used as the basis for AI and ML models such as may be used in computational systems to analyze complex data and provide results based on that analysis productive toward the improved knowledge or task action performance of people and computational and robotic systems.

The following figures set forth, without limitation, exemplary artificial intelligence-based systems that may be used to implement at least one embodiment.

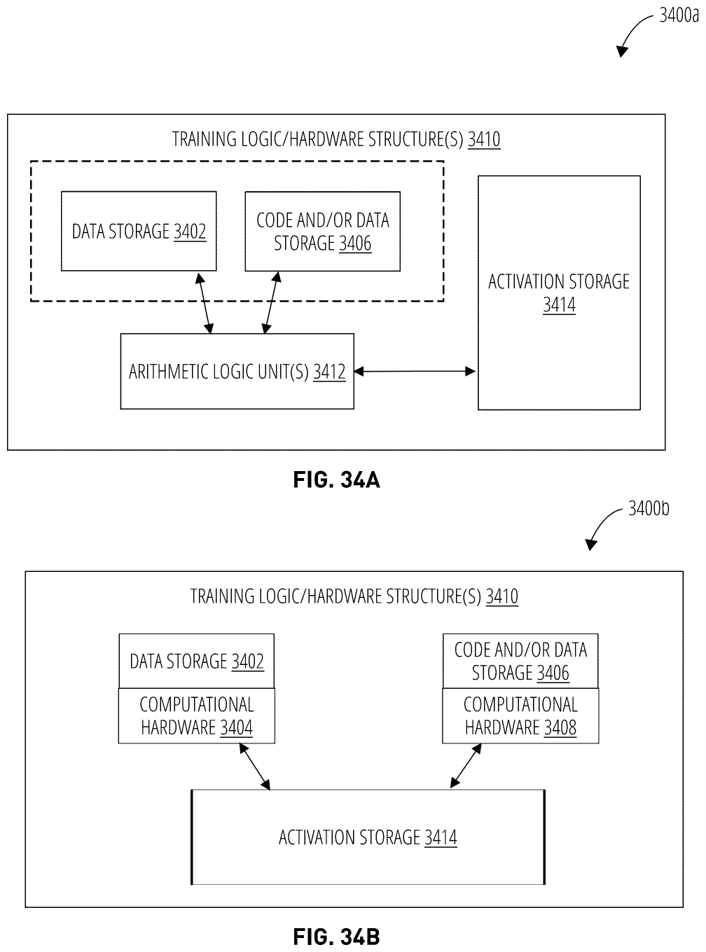

FIG. 34A illustrates inference and/or training logic 3400a used to perform inferencing and/or training operations associated with one or more embodiments. Details regarding training logic/hardware structure 3410 are provided below in conjunction with FIG. 34A and/or FIG. 34B.

In at least one embodiment, training logic/hardware structure 3410 may include, without limitation, code and/or data storage 3402 to store forward and/or output weight and/or input/output data, and/or other parameters to configure neurons or layers of a neural network trained and/or used for inferencing in aspects of one or more embodiments. In at least one embodiment, training logic/hardware structure 3410 may include or be coupled to code and/or data storage 3402 to store graph code or other software to control the timing and/or order in which weight and/or other parameter information is to be loaded to configure logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment code and/or data storage 3402 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 3402 may be included with other on-chip or off-chip data storage, including a processor's L1, L2, or L3 cache or system memory.

In at least one embodiment, any portion of code and/or data storage 3402 may be internal or external to one or more processors or other hardware logic devices or circuits. In at least one embodiment, code and/or data storage 3402 may be cache memory, dynamic randomly addressable memory (DRAM), static randomly addressable memory (SRAM), non-volatile memory (e.g., flash memory), or other storage. In at least one embodiment, a choice of whether code and/or data storage 3402 is internal or external to a processor, for example, or comprising DRAM, SRAM, flash, or some other storage type may depend on available storage on-chip versus off-chip, latency needs of training and/or inferencing functions being performed, batch size of data used in inferencing and/or training of a neural network, or some combination of these factors.

In at least one embodiment, training logic/hardware structure 3410 may include, without limitation, a code and/or data storage 3406 to store backward and/or output weight and/or input/output data corresponding to neurons or layers of a neural network trained and/or used for inferencing in aspects of one or more embodiments. In at least one embodiment, code and/or data storage 3406 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic/hardware structure 3410 may include or be coupled to code and/or data storage 3406 to store graph code or other software to control the timing and/or order in which weight and/or other parameter information is to be loaded to configure logic, including integer and/or floating point units (collectively, arithmetic logic units (ALUs)).

In at least one embodiment, code, such as graph code, causes loading of weight or other parameter information into processor ALUs based on an architecture of a neural network to which such code corresponds. In at least one embodiment, any portion of code and/or data storage 3406 may be included with other on-chip or off-chip data storage, including a processor's L1, L2, or L3 cache or system memory. In at least one embodiment, any portion of code and/or data storage 3406 may be internal or external to one or more processors or other hardware logic devices or circuits. In at least one embodiment, code and/or data storage 3406 may be cache memory, DRAM, SRAM, non-volatile memory (e.g., flash memory), or other storage. In at least one embodiment, a choice of whether code and/or data storage 3406 is internal or external to a processor, for example, or comprising DRAM, SRAM, flash memory or some other storage type may depend on available storage on-chip versus off-chip, latency needs of training and/or inferencing functions being performed, batch size of data used in inferencing and/or training of a neural network, or some combination of these factors.

In at least one embodiment, code and/or data storage 3402 and code and/or data storage 3406 may be separate storage structures. In at least one embodiment, code and/or data storage 3402 and code and/or data storage 3406 may be a combined storage structure. In at least one embodiment, code and/or data storage 3402 and code and/or data storage 3406 may be partially combined and partially separate. In at least one embodiment, any portion of code and/or data storage 3402 and code and/or data storage 3406 may be included with other on-chip or off-chip data storage, including a processor's L1, L2, or L3 cache or system memory.

In at least one embodiment, training logic/hardware structure 3410 may include, without limitation, one or more arithmetic logic units 3412, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 3414 that are functions of input/output and/or weight parameter data stored in code and/or data storage 3402 and/or code and/or data storage 3406. In at least one embodiment, activations stored in activation storage 3414 are generated according to linear algebraic and or matrix-based mathematics performed by arithmetic logic units 3412 in response to performing instructions or other code, wherein weight values stored in code and/or data storage 3406 and/or code and/or data storage 3402 are used as operands along with other values, such as bias values, gradient information, momentum values, or other parameters or hyperparameters, any or all of which may be stored in code and/or data storage 3406 or code and/or data storage 3402 or another storage on or off-chip.

In at least one embodiment, arithmetic logic units 3412 are included within one or more processors or other hardware logic devices or circuits, whereas in another embodiment, arithmetic logic units 3412 may be external to a processor or other hardware logic device or circuit that uses them (e.g., a co-processor). In at least one embodiment, arithmetic logic units 3412 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or code and/or data storage 3402, code and/or data storage 3406, and activation storage 3414 may share a processor or other hardware logic device or circuit, whereas, in another embodiment, they may be in different processors or other hardware logic devices or circuits, or some combination of same and different processors or other hardware logic devices or circuits. In at least one embodiment, any portion of activation storage 3414 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement, and/or other logic circuits.

In at least one embodiment, activation storage 3414 may be cache memory, DRAM, SRAM, non-volatile memory (e.g., flash memory), or other storage. In at least one embodiment, activation storage 3414 may be completely or partially within or external to one or more processors or other logic circuits. In at least one embodiment, a choice of whether activation storage 3414 is internal or external to a processor, for example, or comprising DRAM, SRAM, flash memory or some other storage type may depend on available storage on-chip versus off-chip, latency needs of training and/or inferencing functions being performed, batch size of data used in inferencing and/or training of a neural network, or some combination of these factors.

In at least one embodiment, the training logic/hardware structure 3410 illustrated in FIG. 34A may be used in conjunction with an application-specific integrated circuit (ASIC), such as a TensorFlow® Processing Unit from Google, an inference processing unit (IPU) from Graphcore™, or a Nervana® (e.g., “Lake Crest) processor from Intel Corp. In at least one embodiment, the training logic/hardware structure 3410 illustrated in FIG. 34A may be used in conjunction with central processing unit (CPU) hardware, graphics processing unit (GPU) hardware, or other hardware, such as field programmable gate arrays (FPGAs).

FIG. 34B illustrates inference and/or training logic 3400b, according to at least one embodiment. In at least one embodiment, training logic/hardware structure 3410 may include, without limitation, hardware logic in which computational resources are dedicated or otherwise exclusively used in conjunction with weight values or other information corresponding to one or more layers of neurons within a neural network. In at least one embodiment, the training logic/hardware structure 3410 illustrated in FIG. 34B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, the training logic/hardware structure 3410 illustrated in FIG. 34B may be used in conjunction with central processing unit (CPU) hardware, graphics processing unit (GPU) hardware, or other hardware, such as field programmable gate arrays (FPGAs). In at least one embodiment, training logic/hardware structure 3410 includes, without limitation, code and/or data storage 3402 and code and/or data storage 3406, which may be used to store code (e.g., graph code), weight values and/or other information, including bias values, gradient information, momentum values, and/or other parameter or hyperparameter information. In at least one embodiment illustrated in FIG. 34B, each of code and/or data storage 3402 and code and/or data storage 3406 is associated with a dedicated computational resource, such as computational hardware 3404 and computational hardware 3408, respectively. In at least one embodiment, each of computational hardware 3404 and computational hardware 3408 comprises one or more ALUs that perform mathematical functions, such as linear algebraic functions, on information stored in code and/or data storage 3402 and code and/or data storage 3406, respectively, the result of which is stored in activation storage 3414.

In at least one embodiment, each of code and/or data storage 3402 and 3406 and corresponding computational hardware 3404 and 3408, respectively, correspond to different layers of a neural network, such that resulting activation from one storage/computational pair 3402/3404 of code and/or data storage 3402 and computational hardware 3404 is provided as an input to a next storage/computational pair 3406/3408 of code and/or data storage 3406 and computational hardware 3408, in order to mirror a conceptual organization of a neural network. In at least one embodiment, each of the storage/computational pairs 3402/3404 and 3406/3408 may correspond to more than one neural network layer. In at least one embodiment, additional storage/computation pairs (not shown) subsequent to or in parallel with storage/computation pairs 3402/3404 and 3406/3408 may be included in training logic/hardware structure 3410.

A basic deep neural network 3500 is based on a collection of connected units or nodes called artificial neurons which loosely model the neurons in a biological brain. Each connection, like the synapses in a biological brain, may transmit a signal from one artificial neuron to another. An artificial neuron that receives a signal may process it and then signal additional artificial neurons connected to it.

In common implementations, the signal at a connection between artificial neurons is a real number, and the output of each artificial neuron is computed by some non-linear function (the activation function) of the sum of its inputs. The connections between artificial neurons are called ‘edges’ or axons. Artificial neurons and edges typically have a weight that adjusts as learning proceeds. The weight increases or decreases the strength of the signal at a connection. Artificial neurons may have a threshold (trigger threshold) such that the signal is sent if the aggregate signal crosses that threshold. Typically, artificial neurons are aggregated into layers. Different layers may perform different kinds of transformations on their inputs. Signals travel from the first layer (the input layer 3502), to the last layer (the output layer 3506), possibly after traversing one or more intermediate layers, called hidden layers 3504.

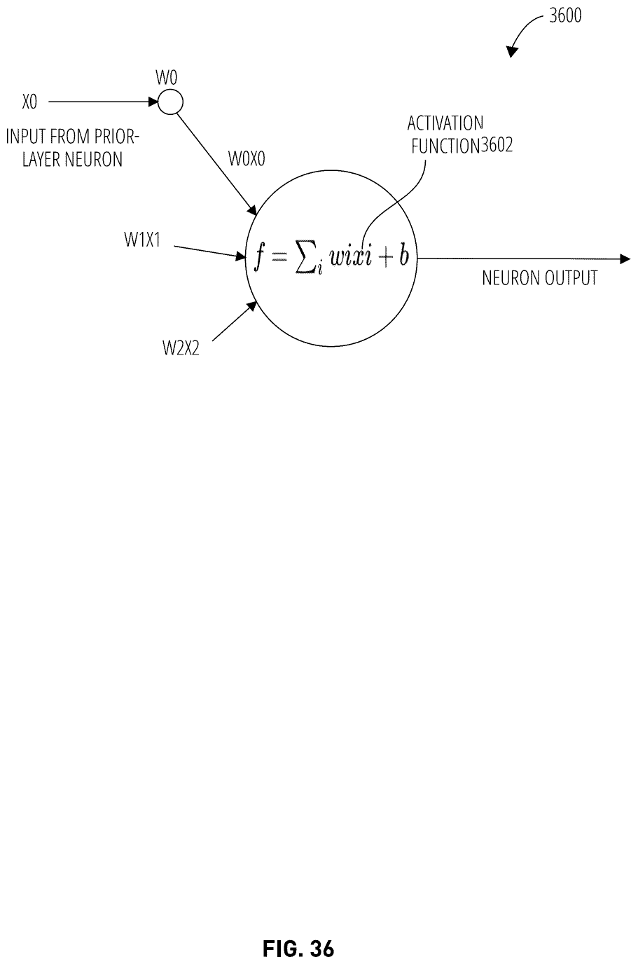

Referring to FIG. 36, an artificial neuron 3600 receiving inputs from predecessor neurons includes the following components:
inputs xᵢ;
weights wᵢ applied to the inputs;
an optional threshold (b), which stays fixed unless changed by a learning function; and
an activation function 3602 that computes the output from the previous neuron inputs and threshold, if any.

An input neuron has no predecessor but serves as input interface for the whole network of artificial neurons 3600, such as may form a basic deep neural network 3500. Similarly an output neuron has no successor and thus serves as output interface of the whole network.

The network includes connections, each connection transferring the output of a neuron in one layer to the input of a neuron in a next layer. Each connection carries an input x and is assigned a weight w.

The activation function 3602 often has the form of a sum of products of the weighted values of the inputs of the predecessor neurons.

The learning rule is a rule or an algorithm which modifies the parameters of the neural network, in order for a given input to the network to produce a favored output. This learning process typically involves modifying the weights and thresholds of the neurons and connections within the network.

LISTING OF DRAWING ELEMENTS

```
  100 micropanel
  101 micropanel hard cover plate
  102 integrated smart touch screen
  103 existing wall
  200 micropanel computing, power, and sensing layers
  201 low voltage CAT-6 wiring
  202 Qi-2 magnetic connector
  203 embedded sensing layer
  204 sensor cover plate
  205 microcomputing layer
  206 microprocessor
  300 micropanel wall installation
  301 existing 120 V outlet
  302 window penetration
  400 subpanel
  401 subpanel layer
  402 cover plate layer
  403 wall rear attachment layer
  500 subpanel and wall rear attachment layers
  501 internal wall surface
  502 structure and insulation
  503 vertical wall connections
  504 wall finish
  505 horizontal wall connections
  506 surface connection layer
  600 subpanel with a door penetration
  601 door penetration
  700 subpanel with a window penetration
  701 window penetration
  800 subpanel surface points and external attachments
  801 vertical connection layer
  802 horizontal connection layer
  803 surface connection layer
  900 interior mounting
  901 micropanel panel hard cover plate
  902 penetrationless television hanging
  903 smart lighting system
  904 smart bookshelves with wireless charging
  905 hanging plants and natural humidifier
  906 white board or picture penetrationless hanging
  907 floor mounted subpanels
  908 smart home entertainment system
  909 robotic vacuum navigation
  910 smart window with shades and blinds
  911 hurricane window
1000 kitchen cabinet mounting layer
1001 hanging rail
1002 hanging cabinet
1003 smart lighting system
1004 standing cabinet
1006 smart microwave/hood exhaust
1008 smart oven
1010 smart dishwasher
1012 smart refrigerator
1014 sink/smart valve technology
1100 exterior mounting layer
1101 internal sensing and insulation layer
1102 surface mounted low voltage system
1103 power point and hose bib subpanel
1104 billboard display system
1105 hanging garden or living wall
1200 smartdesk with wireless charging
1202 furniture subpanel layer
1203 low voltage or Cat 6 wiring
1204 connection to a floor panel
1205 microcomputing layer
1206 device connection
1300 whole room panel components
1301 standard panel
1302 specialty panel
1303 window penetration panel
1400 floor panel
1401 finish floor layer
1402 substrate cavity layer
1403 low voltage CAT-6 and DC power supply
1500 ceiling panel
1501 cover plate
1502 substrate cavity layer
1503 low voltage CAT-6 and DC power supply
1504 light fixture
1600 utility system layer
1601 utility hub layer
1602 utility wall layer
1603 high voltage AC mains panel layer
1604 bathroom
1605 kitchen
1606 housing unit
1700 high-pressure water, HVAC, energy storage,
          and AC electrical distribution layers
1701 air cooled condensing unit
1702 exhaust air outlet
1703 integrated energy recover ventilator and heat pump
1704 ventilation air inlet
1705 water heater air inlet and outlet
1706 heat pump water heater
1707 5 kW power wall with battery storage
1708 access door
1709 recirculating hood
1710 load center with smart screen
1712
1714
1716 access door
1800 mechanical ducting and liquid HVAC layers
1802 8″ duct
1804 6″ duct
1806 8″ × 8″ duct
1808 12″ × 10″ duct
1900 utility hub and utility wall connection layer
1901 utility wall to hub connection
1902 utility wall hub connectors
2000 low pressure system and high voltage distribution layers
2001 fire suppression life safety layer
2002 utility wall structure
2003 low pressure water distribution layer
2004 waste distribution layer
2005 high voltage AC mains panel layer
2006 vertical mains AC distribution
2007 horizontal mains AC distribution
2008 electrical box
2100 high pressure plumbing layer connection
2101 non-potable cold water riser
2102 cold water riser
2103 hot water riser
2104 drainage stack
2200 rainwater, gray water, and black water layers
2201 black water stack
2202 black water connection to a unit below
2203 black water connection to a unit above or vent to atmosphere
2204 gray water stack
2205 gray water connection to a unit below
2206 gray water connection to a unit above or vent to atmosphere
2207 toilet
2208 bathroom sink
2209 shower and tub
2210 washing machine
2300 low voltage DC electrical layer
2301 DC distribution panel
2302 under-floor DC cable
2303 wall termination outlet
2304 smart lighting system
2400 exemplary physical component integration
          with major systems elements
2500 system controller
2502 module controller
2504 AIOS
2506 Supervising AI Agent
2508 AI agent
2510 Panels
2512 Subpanels
2514 Panel AI agents
2516 subpanel AI agents
2600 method
2602 block
2604 block
2606 block
2608 block
2610 block
2612 block
2614 block
2700 method
2702 block
2704 block
2706 block
2708 block
2710 block
2712 block
2714 block
2716 block
2718 block
2720 block
2800 AI system
2802 sensor data
2804 text data
2806 user
2808 user selection data
2810 signal classifier
2812 database
2814 stored data
2816 signal classifications
2818 tokenizer
2820 input tokens
2822 prompt composer
2824 AI model
2826 model selector
2828 AI output
2830 prompt
2832 model identifier
2834 robotic system
2836 computing device or system
2900 cloud computing node
2902 computer system/server
2904 system memory
2906 processing units
2908 random access memory (RAM)
2910 I/O interfaces
2912 cache memory
2914 external devices
2916 display
2918 network adapter
2920 storage system
2922 program/utility
2924 program modules
2926 bus
3000 cloud computing environment
3002 laptop
3004 cellular telephone
3006 automobile computer system
3008 desktop computer
3100 item
3102 hardware and software layer
3104 virtualization layer
3106 management layer
3108 workloads layer
3200 exemplary tokenizer
3202 data to be tokenized
3204 tokenizable element
3206 token
3208 tokenized output
3300 deep neural network
3302 training dataset
3304 training framework
3306 untrained neural network
3308 trained neural network
3310 new dataset
3312 result
3400a inference and/or training logic
3400b inference and/or training logic
3402 code and/or data storage
3404 computational hardware
3406 code and/or data storage
3408 computational hardware
3410 training logic/hardware structure
3412 arithmetic logic unit
3414 activation storage
3500 basic deep neural network
3502 input layer
3504 hidden layers
3506 output layer
3600 artificial neuron
3602 activation function
```

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the disclosure as claimed. The scope of disclosed subject matter is not limited to the depicted embodiments but is rather set forth in the following claims.

What is claimed is:

1. A smart panel system comprising:
at least one smart panel comprising at least one subpanel including at least one micropanel, each subpanel including:
at least one node;
at least one internal line;
at least one internal connector; and
a unique ID;
each micropanel including layers, wherein the layers comprise:
a processing layer; and
a communications layer; and
a module controller comprising:
an Artificial Intelligence Operating System (AIOS) including a plurality of software Artificial Intelligence (AI) agents, wherein each software AI agent is dedicated to specific tasks; and
logic to:
control the subpanels and the micropanels; and
monitor the subpanels and the micropanels.

2. The smart panel of claim 1, wherein the at least one layer of the micropanel further comprises at least one of:
a rear attachment layer;
a front attachment layer;
a display layer; and
a secure computing and write once, read many (WORM) layer.

3. The smart panel of claim 1, wherein the smart panel is composed of components including at at least one of:
standard panels;
specialized standard panels;
ceiling panels;
floor panels;
wet system panels; and
high voltage systems panels.

4. The smart panel of claim 1, wherein the at least one subpanel includes at least one of:
a vertical core with one or more nodes from multiple layers;
a core with one or more nodes from multiple layers;
a surface connector for the core;
a surface attachment point;
a surface insertion mechanism for the core; and
a surface removal mechanism for the core.

5. The smart panel of claim 1, wherein the at least one subpanel includes at least one of:
a sensing layer;
a low voltage power layer;
a battery layer;
a substrate layer;
a display surface attachment and node;
penetration support using grid-skipping and grid-bending in layers and internal edge attachment points;
an internal insulation layer with internal sensing; and
an external sensing layer.

6. The smart panel of claim 5, the subpanel further comprising at least one of:
a low voltage DC electrical layer;
a wired communication layer;
a processor layer;
a volatile storage layer;
a mains voltage AC electrical layer;
a low pressure plumbing layer;
a high pressure plumbing layer;
a mechanical ducting layer;
a liquid HVAC layer;
rainwater, greywater and black water layers;
a photo-voltaic scavenging layer;
an energy scavenging layer;
a high voltage DC lines layer;
a catastrophic failsafe control layer;
a secure enclave, identity and fallback management layer; and
a write-once storage layer.

7. The smart panel of claim 1, wherein the subpanel includes a wall rear attachment layer including at least one of:
an internal wall surface;
structure and insulation;
vertical wall connections;
a wall finish; and
horizontal wall connections.

8. The smart panel of claim 1, wherein module controller further comprises logic to:
create the plurality of software AI agents for different layers of the subpanels;
create the plurality of software of software AI agents for different layers of the micropanels; and
locate a remote AIOS on the subpanels; and
locate a remote AIOS on the micropanels.

9. The smart panel of claim 8, wherein at least a portion of the plurality of software AI agents is located on the subpanels and micropanels.

10. The smart panel of claim 8, further comprising logic to:
create software AI agent workflows; and
manage, by supervising software AI agents, the software AI agent workflows.

11. A method of monitoring and controlling a smart panel system, the method comprising:
receiving, by a module controller from a smart panel, identification data, state data, and operating data, wherein the smart panel system includes:
at least one smart panel comprising at least one subpanel including at least one micropanel, each subpanel including:
at least one node;
at least one internal line;
at least one internal connector; and
a unique ID;
each micropanel including at least one layer, wherein the layers are at least one of:
a processing layer;
a communications layer; and
the module controller comprising:
an Artificial Intelligence Operating System (AIOS) including a plurality of software Artificial Intelligence (AI) agents, wherein each AI agent is dedicated to specific tasks; and
logic to:
control the subpanels and the micropanels; and
monitor the subpanels and the micropanels;
analyzing, by the AIOS, the identification data, the state data, and the operating data, to generate input tokens;
generating prompts, by the AIOS, from the input tokens;
generating, by the AIOS, AI outputs related to the prompts; and
applying, by the AIOS plurality of AI agents, the AI outputs to the smart panels.

12. The method of claim 11, further comprising:
creating, by the module controller, the plurality of software AI agents for different layers of at least one of:
the subpanels; and
the micropanels; and
locating, by the module controller, a remote AIOS on at least one of:
the subpanels; and
the micropanels.

13. The method of claim 12, further comprising:
locating, by the module controller, at least a portion of the plurality of AI agents on at least one of:
the subpanels; and
the micropanels.

14. The method of claim 12, further comprising:
creating software AI agent workflows; and
managing, by supervising software AI agents, the software AI agent workflows.

15. The method of claim 14, further comprising:
monitoring and managing, by the plurality of software AI agents, at least one layer in at least one subpanel,
wherein the at least one subpanel includes at least one of:
a sensing layer;
a low voltage power layer;
a battery layer;
a substrate layer;
a display surface attachment and node;
penetration support using grid-skipping and grid-bending in layers and internal edge attachment points;
an internal insulation layer with internal sensing; and
an external sensing layer.

16. The method of claim 14, further comprising:
monitoring and managing, by the plurality of software AI agents, at least one layer in the at least one subpanel,
wherein the at least one subpanel comprises at least one of:
a low voltage DC electrical layer;
a wired communication layer;
a processor layer;
a volatile storage layer;
a mains voltage AC electrical layer;
a low pressure plumbing layer;
a high pressure plumbing layer;
a mechanical ducting layer;
a liquid HVAC layer;
rainwater, greywater and black water layers;
a photo-voltaic scavenging layer;
an energy scavenging layer;
a high voltage DC lines layer;
a catastrophic failsafe control layer;
a secure enclave, identity and fallback management layer; and
a write-once storage layer.

17. A method of creating a smart panel system, the method comprising:
providing:
more than one smart panel comprising at least one subpanel including at least one micropanel, each subpanel including:
at least one node;
at least one internal line;
at least one internal connector; and
a unique ID;
each micropanel including at least one layer, wherein the layers are at least one of:
a processing layer;
a communications layer; and
a module controller comprising:
an Artificial Intelligence Operating System (AIOS) including a plurality of software Artificial Intelligence (AI) agents, wherein each AI agent is dedicated to specific tasks; and
logic to:
control the subpanels and the micropanels; and
monitor the subpanels and the micropanels;
connecting each subpanel to another subpanel using at least one physical connection, thereby forming smart panel structures;
receiving, by the module controller from the smart panel structures, identification data, state data, and operating data;
analyzing, by the AIOS, the identification data, the state data, and the operating data, to generate input tokens;
generating prompts, by the AIOS, from the input tokens;
generating, by the AIOS, AI outputs related to the prompts; and
applying, by the AIOS plurality of AI agents, the AI outputs to the smart panels.

18. The method of claim 17, further comprising:
creating, by the module controller, the plurality of software AI agents for different layers of at least one of:
the subpanels; and
the micropanels; and
locating, by the module controller, a remote AIOS on at least one of:
the subpanels; and
the micropanels.

19. The method of claim 18, further comprising:
determining, by the plurality of software AI agents in one subpanel, which other smart panels are logically adjacent to the one subpanel and where the module controller is logically located, thereby identifying an array of neighboring panels; and
adding the one subpanel to the array of neighboring panels.

20. The method of claim 19, further comprising:
providing, by the one subpanel to the array of neighboring panels, data from at least one of:
a sensing layer;
a low voltage power layer;
a battery layer;
a substrate layer;
a display surface attachment and node;
penetration support using grid-skipping and grid-bending in layers and internal edge attachment points;
an internal insulation layer with internal sensing; and
an external sensing layer.
